(19) United States
(12) Patent Application Publication
(10) Pub. No.: US 2018/0240055 A1
(43) Pub. Date: Aug. 23, 2018

(54) SYSTEM AND METHOD FOR THE DELIVERY OF SERVICES TO A PROPERTY OWNER

(71) Applicant: HOMEE, INC., Tampa, FL (US)

(72) Inventors: David G. Theus, Florence, KY (US); Douglas C. Schaedler, Tampa, FL (US); Steven M. Brinager, Harold, KY (US)

(21) Appl. No.: 15/894,433

(22) Filed: Feb. 12, 2018

Related U.S. Application Data
(60) Provisional application No. 62/457,544, filed on Feb. 10, 2017.

(51) Int. Cl. G06Q 10/06; G06Q 50/16

(52) U.S. Cl. CPC G06Q 10/06311; G06Q 50/163

(57) ABSTRACT

The invention provides for an on-demand provision of a property maintenance service job through a computing system including one or more servers that interface with a plurality of devices. A plurality of profiles for service providers are maintained for providers that provide property services. A consumer job request from a device of a consumer is captured through the system for a job at a jobsite. Then, a plurality of provider job requests may be generated for the service providers. The job requests are associated with a job and job site associated with the consumer ordering service. Job requests are directed to devices of a plurality of service providers in a sequential fashion controlled by provider criteria. An acceptance of the job request is received from a device of a service provider. Upon acceptance of the job request by the provider device, a location of the service provider device is evaluated with respect to the job site. A timer is generated and is associated with the job. The timer is configured for being started and stopped with the device of the service provider. Approval is obtained from the consumer for the start of a timer through the consumer device. Then the subsequent progression of the timer associated with the job is monitored until the job is finished or ended in another way.

### CROSS-REFERENCE TO RELATED APPLICATION

This application claims the benefit of U.S. Provisional Application No. 62/457,544 filed Feb. 10, 2017, by David G. Theus, et al., the entire disclosure of the Provisional application is incorporated by reference herein in its entirety.

### FIELD OF THE INVENTION

The present invention relates generally to the provision of on-demand services, and more specifically to the provision of on-demand property maintenance services, including repair and improvement services to a property location for property owners and tenants of property owners.

### BACKGROUND OF THE INVENTION

Property owners, such as owners of homes or rental properties, are inherently faced with issues in maintaining the property. For example, it is often necessary to maintain or repair various mechanical systems or other systems of the property. Such maintenance may be specifically directed to electrical systems, HVAC systems, plumbing systems. Alternatively, there just may be a need to fix something on the property that may or may not be tied to a specific system.

As such, property owners will engage a company to handle such property maintenance services. Traditionally, a property owner would have to find out who might offer the needed services, and would then have to obtain the contact information and call and schedule such services. The experience or quality of the company or person doing the job would often be unknown. The jobs would then be scheduled in the future, often at an inconvenient time and usually involving a wait for the job to be started. The overall rate or cost of the job would be uncertain and not particularly transparent, unless the information was specifically asked for by the consumer. And even if an hourly rate was involved, it was difficult to track the work on the job and ensure efficiency and cost effectiveness. Furthermore, the job might take several days to complete and then would be billed at a later time, removed from the completion date of the job. As such, the traditional experience for a consumer is not the most convenient, cost effective, or transparent.

The provider also has some downside with respect to the particular job that is engaged in the traditional economic model. They do not know if they will get paid by the consumer. They would often get paid a significant time after the job was completed and they would have to maintain records and information to prepare a bill at a later time for presentation to the consumer. Furthermore, they have to maintain a system for scheduling and follow up on various jobs.

Accordingly, the current economic model for the provision of property maintenance services, including repair and improvement services for property owners, has some drawbacks.

The present invention addresses several of the drawbacks as noted above and other insufficiencies in the current business model by providing on-demand property maintenance services in a transparent and cost-effective manner for both the consumer and service provider.

### SUMMARY OF THE INVENTION

The invention provides for an on-demand provision of a property maintenance service job through a computing system including one or more servers that interface with a plurality of devices. A plurality of profiles for service providers are maintained for providers that provide property services. A consumer job request from a device of a consumer is captured through the system for a job at a jobsite. Then, a plurality of provider job requests may be generated for the service providers. The job requests are associated with a job and job site associated with the consumer ordering service. Job requests are directed to devices of a plurality of service providers in a sequential fashion controlled by provider criteria. An acceptance of the job request is received from a device of a service provider. Upon acceptance of the job request by the provider device, a location of the service provider device is evaluated with respect to the job site. A timer is generated and is associated with the job. The timer is configured for being started and stopped with the device of the service provider. Approval is obtained from the consumer for the start of a timer through the consumer device. Then the subsequent progression of the timer associated with the job is monitored until the job is finished or ended in another way.

### BRIEF DESCRIPTION OF THE DRAWINGS

The patent or application file contains at least one drawing executed in color. Copies of this patent or patent application publication with color drawings will be provided by the Office upon request and payment of the necessary fee.

The accompanying drawings, which are incorporated in and constitute a part of this specification, illustrate embodiments of the invention and, together with a general description of the invention given below, serve to explain the principles of the invention.

FIG. 1 is a block diagram of a service system, one or more mobile devices, and one or more client devices consistent with embodiments of the invention.

FIG. 2 is a block diagram of an embodiment of a service system of FIG. 1 consistent with embodiments of the invention.

FIG. 3 is a block diagram of an embodiment of a mobile device of FIG. 1 that might be used by a Consumer in the inventive system consistent with embodiments of the invention.

FIG. 4 is a block diagram of an embodiment of a mobile device of FIG. 1 that might be used by a Provider consistent with embodiments of the invention.

FIGS. 5A-5E are a flow diagrams illustrating a sequence of operations that may be performed by the systems and devices of FIG. 1 consistent with embodiments of the invention.

FIG. 6A-6C are diagrammatic views of exemplary graphical user interfaces that may be output on a display of a Consumer device, consistent with embodiments of the invention.

FIG. 7A is a diagrammatic view of an exemplary graphical user interface on a Consumer device for illustrating the location of a Consumer, consistent with embodiments of the invention.

FIGS. 8A-8E are diagrammatic views of exemplary graphical user interfaces on a Consumer device for registering an account, consistent with embodiments of the invention.

FIGS. 9A-9E are diagrammatic views of exemplary graphical user interfaces on a Consumer device for selecting service, consistent with embodiments of the invention.

FIG. 10A is a diagrammatic view of an exemplary graphical user interfaces on a Provider device initiating registration of an account, consistent with embodiments of the invention.

FIGS. 11A-11F are diagrammatic views of exemplary graphical user interfaces on a Provider device for registering a Provider account, consistent with embodiments of the invention.

FIGS. 12A-12C are diagrammatic views of exemplary graphical user interfaces on a Provider device for providing service, consistent with embodiments of the invention.

FIGS. 13A-13D are diagrammatic views of exemplary graphical user interfaces on a Consumer device for illustrating provider information and selecting service, consistent with embodiments of the invention.

FIG. 13E-13G are graphs and tables regarding wage rates for use in embodiments of the invention.

FIG. 14A-14B are additional diagrammatic views of example graphical user interfaces that may be output on a display of a device of FIG. 1, in accordance with the invention.

FIGS. 15A-15B are diagrammatic views of exemplary graphical user interfaces on a consumer device for indicating a link with a provider, consistent with the embodiments of the invention.

FIG. 16A a singular diagrammatic view of an exemplary graphical user interfaces on a consumer device sharing information for a service provider, consistent with the embodiments of the invention.

FIGS. 17A-17E are diagrammatic views of exemplary graphical user interfaces on consumer and provider devices for navigation to a jobsite, that are consistent with embodiments of the invention.

FIGS. 18A-18J are diagrammatic views of exemplary graphical user interfaces for both consumer and provider devices illustrating time or information associated with a job, that are consistent with embodiments of the invention.

FIGS. 19A-19G are diagrammatic views of exemplary graphical user interfaces for both consumer and provider devices illustrating time or information associated with a job, that are consistent with embodiments of the invention.

FIGS. 20A-20F are diagrammatic views of exemplary graphical user interfaces on consumer and provider devices for illustrating various scenarios of ending a job, that are consistent with embodiments of the invention.

FIGS. 21A-21D are diagrammatic views of exemplary graphical user interface on a provider device for providing job details, that are consistent with embodiments of the invention.

FIGS. 22A-22F are diagrammatic views of exemplary graphical user interface on a provider device for providing materials information for a job, that are consistent with embodiments of the invention.

FIGS. 23A-23D are diagrammatic views of exemplary graphical user interface on a provider device for indicating additional job information, that are consistent with embodiments of the invention.

FIGS. 24A-24F are diagrammatic views of exemplary graphical user interfaces for consumer and provider devices for reviewing information regarding a job, that are consistent with embodiments of the invention.

FIGS. 25A-25C are diagrammatic views of exemplary graphical user interfaces on a provider device for the management of multiple jobs, that are consistent with embodiments of the invention.

FIGS. 26A-26D are diagrammatic views of exemplary graphical user interface on a provider device for the management of multiple jobs, that are consistent with embodiments of the invention.

FIGS. 27A-27G are diagrammatic views of exemplary graphical user interfaces on consumer and provider devices for the management of suspended jobs, that are consistent with embodiments of the invention.

FIG. 28A is a diagrammatic view of an exemplary graphical user interface on a provider device for management of a job, that are consistent with embodiments of the invention.

FIGS. 29A-29D are diagrammatic views of exemplary graphical user interface on a provider device for providing additional information in a profile, that are consistent with embodiments of the invention.

FIG. 30A is a diagrammatic view of an exemplary graphical user interface on a provider device for illustrating additional provider information, that are consistent with embodiments of the invention.

FIGS. 31A-31H are diagrammatic views of exemplary graphical user interfaces on a consumer device for additional consumer information in a profile, that are consistent with embodiments of the invention.

FIG. 32 is a diagrammatic view of a search protocol example, consistent with embodiments of the invention.

FIGS. 33A-33C are diagrammatic views of exemplary graphical user interfaces on a consumer device for a managed property, that are consistent with embodiments of the invention.

FIGS. 34A-34D are diagrammatic views of exemplary graphical user interfaces on a consumer device for setting up a managed property, that are consistent with embodiments of the invention.

FIG. 35 is a diagrammatic view of an exemplary graphical user interface for managing a property, consistent with embodiments of the invention.

FIG. 36 is a diagrammatic view of an exemplary graphical user interface for approving transactions for a managed property, consistent with embodiments of the invention.

FIGS. 37A-37B are diagrammatic views of exemplary graphical user interfaces for making payments for a managed property, consistent with embodiments of the invention.

FIGS. 38A-38D are diagrammatic views of exemplary graphical user interfaces for ordering service at a managed property, consistent with embodiments of the invention.

FIGS. 39A-39D are diagrammatic views of exemplary graphical user interfaces for selecting service at a managed property, consistent with embodiments of the invention.

FIGS. 40A-40B are diagrammatic views of exemplary graphical user interfaces for adding information regarding service at a managed property, consistent with embodiments of the invention.

FIGS. 41A-41C are diagrammatic views of exemplary graphical user interfaces for adding information regarding service at a managed property, consistent with embodiments of the invention.

FIGS. 42A-42C are diagrammatic views of exemplary graphical user interfaces for adding information regarding service at a managed property, consistent with embodiments of the invention.

FIG. 43 is a diagrammatic view of an exemplary graphical user interface for an approval process for a managed property, consistent with embodiments of the invention.

FIGS. 44A-44C are diagrammatic views of exemplary graphical user interfaces for an approval process for a managed property, consistent with embodiments of the invention.

FIG. 45 is a diagrammatic view of an exemplary graphical user interface for a history of service jobs, consistent with embodiments of the invention.

FIGS. 46A-46B are diagrammatic views of exemplary graphical user interfaces for an approval process for a managed property, consistent with embodiments of the invention.

FIGS. 47A-47B are diagrammatic views of exemplary graphical user interfaces on a provider device for managing providers, consistent with embodiments of the invention.

FIG. 48 is a diagrammatic view of exemplary graphical user interface on a provider device for selecting to be a business owner, consistent with embodiments of the invention.

FIG. 49 FIG. 48 is a diagrammatic view of exemplary graphical user interface on a provider device for managing providers, consistent with embodiments of the invention.

FIGS. 50A-50B are diagrammatic views of exemplary graphical user interfaces on a provider device for managing providers, consistent with embodiments of the invention.

FIG. 51 is a diagrammatic view of exemplary graphical user interface on a provider device for managing providers, consistent with embodiments of the invention.

FIG. 52 is a diagrammatic view of exemplary graphical user interface on a provider device for provider use of a managed account, consistent with embodiments of the invention.

FIG. 53 is a diagrammatic view of exemplary graphical user interface on a provider device for provider use of a managed account, consistent with embodiments of the invention.

FIGS. 54-55 are diagrammatic views of exemplary graphical user interfaces on a provider device for provider use of a managed account, consistent with embodiments of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF EMBODIMENTS OF THE INVENTION

The present invention is implemented in a hardware and software platform that incorporates a plurality of computing devices, such as mobile computing devices, used by both customers and service providers and running individual applications or “Apps”. The mobile devices and Apps interface with one or more backend computing devices, such as backend server devices/servers running one or more service programs for the processing and exchange of data and information between the customers and service providers in the provision of on-demand services, such as mechanical, electrical and handyman services and other services at a single family residence, multi-family residence, commercial building, vacation property or some other building or property. The invention provides an interactive environment that allows a customer (consumer) to obtain services from various contractors or service providers (providers) in an on-demand environment. Through separate mobile device interfaces and the backend system, information and communication is provided back and forth between the customer and service provider for a particular ordered job. The provider, who might be a plumber, electrician, HVAC technician, handyman or other skilled worker that can provide the desired service, interfaces during the job in various ways and at various junctures to ensure proper completion of the job at the convenience of both consumer and provider. The job completes with financial transactions between the consumer and provider.

For the purposes of illustrating the invention, the user or customer of the service and the user of the consumer App, such as a homeowner, for example, is referred to as a “consumer”. The service provider, on the other hand, who interfaces with the provider App, is referred to as a “provider”. However, the terminology is illustrative and not limiting with respect to the invention. Similarly, the various computing devices used to implement the invention are referred to as “consumer device” and “provider device” without being limiting. The various devices can be any suitable computing devices for providing network connectivity, processing resources and functions, and data input/output interfaces for enabling a particular user to communicate with the backend system over a network to provide the job related interaction between consumer and provider.

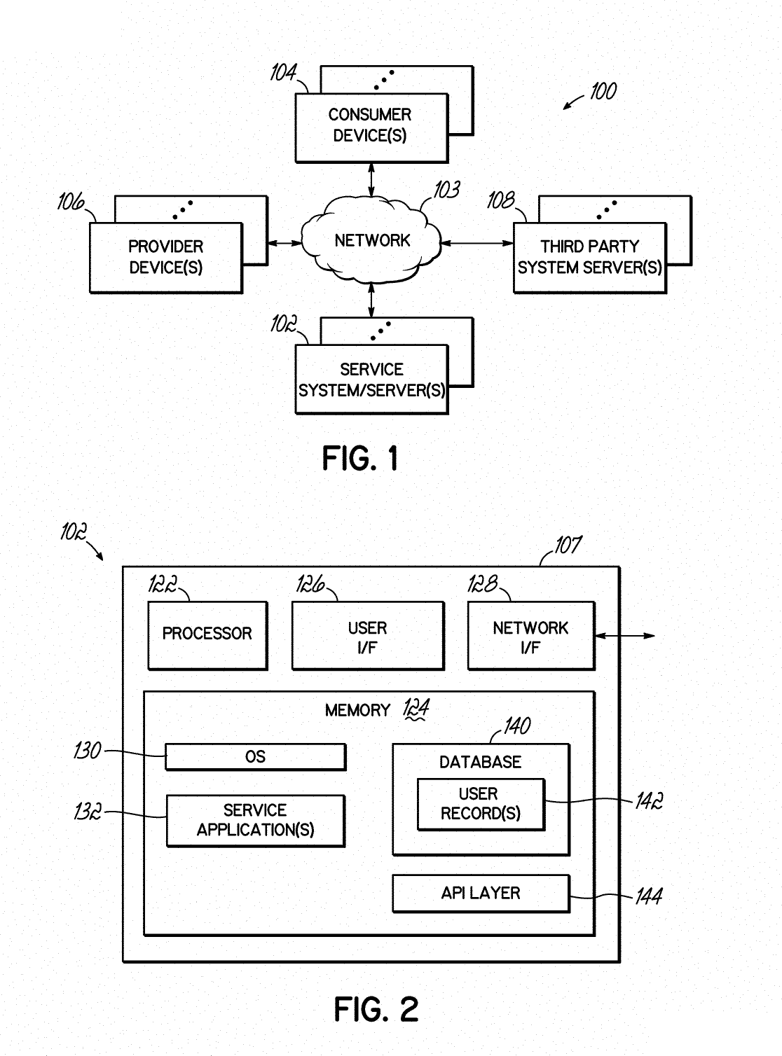

Turning now to the Figures, and particularly to FIG. 1, this figure provides a general block diagram illustrating an overall system 100 for implementing the invention consistent with embodiments of the invention. As shown in FIG. 1, system 100 includes a service system/servers 102, in accordance with aspects of the invention, wherein one or more service programs are implemented on computing devices, such as one or more server devices or servers. The system 102 including hardware and software is referred to as the backend system or backend servers, as appropriate. The distribution and arrangement of the servers or other devices implementing the service system 102 is not limiting to the invention.

The service system 102 may be connected with consumer and provider devices 104, 106 and appropriate Apps through a suitable communication network 103, where the communication network 103 may comprise one or more cellular voice/data networks, various wireless networks (e.g. the Internet), local area networks (LAN), wide area networks (WAN), one or more high speed bus connections, and/or other such types of communication networks, or combinations of networks for providing the functional communications between service system 102 and various devices 104, 106. To that end, the system 100 will include one or more user computing devices 104, 106, such as mobile devices for communication with each other and the service system 102 through an appropriate network link 103. In one typical use of the invention, the consumer and provider devices 104, 106 may typically be a cellular phone or smart phone, tablet computer, laptop computer, thin client terminal and/or other such computing device, that a mobile consumer and provider can use, but the invention is not limited to such devices.

As will be described in detail below, consistent with embodiments of the invention, the devices 104, 106 provide suitable user interfaces for use by respective consumers and providers to provide inputs, receive/send information, receive/send notifications, and otherwise engage with the service system 102 for the requesting, scheduling and provision of on-demand services in accordance with the invention. System 102 may provide additional information to one or both of the consumer or provider devices as necessary to implement the functionality as described herein. The input data and information from a consumer or provider, provided through their devices, may be utilized to set up various user records associated with requested and scheduled service jobs. Such records may be maintained on the service system and provided to the mobile devices as needed. The user records may include a variety of different information about a consumer, about a provider, about the job location, about the job type, as well as information about the location of the consumer and job, location of the provider, distances between the provider and a job site, about the duration of a job, billing information, cost information, etc., for the completion of a job in an on-demand environment. The user records created may be constantly edited depending on inputs from one or both of the consumer and provider as discussed herein. The service system 102 provides a platform for the invention implementation of the beginning, ongoing progress, and completion of one or more jobs between system users in addition to providing access to other systems for obtaining information needed by the overall service system, the consumer(s) or provider(s).

Consistent with embodiments of the invention, an interface, such as a web-based user interface, may provide user access to information on the service system 102 regarding jobs. A user such as the consumer or provider may access the web-based user interface with an Internet web browser. In some embodiments, the interface generated by the service system 102 may be a dedicated interface, such as an interface that may be provided by a special purpose application. In one embodiment, as discussed herein, the service system 102 maintains the various consumer and provider records/profiles and job histories. Through an appropriate web interface, as known to a person of ordinary skill in the art, a user (whether a consumer or provider or other user) is provided a portal where they might access and edit their records or profiles, might review job histories and information, may change any passwords used in the invention, or control various job states.

Moreover, consistent with embodiments of the invention, a mobile device 104, 106 may be registered with the service system 102 such that the mobile device 104, 106 is linked with one or more user records for a registered user of the system, such as a consumer or provider. The users interface with the user records using the mobile devices. After registration with the service system, the mobile devices may be configured to execute their respective Apps to cause the mobile device monitor the progress of the job and interaction by the consumer and provider and provide and capture various job states. The various job states that are set by the mobile devices are then stored by the backend service system.

FIG. 2 provides an exemplary block diagram that illustrates components/elements of the one or more servers 107 that may be part of the backbone providing of the service system 102 consistent with embodiments of the invention. Such servers for implementing system 102 may include one or more application servers, database servers, or other suitable servers as needed for processing, storing, accessing and securing the data needed for the invention and interfacing with the various client mobile devices. The service system server 107 includes at least one processor/processing element or CPU 122, such as a hardware-based microprocessor, and a computer readable medium or memory 124 that is coupled to at least one processor 122, such as for storing or carrying the software that includes the executable instructions that are executed by the processor 122 or other processing element. The memory 124 may represent the random access memory (RAM) devices comprising the main storage of the service system 102, as well as any supplemental levels of memory, e.g., cache memories, non-volatile or backup memories (e.g., programmable or flash memories), read-only memories, etc. In addition, memory 124 may be considered to include memory storage physically located elsewhere in the service system 102, e.g., any cache memory in a microprocessor, as well as any storage capacity used as a virtual memory, e.g., as stored on a mass storage device or on another computer coupled to the service system 102. Examples of memory elements may also include hard drives, CD or DVD units, magnetic memory etc as noted further herein.

For the interface with a user or operator, the service system 102 may include a user interface 126 incorporating one or more user input/output devices, e.g., a keyboard, a mouse or other pointing device, a display, a printer, etc. Data may be communicated by the system 102 to and from another device, computer or terminal (e.g., the consumer device 104, the provider device 106, etc.) over a suitable network interface 128 that is coupled to the appropriate communication network 103. The network interface 128 may include multiple interfaces, such as with various servers, and other suitable interfaces for connecting the elements that form the backbone for implementing the system 100 of the invention. Also, the server may include one or more API (application program interface) layers 144 for interfacing with the devices 104, 106 as well as one or more third party systems/servers as discussed herein. The service system 102 also may be in communication with one or more mass storage devices, which may be, for example, internal hard disk storage devices, external hard disk storage devices, external databases, storage area network devices, etc, through suitable networking interfaces as indicated at 128. As such, system 102 may be implemented through one or more servers 107 and the software and hardware components will be referred to generally herein as the “service system”. The various interfaces, 126 and 128 are implemented through appropriate hardware and software components as is known to a person of skill in the art.

The service system 102 servers may typically operate under the control of an operating system 130 and execute or otherwise rely upon various computer software applications, components, programs, objects, modules, engines, data structures, etc., including for example, a service application 132. In one embodiment, the service application 132 is configured to work with each of the various devices 104, 106 for exchanging information, interfacing with other services, managing data and providing the data used in executing both the provider application and consumer applications operating on the devices 104, 106 in implementing the features of the invention. The memory 124 of the service system 102 may generally include or provide one or more databases 140 that may store one or more user records 142. A database in system 102 might also involve a separate database server that interfaces with server 107 as appropriate. In general, each user record 142 of the status database may be associated with a registered user that had registered with the service system 102, and the user record may store job information, user profile information, job status or state information and other information for one or more mobile devices that are linked to the registered user and/or were registered by the particular registered system user.

The database(s) 140 may comprise data and supporting data structures that store and organize the data used by the invention, including data from the mobile devices, data input from the users, user records associated with consumers, providers and the on-demand jobs scheduled and/or in progress along with other data and information. In particular, the databases 140 may be arranged with any database organization and/or structure including, but not limited to, a relational database, a hierarchical database, a network database, and/or combinations thereof. A suitable database management system in the form of a computer software application executing as instructions on a processor 122 of the service system 102 may be used to access the information or data stored in records of the databases 140 in response to one or more queries, where a query may be dynamically determined and executed by the operating system 130 and/or other applications 132, as is known in the art.

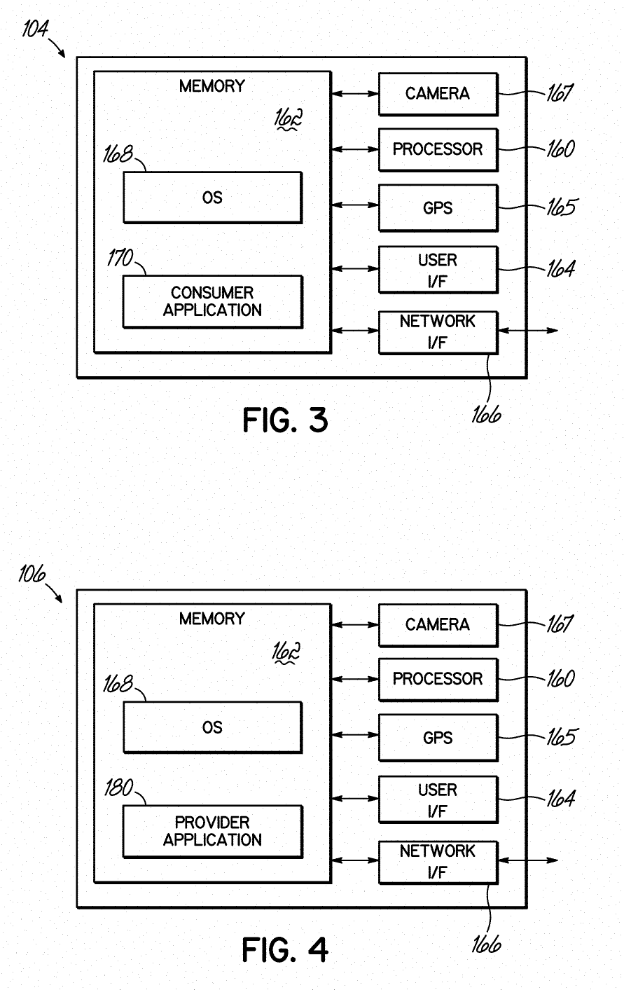

FIGS. 3 and 4 provide exemplary block diagrams that illustrate the components of the mobile devices 104, 106 consistent with embodiments of the invention. Generally multiple mobile devices 104, 106 are part of the system 100 of the invention for use by both consumers and providers. The mobile devices 104, 106 include at least one processor element or processor 160 including at least one hardware-based microprocessor and a memory 162 coupled to the at least one processor 160. The memory 162 may represent the random access memory (RAM) devices comprising the main storage of the mobile devices 104, 106 as well as any supplemental levels of memory, e.g., cache memories, non-volatile or backup memories (e.g., programmable or flash memories), read-only memories, etc. In addition, memory 162 may be considered to include memory storage physically located elsewhere in the mobile devices 104, 106 e.g., any cache memory in a microprocessor, as well as any storage capacity used as a virtual memory, e.g., as stored on a mass storage device or on another computing device coupled to the mobile devices 104, 106. As described above with respect to the service system 102 of FIG. 2, the mobile devices 104, 106 may include one or more appropriate user interface(s) 164 for interfacing with a user and one or more appropriate network interface(s) 166 for communication over the one communication network 103. The user interface 164 refers broadly and generally to any suitable input and output elements and related hardware/software for receiving data/information from a user and displaying data/information to the user. For example, with a computing device 104, 106, the user interface might include hardware components such as a keyboard, microphone, speaker, touch screen, display screen etc. and appropriate interface software for communicating or interfacing with a user. Generally, most mobile devices, such as phone or tablet devices, rely upon their touch screens to provide a suitable user interface for engaging the devices and the applications they run and for inputting data/information and displaying various communicative outputs and data/information associated with the invention. The same screen is both the input interface and output interface as described in the embodiment illustrated herein. The network interface provides the hardware/software interface suitable for communication with other computing devices, such as service system 102. For example, such a network interface may include a cellular network interface, as well as a wireless or Wi-Fi interface or other suitable network interfaces for communication over one or more network(s) 103.

The mobile device 104 typically operates under the control of an operating system 168 and/or application and executes or otherwise relies upon various computer software applications, components, programs, objects, modules, data structures, etc., including for example, a consumer application or consumer App 170 in accordance with the invention. The consumer App 170 may be executed by the processor 160 of the mobile device 104 so that a consumer, for example, can order an on-demand service, can monitor the provision of that service and various conditions related to the service job, and pay for the job, as discussed further herein. The consumer application also is used to interface with the service system 102 and provider and provider device 106 in accordance with the invention. Data and inputs are entered by the consumer through the user interface 164 and information is displayed also through the user interface.

In one embodiment, the consumer application 170 may be implemented as a downloadable application or app, such as an application supported by Android and iOS operating systems available from Open Handset Alliance and Apple Computer, respectively, or in other forms of program code as appropriate for a particular mobile device, such as a mobile phone or pad device, for example. In some embodiments, the consumer application 170 may be downloaded to a device 104 from an external source including for example, a network accessible location (e.g., a mobile application store, an accessible database), a computer readable storage media, and/or other such external sources.

Device 104 may also implement a GPS functionality for providing location information associated with the user as described herein. In the current invention, the location of the user and provider are used to determine arrival times, navigation directions and job start times as well as other information that allows the consumer and provider to make decision on the job execution. As such, the device 104 will generally include GPS functionality 165 as implemented with known hardware/software elements to provide the device and ultimately the service system 102 the necessary information regarding the location of the device and thus the location of the user. As discussed herein, the invention will use the location information as provided by the devices 104, 106 and GPS functionality 165 and combine that information and data with other sources or databases, such as from third party systems 108. The third party systems, often interfaced through the API layer 144 of the service system 102, provide map information and other granular location data associated with a user. In that way, maps can be displayed, distances of separation between the user and provider calculated, travel times determined, navigation directions provided, charge rates calculated, points of interest displayed etc., as is known in the art.

The devices 104, 106, as with typical mobile devices, will also usually have some kind of camera functionality 167 for capturing still images or videos as is known in the art. The present invention uses the camera functionality as in input interface as discussed herein.

FIG. 4 provides a block diagram, similar to that of FIG. 3, that illustrates the components of the client device 106 consistent with embodiments of the invention. The provider device 106 may be similar to the consumer device 104 (for example, two mobile phone devices) and thus the various elements are illustrated with similar reference numerals and operate as noted with respect to FIG. 3. However, since the provider device is used by a service provider and thus creates that side of the invention as described herein, the device 106 will generally be running a different provider application 180. Of course, a provider of one service might also act as a consumer of another service and so both Apps 170, 180 may be resident on the same device. Using a provider application, a service provider can, for example, respond to and provide on-demand service, interface with the consumer in the provision of that service, track the time of the service and costs, and be paid for the completed job as discussed further herein.

In general, the various executable software routines that are executed to implement the embodiments disclosed herein, whether implemented as part of an operating system or a specific application, component, program, object, module or sequence of instructions, or even a subset thereof, may be referred to herein as “computer program code,” or simply “program code.” For the particular invention, the client parts of the code are referred to as the “App” associated with each client. The program code/App generally comprises one or more instructions that are resident at various times in various memory and storage devices in a computer, and that, when read and executed by one or more hardware-based processing units in a computer (e.g., processors, microprocessors, processing cores, or other hardware-based circuit logic), cause that computer to perform the steps embodying desired functionality. Moreover, while embodiments have and hereinafter will be described in the context of fully functioning computers/devices and computer systems, those skilled in the art will appreciate that the various embodiments are capable of being distributed as a program product in a variety of forms, and that the invention applies equally regardless of the particular type of computer readable media used to actually carry out the distribution. Furthermore, as functionality of the system might be distributed between the various components, such as system servers, mobile devices, and other components, the invention is not limited to specific components handling specific functions. As discussed herein, software program code as a module or component may exist on a hardware component independently of other program code or it can be a shared element of other code.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by a computer or other device. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code/Apps described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

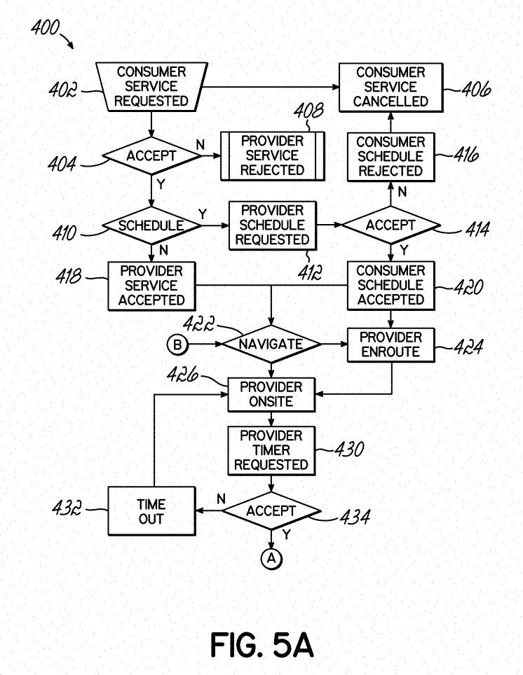

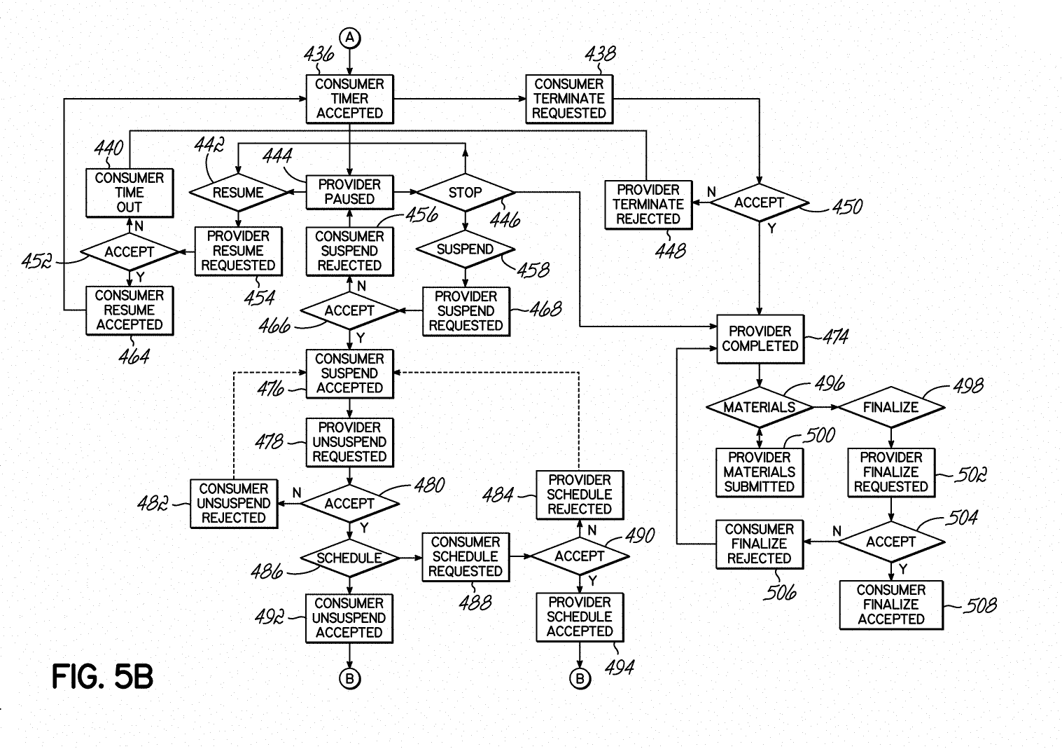

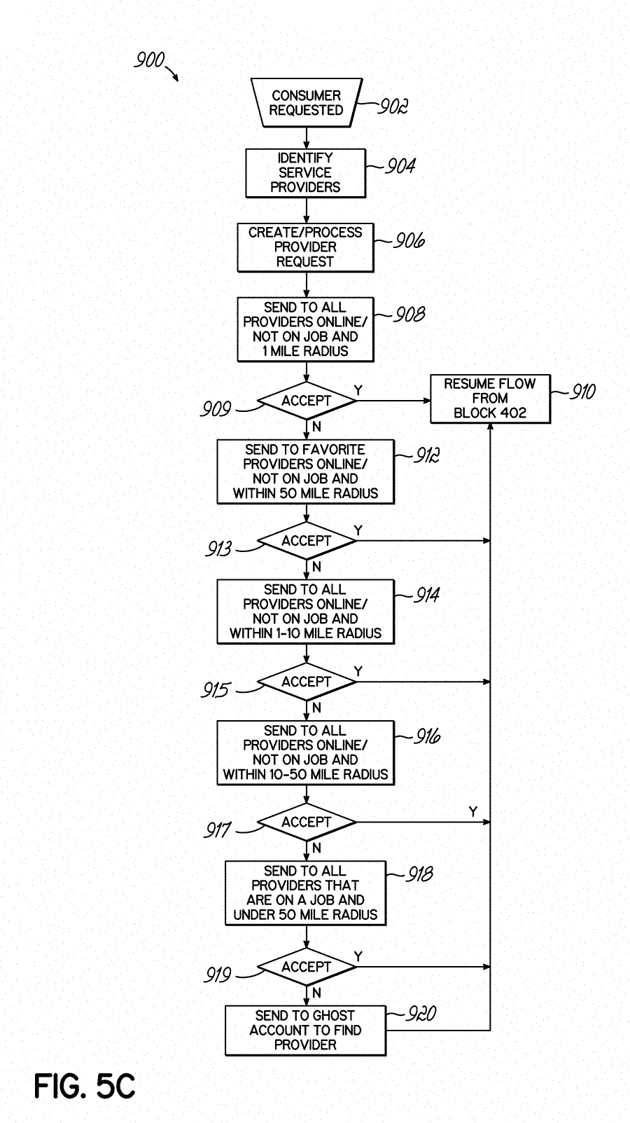

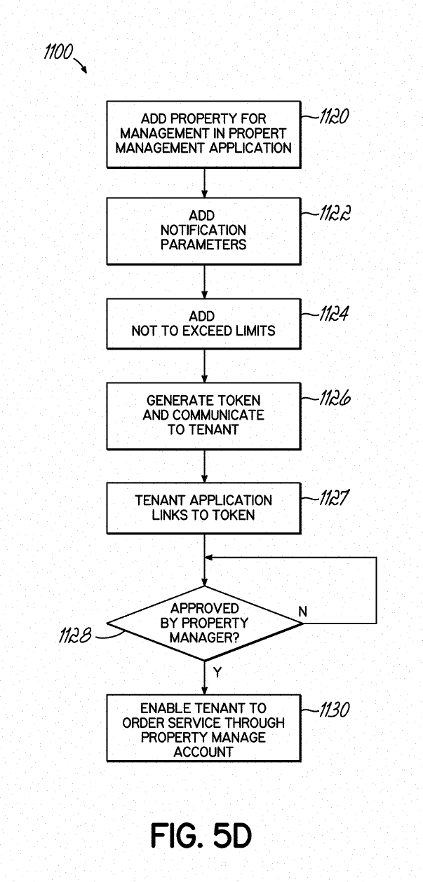

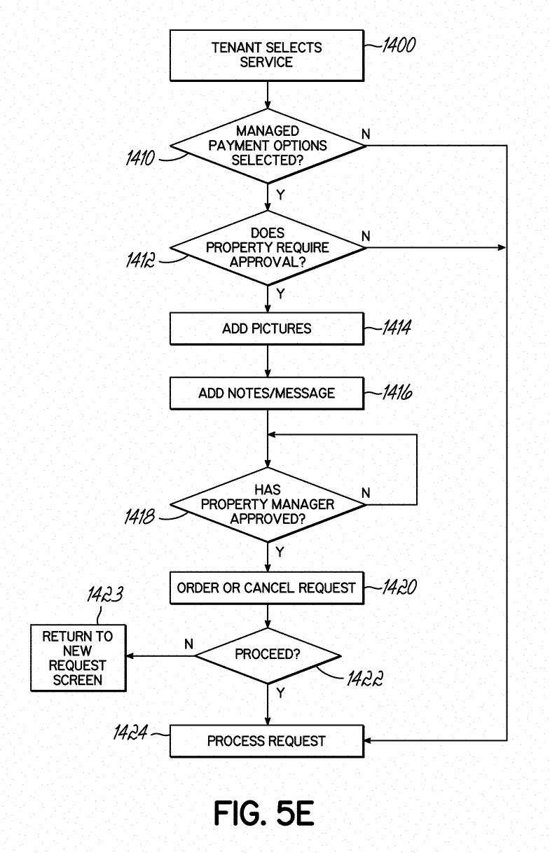

Turning now to various additional figures as illustrated herein, the operation of the invention is described. The invention incorporates an interaction between both a consumer and a service provider, which each have their own devices, and the interaction of each of the devices with service system 102 as described herein. FIG. 5A-5B illustrate one embodiment of a workflow or flowchart in accordance with the invention and will be described in combination with various figures of user interfaces of the mobile devices (screens/screen shots) that illustrate the communicative interfaces and input/output platforms for each of the devices 104, 106 as provided by the user interfaces 164 associated with the devices. The various Blocks of the flowchart illustrate the various actions and decision points and branches provided by the invention and the interaction of the consumer and provider. The different users will take different actions and provide inputs to control the flow of the applications. The various inputs will then result in various job states that change and are set by the devices 104, 106 acting with system 102 and then stored appropriately on the service system/server 102.

With mobile devices having touch screen user interfaces that provide both a display and also various input fields that are activated by touching the field or screen, the input and output flow of the invention is illustrated through the various screens. Accordingly, the various screen shots of the figures illustrate the program flow of the invention, and when the application notes a consumer screen or provider screen is presented or provided to the user, this makes reference to the operation and running of a respective consumer or provider App that then generates the user interface that is reflected in the screen for both providing output information and then capturing user inputs. The input fields may be in various forms, such as a portion of the screen, button fields, icons, sliders, thumbnails, bars, drop down menus, etc, and so herein such input fields will often be referred to as just “fields” to indicate the input user interface. Such fields are touched or engaged by the user. The invention is not limited to the way in which the portions of the screen are arranged to capture the desired touch inputs or touch engagement. Similarly, the screen is a display and thus the output user interface will display various text and other information through the progress of the invention and the ordering of on-demand service. As such, various notifications, messages, informational displays, menus, alerts, dialog boxes, modal dialog boxes, windows, etc displayed on the screen will also be generally referred to as “notifications” to indicate the output user interface and the invention is not limited by the output screen display nomenclature.

Each of the Apps, including the consumer application 170 and provider application 180 are separately addressed initially to show the engagement by a consumer or service provider. Herein, the terms “application” and “app” or “App” are used interchangeably when referring to the consumer application/App 170 and provider application/App 180. The Apps are executed by the respective devices where they reside and request inputs

### Consumer Application/App

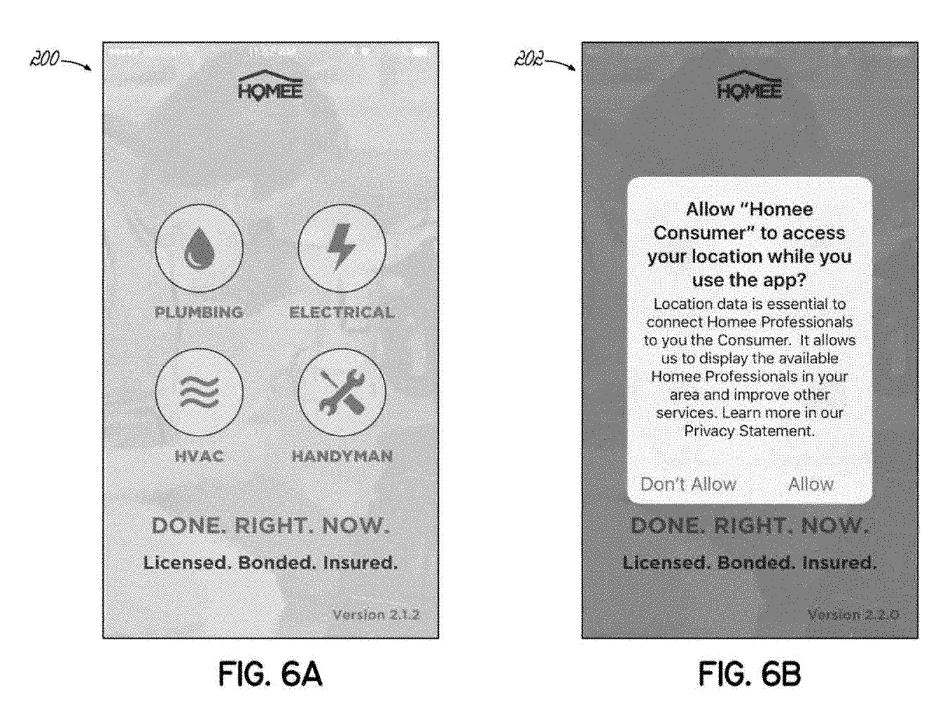

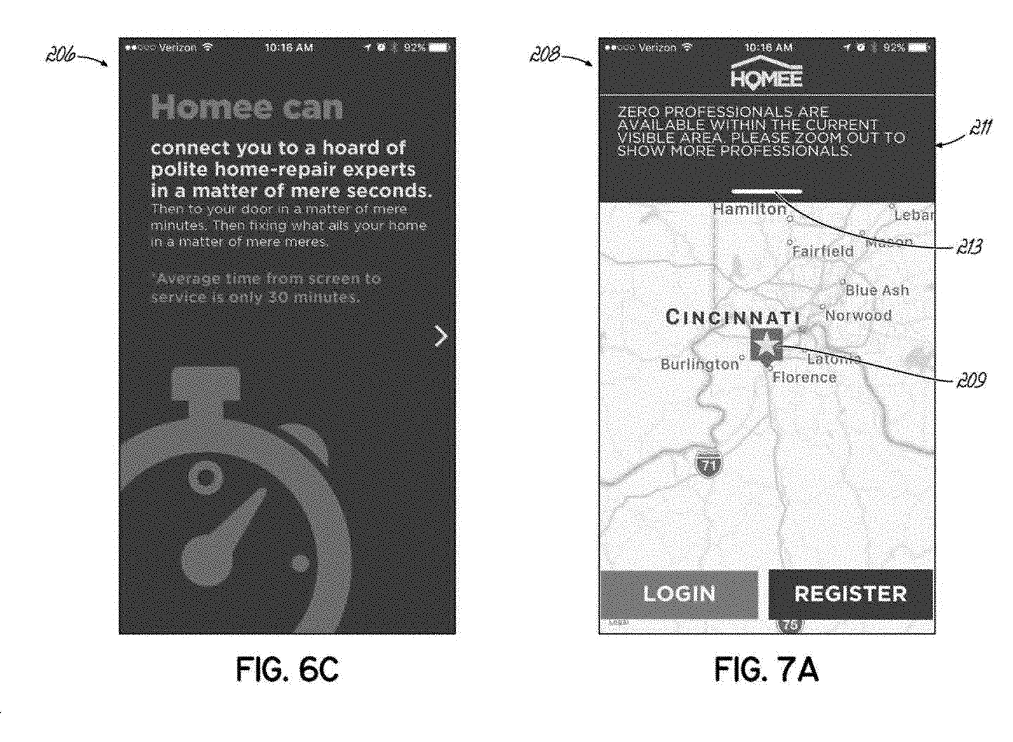

The consumer App is downloaded in a suitable fashion, such as from an App store or other source, onto the consumer device 104. Upon download and installation of the consumer application 170 on a supported device (e.g., phone and/or tablet, Android and/or iOS), a landing screen 200 is presented to a user as shown in FIG. 6A that illustrates the App title, one or more tag lines and various icons/imagery along with other information that shows available on-demand services offered through the invention, such as plumbing, electrical, handyman and HVAC services. Of course, other services may be offered in accordance with the invention.

Because the consumer App requires location tracking and relies on device notifications, various permissions are needed from the consumer user. For example, for downloading the App, the App Stores may require location access and messaging notification permission and thus screens notifying and requiring user acceptance are shown. FIG. 6B illustrates an exemplary location access permission screen 202 having informational fields and input fields and the message notification permission screen might be similar with different information, as is known in the art. Generally, these screens are one time notifications per installation but might be shown again if a user uninstalls the App and then reinstalls it. After the initial landing screen and subsequent notifications, users might be presented with informational screens, like screen 206 of FIG. 6C, which overview various details associated with the App and the use of the service. One or more splash screens might be shown periodically to a user following the initial display.

Once a consumer swipes through or provides inputs to the initial screens and splash screens, a map screen 208 is presented that shows the location of the consumer centered on a map view. As noted, the GPS functionality 165 of the consumer device and third party location services accessed through the service system 102 are used by the consumer App 170. The location is generally centered on the map view with a custom pin icon 209 as illustrated in FIG. 7A. Any in-app notifications/messaging may be presented to the user in a section 211 of the screen which animates from the top of the screen. One such notification as illustrated in FIG. 7A is that there are no service providers or professionals that are within the viewed map area. The consumer is then instructed to zoom out in the view to locate providers. Such notifications like that shown at 211 may be expanded or collapsed utilizing the sliding of a horizontal line icon 213 as is shown. The consumer interacts with the map view of FIG. 7A to pan, zoom in or zoom out, slide or otherwise present touch input using the standard device gestures for a touch screen (push, pinch fingers to zoom in, tap and move to pan) as are known to a person of ordinary skill in the art.

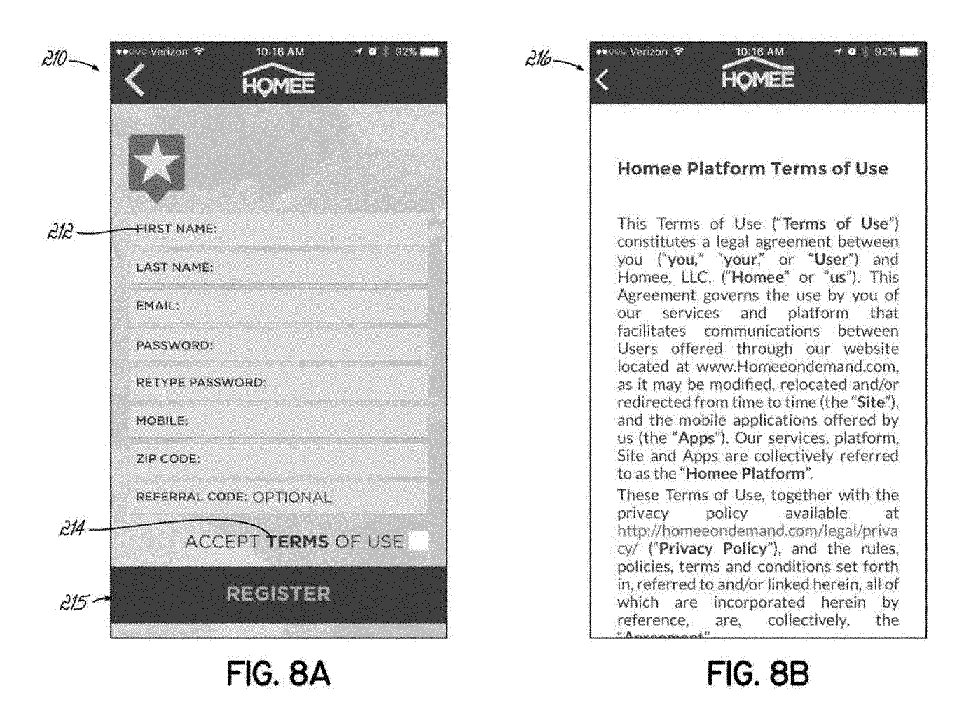

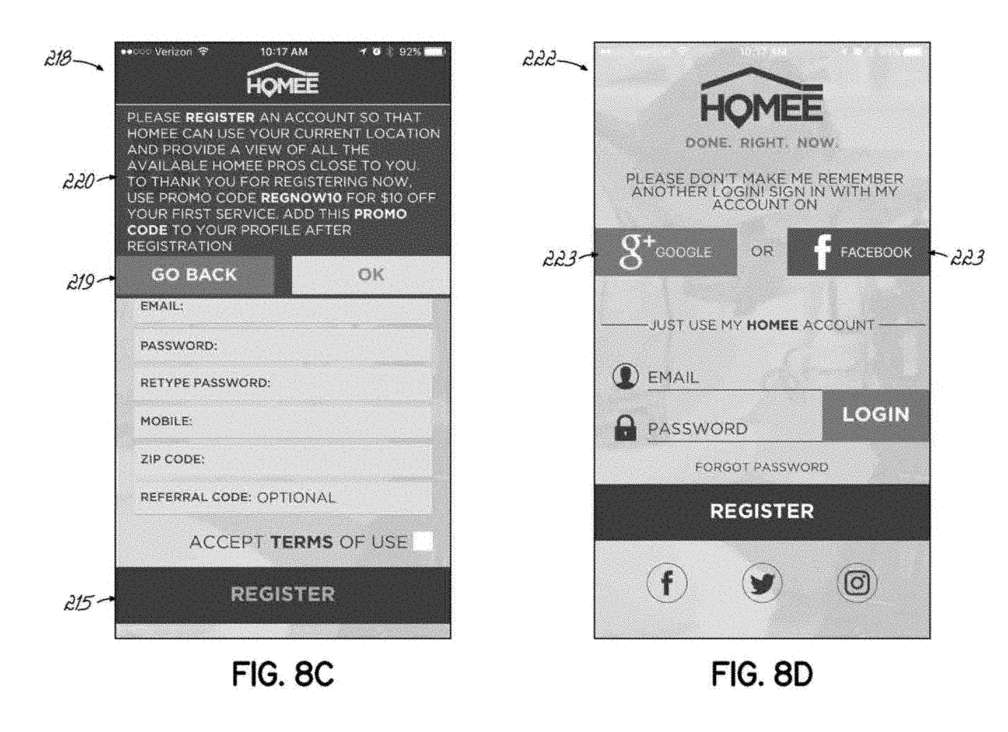

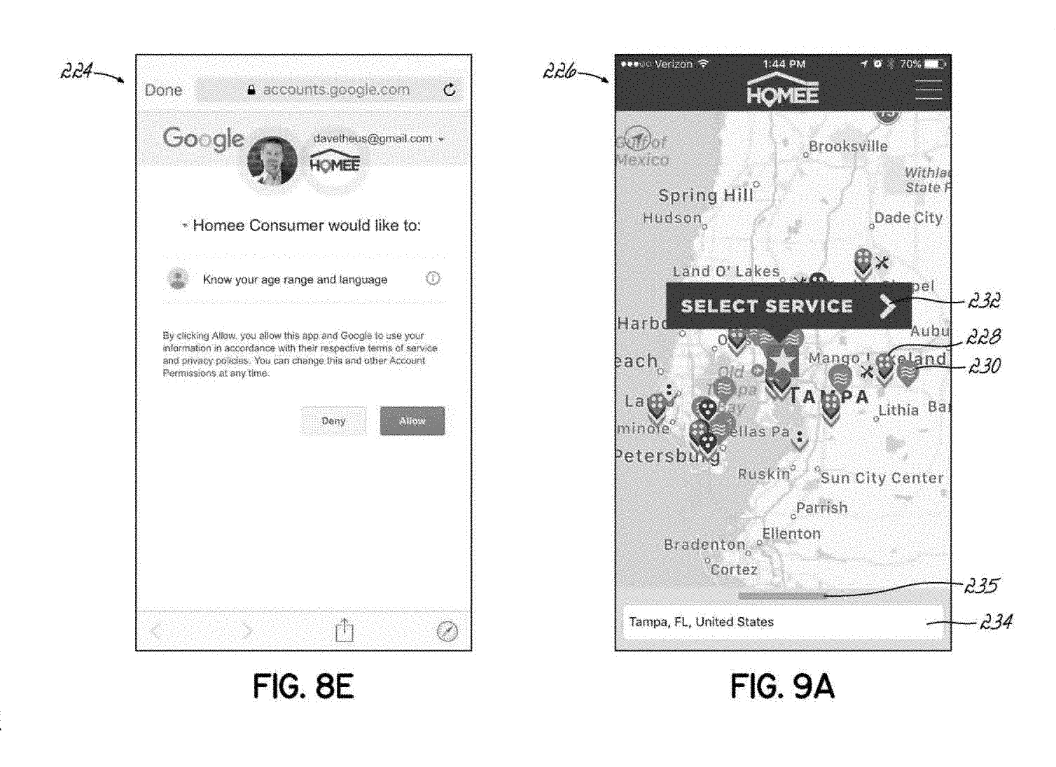

If a provider is determined and the consumer would like to engage one for on-demand service, a consumer is required to either Login (with existing credentials) or Register to create a new account. A user registration screen might be used as illustrated in FIG. 8A and will prompt the consumer to enter data, such as through the touch screen fields. The registration screen 210 includes a plurality of data entry fields 212, some of which will be required fields/selections. A term field 214, indicated by the text “TERM” at the bottom of the screen is a hyperlink to the Consumer Legal Terms of Use which are located on a website that is provided as part of the service system 102 and can be accessed through the network 103 and service system 102 to be displayed on a screen by tapping or engaging the Term link 214. FIG. 8B provides illustration of one screen 216 of usually multiple screens showing the terms. A consumer must then accept these terms, such as by engaging a box field proximate the Term link 214, and then engage and provide input to a Register field 215 to process a successful registration which is required to utilize the full consumer App.

If a user views the registration screen 210 but does not submit a completed registration and goes back (via field 219) to screen 218 to view the original Map view, the App may display an in-app notification offering a promotional code to continue the registration process until completion (see FIG. 8C). Such promotional codes and vouchers may be managed by the service system 102 or external third parties and systems 108 that are accessed by the service system 102, such as through network 103. The codes and vouchers may be displayed, verified and utilized by the consumer App. Once a consumer has registered successfully and the consumer account is created and an appropriate consumer account record created, consumers are then presented with a login screen 222 as shown in FIG. 8D. The consumer can use the data/information that they provided on the registration screen 210 (email and password, for example) for inputs for the login. Alternatively, they can use various social credentials as illustrated by fields 223 in screen 222 of FIG. 8D. For example, the service system 102 may utilize OAuth or some other authorization standard or program to link to one or more social accounts from third party services 108 and to the respective credentials to the user account/record associated with consumer. In the illustrated embodiment, both Facebook and Google might be utilized for social logins as seen in FIG. 8D. Another input screen may then appear when the fields 223 are engaged. For example, FIG. 8E illustrates a screen 224 presented from Google that grants the device 104 and service system 102 access to allow authentication, such as through OAuth. The user allows or denies the use of the information for the invention.

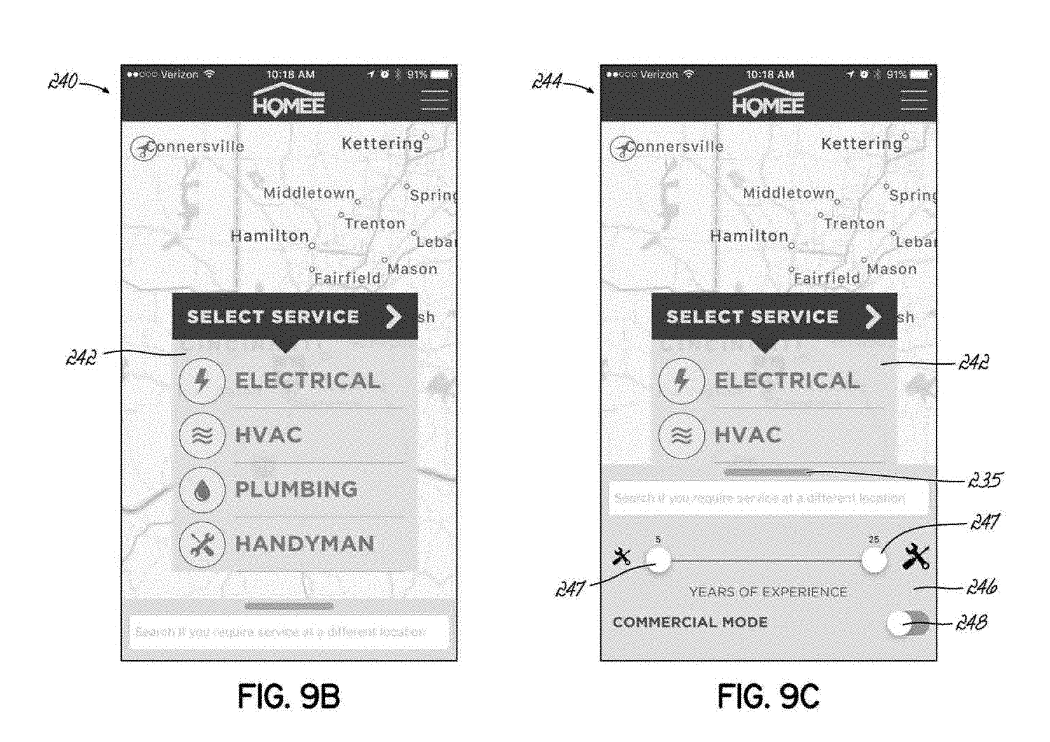

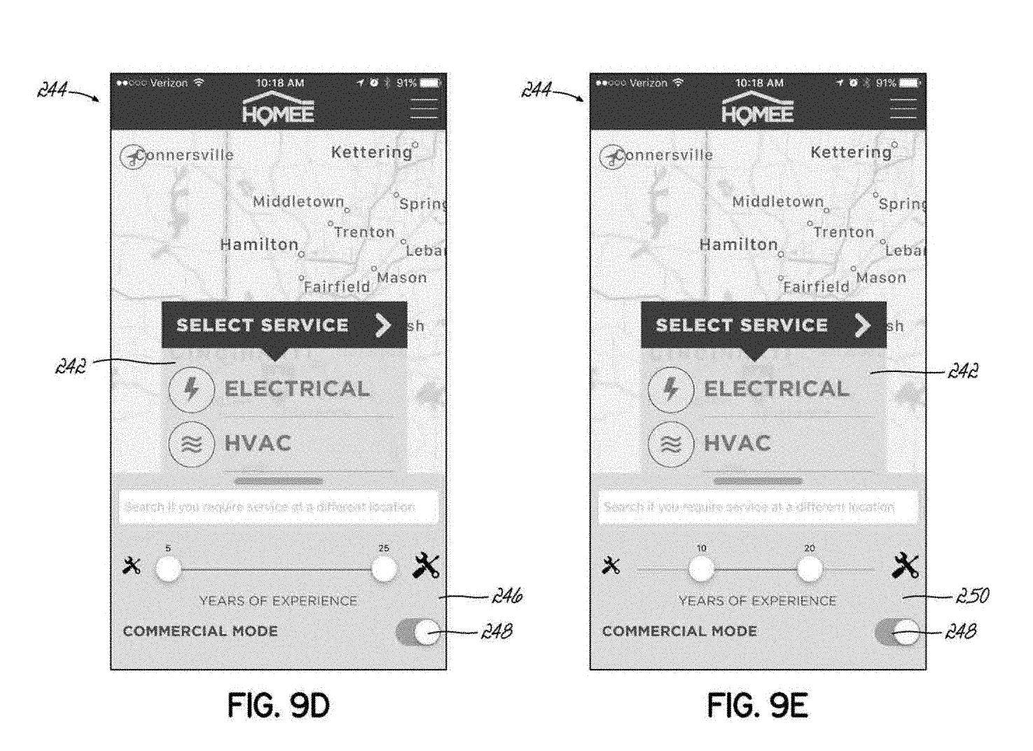

After successful login, the consumer is presented with an authenticated map view screen 226 as shown in FIG. 9A. Generally, a consumer's session lasts indefinitely unless they logout of the App or a new App version upgrade requires them to re-authenticate. This map view 226 displays the consumers current location as well as various pins 228, 230 of the various service providers and professionals located in the current specific map view, or alternatively displays a notification that there are no or “zero” providers. (see FIG. 7A for example). From this screen 226, the consumer can engage the “Select Service” field 232 to select an on-demand service in accordance with the invention to specify the type of on-demand service or trade they require. As shown in FIG. 9B and fields 242, available services are shown for selection by engagement of one of the fields and discussed further herein. For the map screen 226, the consumer can use the advanced controls located at the bottom of this Map view screen. The advanced control area allows for various ways to filter and control the map. First is the Location search bar 234, consumers can type in various locations and the map feature of the consumer App will then reposition the screen around that location (city, state, longitude/latitude, POI, etc.) and use that location as a job location for requesting service. A user can expand that advanced controls section by swiping up on the horizontal icon 235 as well to display further features. The map screen 226 is populated with various pins or icons 228, 230 corresponding to local (per map view) providers based on provider records and data from the records previously set up and populated from a provider App as discussed herein and managed by service system 102 for use by the consumer App.

In accordance with one feature of the invention, based on the information in the provider records, the providers may be filtered and sorted according to the on-demand needs of the consumer. Specifically referring to FIG. 9C and screen 244, an upward swipe on icon 235 exposes a filtering functionality and field 246 for the available providers based on years of service and also a toggle functionality and toggle field 248 for selecting licensed and unlicensed providers. Referring to FIGS. 9C-9E, the sliders 247 in the input field 246 control the filtering functionality for the Years of Experience filtering based on provider data in the provider record/profile for a provider as discussed herein. The sliders 247 set the range of years of experience and the consumer App filters dynamically so that the map view 244 only displays those providers meeting the filtering criteria. The left hand slider 247 controls minimum experience and the right slider controls the maximum experience of the filtering range. The Commercial Mode toggle field 248 might be activated to provide filtering base on license data in a provider profile. With the toggle in the off position, the map screen 244 displays both licensed and unlicensed providers. With the toggle in the on position, the consumer App provides further filtering and the map screen only displays licensed providers. With the combination of the map location search function, the Years of Experience slider and the Commercial Mode toggle, the consumer has full control of the network of on-demand service providers that a job request will be sent to. Therefore, in accordance with one feature of the invention, the criteria of trade type, location, years of experience, and license carrying are utilized for assisting a consumer in selecting a service provider.

### Provider Application

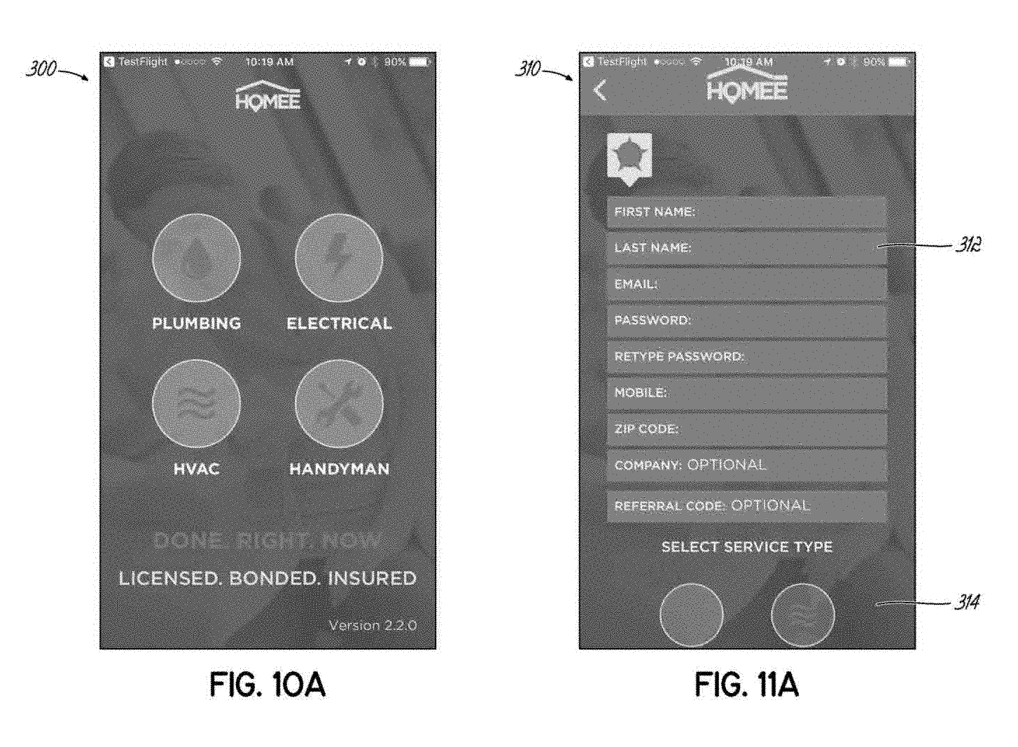

In accordance with another feature of the invention, the service providers of the on-demand services interface with the inventive system 100 through a device 106 that runs a provider application 180. The provider application 180 is downloaded in a suitable fashion, such as from an app store, onto the provider device 104. Upon download and installation of the provider application 180 on a supported device (e.g., phone and/or tablet, Android and/or iOS), the App provides a landing screen 300 that is illustrated to a user as shown in FIG. 10A and that has the App title, one or more tag lines and various icons/imagery along with other marketable information that shows available on-demand services offered, such as plumbing, electrical, handyman and HVAC services. Of course, other services may be offered in accordance with the invention.

Because the provider App also requires location tracking and relies on device notifications, various permissions are needed from the provider user as well. For example, for downloading the App, the App Stores may require location access and messaging notification permission and thus screens notifying and requiring user acceptance may appear similar to FIG. 6B that illustrates an exemplary location access permission screen 202. Again, the message notification permission screen might be similar with different information, as is known in the art. Generally, these screens are one-time notifications per install but might be shown again if a user uninstalls the App and then reinstalls it.

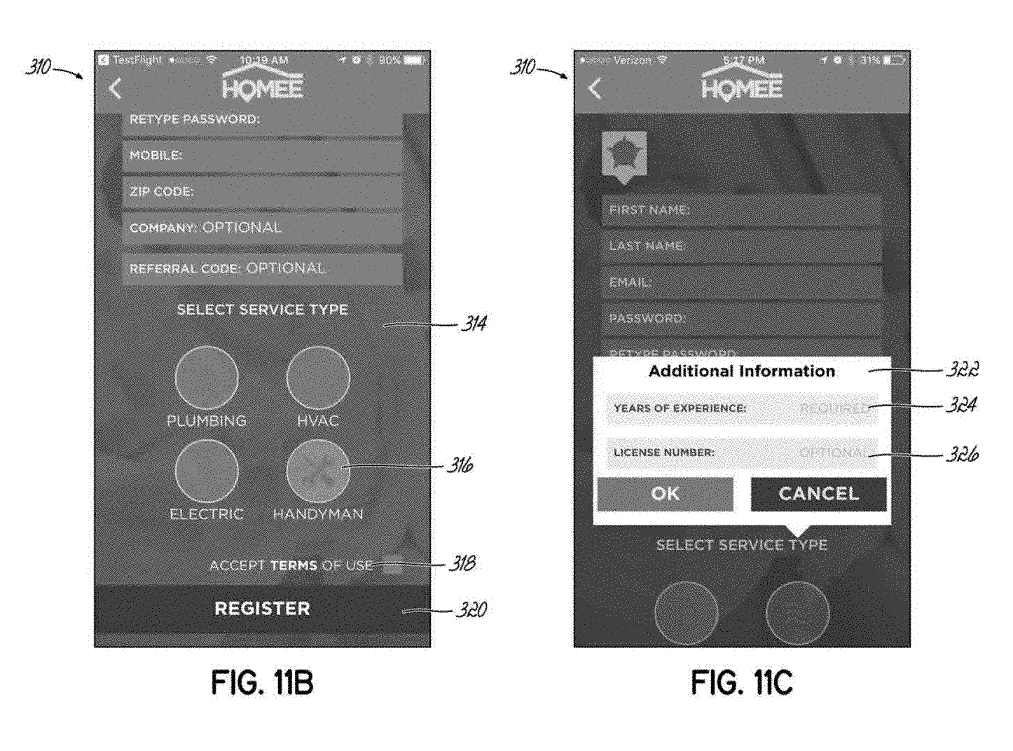

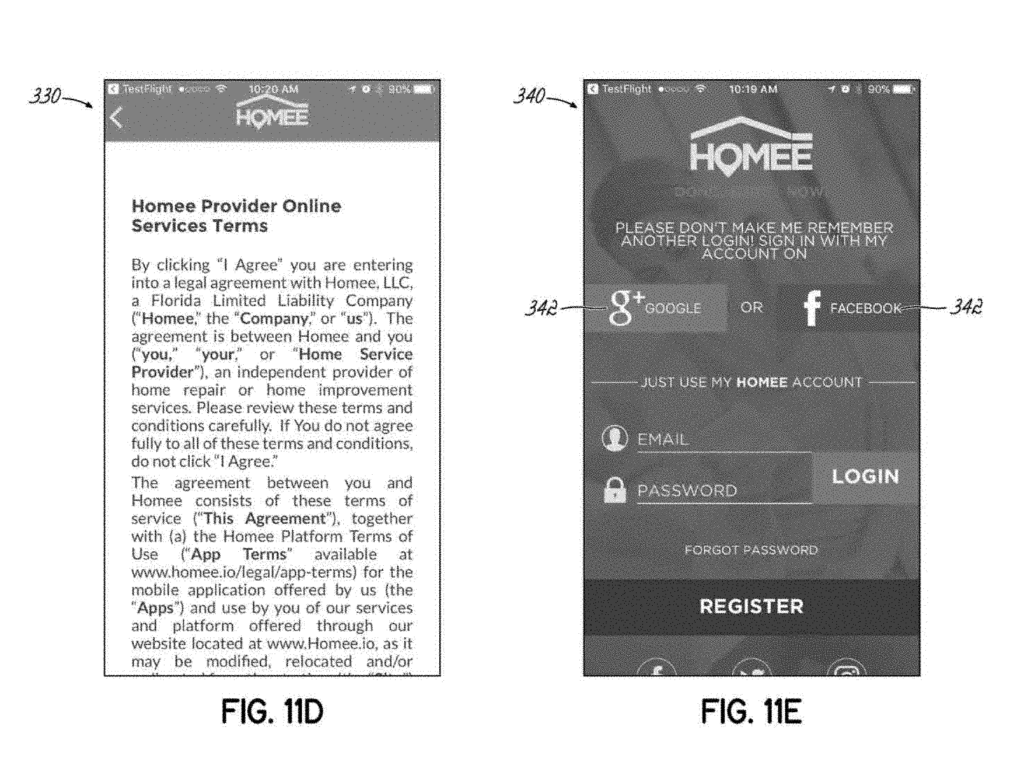

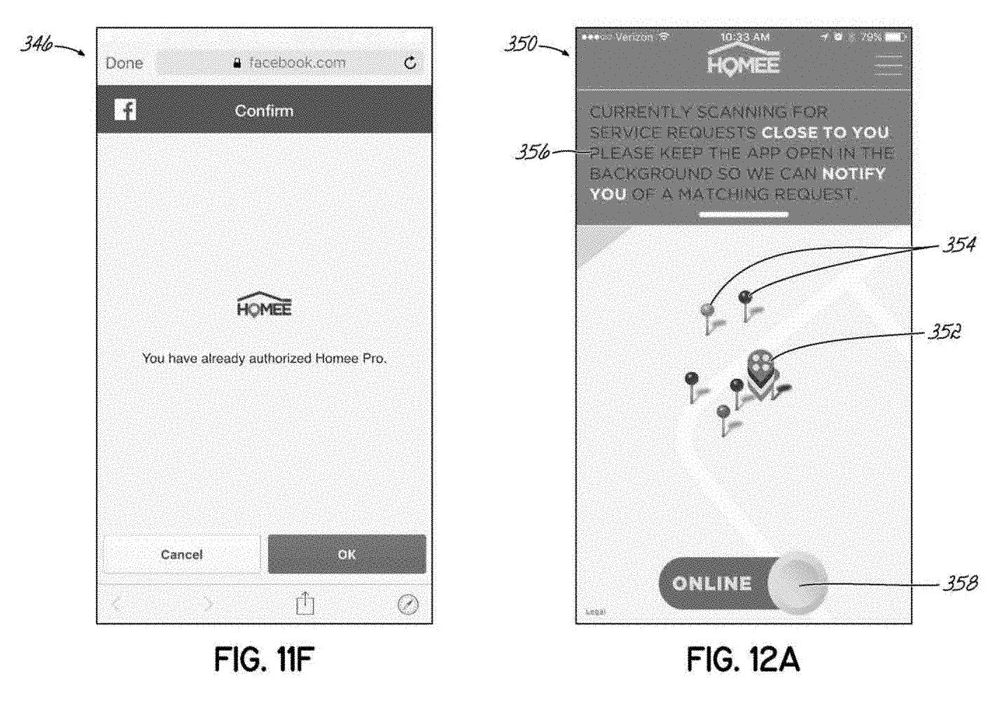

After the initial landing screen and subsequent notifications, a provider might be presented with screens, where the provider is required to either Login (with existing credentials) or Register to create a new provider account/record. A user registration screen might be used as illustrated in FIG. 11A and will prompt the provider to enter data in certain fields, such as through the touch screen. The registration screen 310 includes a plurality of data entry fields 312, some of which will be required fields/selections. A term field 318, indicated by the text “Term” at the bottom of the screen is a hyperlink to the Provider Legal Terms of Use which are located on a website that is provided as part of the service system 102 and can be accessed through the network 103 and service system 102 to be displayed by the provider App by tapping or engaging the Term link 318. FIG. 11D provides illustration of one screen 330 of usually multiple screens showing the terms. A provider must then accept these terms, such as by engaging a box field proximate the Term link 318, and then engage a Register field 320 to process a successful registration which is required to utilize the full consumer App.

Referring to FIG. 11B, provider information such as the type of service to be provided by the service provider may be selected through a field or icon 316 in the larger field 314 wherein various services are listed. As seen in FIG. 11C, the screen 310 might also employ one or more pop-up fields 322 that request additional optional or required information such as the Years of Experience and License Number, that is used to further populate a provider profile/record with data that might then be used for filtering by a consumer as noted herein. The provider can then engage the Register field 320 for completing registration.

Once a user has registered successfully a provider account/record is created. As noted, the various consumer and provider records and profile information are stored by the backend system 102. For example, the provider is required to fill out a background check form with additional information. As part of the registration, the provider gives information that is required for performing a background check. For example, the provider may have to provide input data for their social security number, date of birth, email addresses, first and last name and other data details, which are then used for an extensive background check. The provider/account is unable to go online within the provider App until the background check is cleared. In accordance with one embodiment, a third party system/service 108 is accessed by the provider device 106 and service system 102 for providing the background check service. For example, in one embodiment, Checkr (www.checkr.com) may be one of the possible third party services used by the system 100 of the invention for background checks.

In one embodiment of the invention, the system 100 checks for the following information, including an identity and criminal record:

### 1. Identity Check

IDENTITY VERIFICATION—a Social Security Number (SSN) verification is the most efficient way to verify a provider's identity. If an identity cannot be verified, the third party system alerts the applicant to request additional documentation.

ADDRESS HISTORY—The Identity Check includes a trace of all known addresses over the multiple years. Based on that information, third party services searches relevant court jurisdictions for the same time period.

### 2. Criminal Records Check

SEX OFFENDER REGISTRY CHECK—A thorough background check includes a Sex Offender Registry Check. The third party searches registries for every state. The data returned includes date of registration and current status.

CRIMINAL RECORDS CHECK—The third party service performs direct searches of Federal, National, State and county court records for relevant information. This search is part of the baseline for establishing due diligence. Results include felony and misdemeanor criminal cases as well as, charges, disposition, dates and sentencing information.

GLOBAL WATCHLIST CHECK—This check searches known domestic and international terrorist watchlists as well as the records of the Office of Inspector General (OIG), Excluded Parties List (EPL) and additional domestic and international agency lists.

COUNTY AND FEDERAL CIVIL RECORDS CHECK—This check provides access to Superior (upper) and Municipal (lower) courts for civil records, as well as those presided over by the federal district court system.

The backend is automated such that when a background check is set to Clear status or has been manually cleared, the third party system triggers an update to the provider's account/record. For example, a flag may be set that shows the provider has a cleared background. Even with a cleared background, the provider is still unable to go online for taking jobs at this point until they have entered all of their deposit account information as noted herein. Once the provider's account is created and they have a verified and cleared background, the provider is also designated in their record as an authorized buyer for a professional service account at a third party supply company as discussed further herein. In the illustrated embodiment of the invention, the service system 102 interfaces with a vendor such as Home Depot or Lowe's for providing a Professional Services account. This account allows the provider to procure parts at a particular store. For example, as noted herein, various jobs may require the purchase of certain parts or materials or other items. A provider that has a provider account/record pursuant to the invention would engage at a store and indicate that they are part of the system of the invention (a brand for the invention, such as HOMEE, might be used for the provider to designate that they are part of the HOMEE system 100). They then present a valid picture ID to the personnel of the store, such as a cashier and have that person input a particular Job ID that is associated with a job as discussed herein. They can then have the parts, or materials, or other items charged to an account associated with the job ID through a cashless transaction. The parts/materials are then linked by Job ID to the system of the invention and can be retrieved in the provider App electronically and then submitted as part of the final transaction to the consumer upon completion of the job.

Once a provider has registered successfully and the account is created and an appropriate account record created, providers are then presented with a login screen 340 as shown in FIG. 11E. The provider can use the data/information that they provided on the registration screen 310 (email and password, for example) as input for the login. Alternatively, they can use various social credentials as illustrated by fields 342 in screen 344 of FIG. 11E. For example, the service system 102 may utilize OAuth or some other authorization standard or program to link one or more social accounts from third party services and the respective credentials to the user account/record associated with the provider. In the illustrated embodiment, both Facebook and Google might be utilized for social logins as seen in FIG. 11E. A screen may then appear when the appropriate fields 342 are engaged. For example, FIG. 11F illustrates a screen 346 presented from Facebook that grants the device 106 and the provider App and service system 102 access to allow authentication, such as through OAuth.

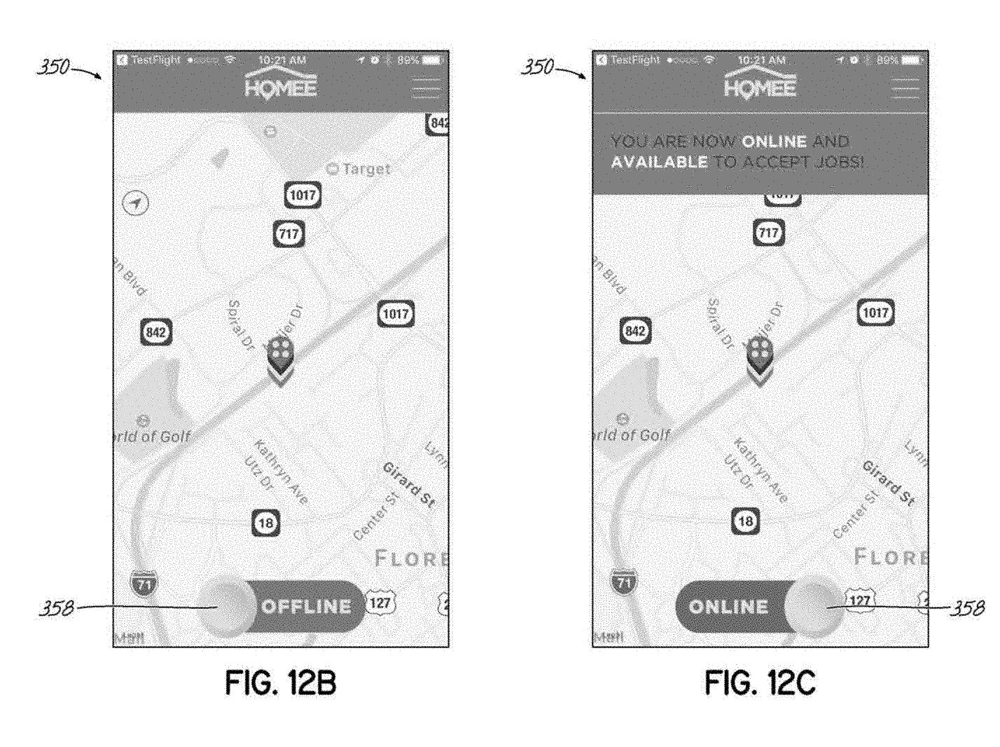

After successful login (a user's session lasts indefinitely unless they logout of the app or a new app version upgrade requires them to re authenticate), the user is presented by the provider App with a Map view on their device, such as screen 350 as illustrated in FIG. 12A. This map view displays the user's current location 352 as well as various pins 354 of the locations where that particular provider completed service job requests or has suspended service job requests or in process jobs. Each of the job pins may be color coded depending on the job status. For example, one color, such as blue, might be used to indicate a completed job for the provider. Alternatively, another color, such as orange, might be used to indicate a suspended job, and green to indicate a job in process. Notifications 356 might also be displayed in appropriate fields as seen in FIG. 12A in order to advise the provider of the issue of keeping the App open to get notification of requests for jobs.

In accordance with one feature of the invention, the user can set their availability to receive job requests. Specifically, a toggle field 358 as shown in FIGS. 12A and 12B gives the provider the opportunity to input and set their availability.

Sliding the toggle off, sets that the provider is in an offline state, and they are not available to receive job requests. As such, when the consumer App is run, they would not appear as an available provider on the consumer App map view screen, screen 226 of FIG. 9A. Furthermore, the provider is kept in an offline state until their background check has cleared and the provider has entered their deposit account information. Then they are able to go online by an appropriate input to the provider App as shown in screen 350 of FIG. 12C. The toggle field 358 might be used by the provider App to output or indicate the status of online or offline for the provider to see.

### Job Order Workflow

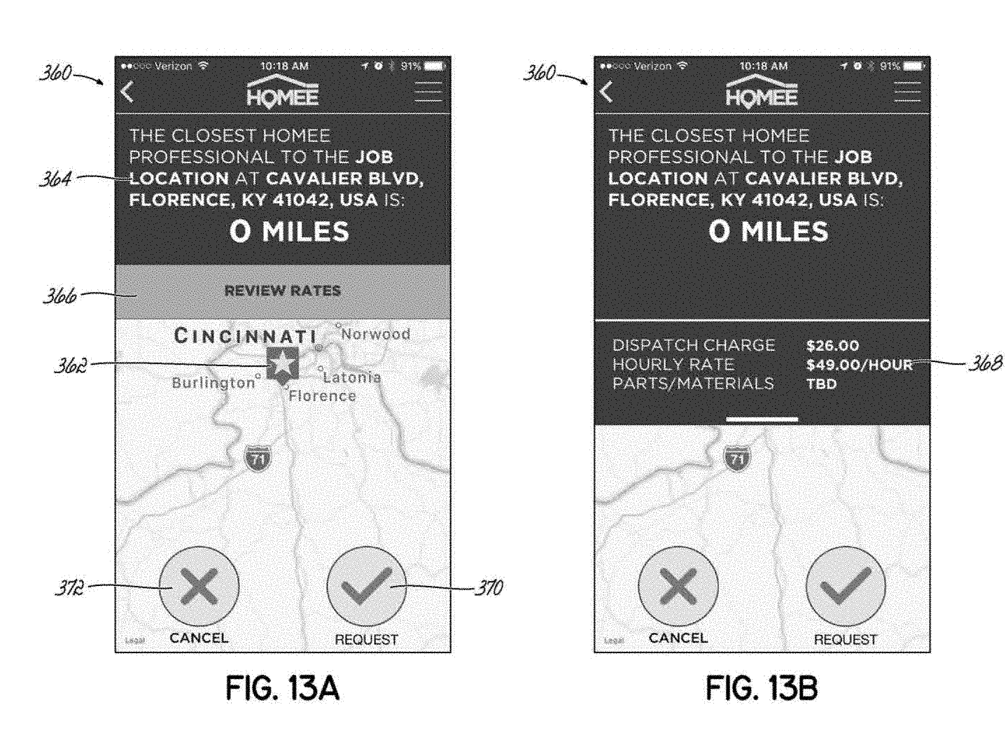

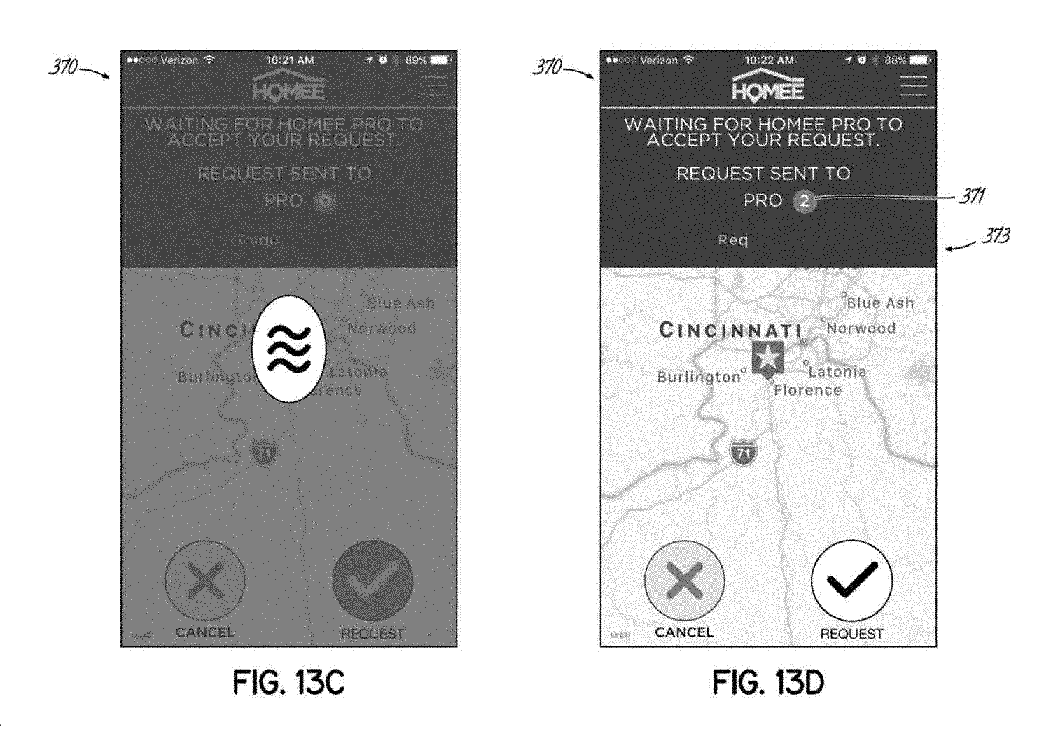

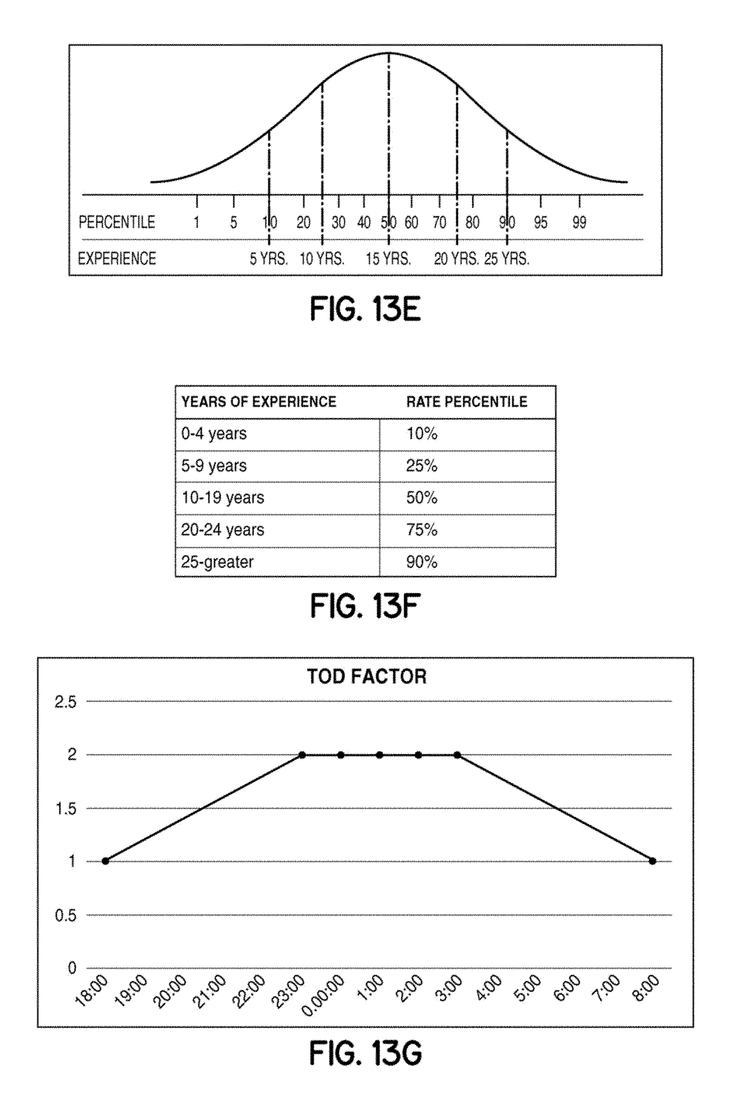

Once the consumer and provider are registered and have suitable records and accounts on the system 102, they are able to select and provide an on-demand service in accordance with the invention. Once a consumer using a device with the consumer App has filtered the map to their requirements as illustrated in FIGS. 9A-9D, they engage the field 232 and specifically the sub-field or menu item that sets forth the desired service type from the drop down Select Service menu 242. In the disclosed embodiment, services such as Electrical, HVAC, Plumbing, or Handyman (or any of the service types the business does or will offer in accordance with the invention) are made available. The device 104 interfaces with the backend service system/server 102 which uses location information for the consumer and from a variety of providers and devices and determines, through available third-party location features and systems 108, the closest provider of the system that matches the consumer filter criteria. As seen in FIG. 13A, the consumer App outputs screen 360 and the icon 362 shows the location along with a display of a dropdown notification 364 of the distance from the provider to the job request location or location of the consumer. The consumer App also presents a Review Rates field 366 that can then be engaged to view a drop down notification 368 that show information regarding the provider, such as a dispatch rate and an hourly rate with magnitudes in the local currency for that particular provider. The consumer App accesses such information through service system 102 and the provider record. Thus, the present invention displays to the consumer the closest available provider as well as provider information such as pricing considerations that may be used by the consumer prior to ordering the service. The consumer can swipe up on the horizontal line icon for the notification 368 to collapse the rate details.

In accordance with one embodiment of the invention, the Rate information for a particular provider is determined using a particular algorithm of the invention. Information related to wage data for certain occupations is used and then modified according to the invention. For example, wage data from the US Department of Labor, Bureau of Labor Statistics may provide wage rate data for a location and for multiple percentiles. These percentiles are then correlated to a provider's years of experience. A normal distribution of wage percentiles is illustrated in FIG. 13E shown with years of service or expertise. In accordance with one embodiment, that information is contained within a look-up table of the system 102 that may be accessed based on job location as determined in the invention. FIG. 13F illustrates an exemplary table with wage rate percentiles associated with years of experience of a provider that may provide the basis for such a look-up table, in accordance with one aspect of the invention. As such, in a table there will be multiple wage rates for a particular location, based upon years of experience for the provider. The interpolated Rate Values are used and are further modified based on provider years of experience.

The rate may be modified by other factors in accordance with the invention. In the disclosed embodiment, a Time factor (which may take into account both time of day and actual day of the week) and a Rating factor are used for modification. As illustrated in FIG. 13G, a graph shows a Time factor (Time of Day−TOD) for an embodiment. During normal business operating hours (e.g., 8 AM-6 PM) the factor might be unity or 1X, but then it is adjusted accordingly as illustrated. The Rating factor, on the other hand, is based on a 1-5 star rating that is given to a provider by the consumer as noted herein for past jobs that have been completed. That information is stored, combined with the other rating factors and averaged for the provider profile record and then used for future rates of future jobs. As such a scale of X/5 with X=star rating, might be used to further modify the rate. So, a lower 1 star rating might create a ⅕ or 20% factor, a 2 star rating might create a ⅖ or 40% factor and so on, up to unity for a 5 star rating (5/5 factor).

For example, the Rate for a job might be determined according to:

RATE=(Rate Factor−Rating)*(Rate Factor−TOD)*(Interpolated Rate Value based on Job Location [Corresponding to the Provider Years of Experience Percentile Look-up] and [Corresponding Service Type]).

Therefore, the rate as used in the invention takes into account various factors to determine a fair and equitable rate based on the job conditions as well as the quality and experience of the provider themselves.

The consumer can then request a job or cancel the transaction. The job progression and job order workflow for both the consumer App and provider App are also described herein through the process flowcharts 400 of FIGS. 5A-5B and various display screens. Referring to FIG. 13B and screen 360, a Request field 370 or a Cancel field 372 are displayed for consumer input and may be engaged for requesting or cancelling a job. If a job is requested, through an interface with the backend service system 102, the system distributes the job request to the localized network in a specific protocol.

In accordance with one embodiment of the invention, the process of creation and management of job requests within the inventive system is handled by service system 102, such as one or more backend server devices. The consumer App will start the process and the service system 102 will then proceed. This removes the requirement for the consumer App to remain open for the duration of the ordering process. The service system 102 provides for various job requests and orders to be queued in the inventive system for approval and scheduling when necessary as noted hereinbelow.

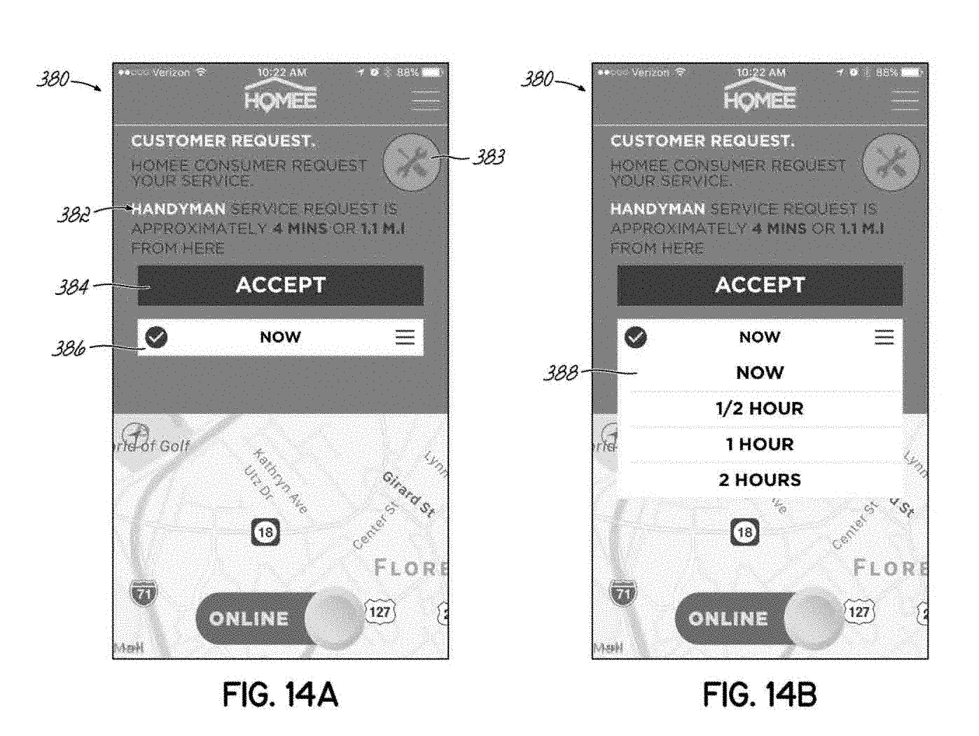

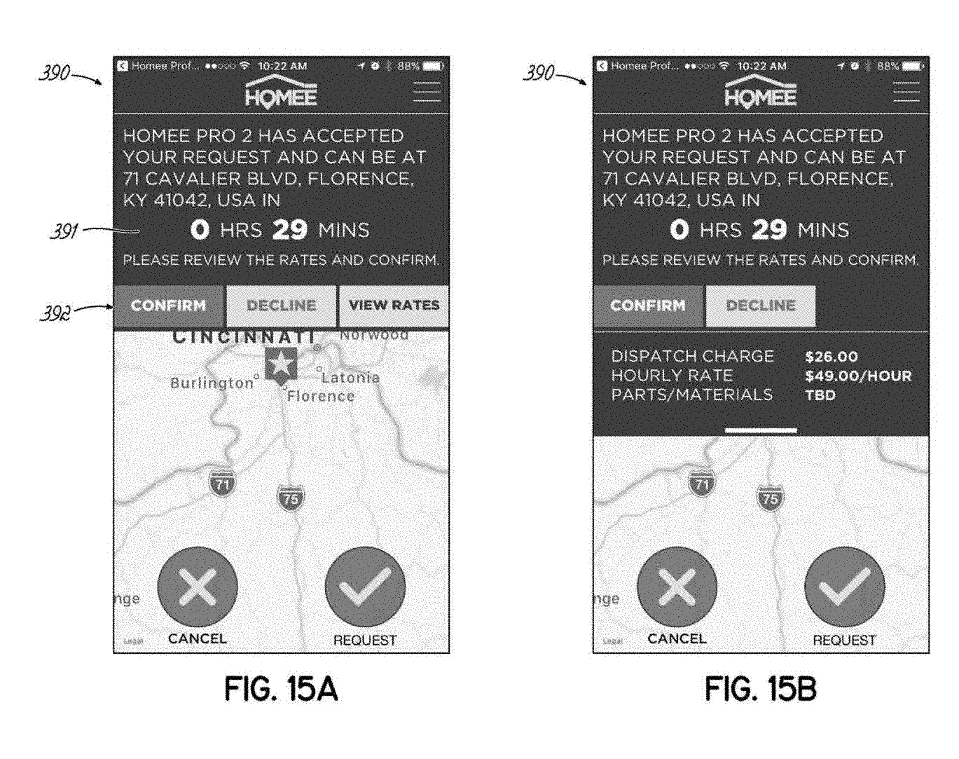

Once the consumer requests a job, the system 102 implements a single consumer request which will then trigger the creation of a set of provider request objects at the appropriate time intervals on the system 102. This does not require further interaction from the consumer App. The consumer App can interface with the system 102 and will be able to poll the existing consumer request to see how many providers have received the requests. The provider App will receive a notification, such as push notification, when a new provider request is received for the provider from the system that can then be accepted or rejected as discussed herein. (see e.g. FIG. 14A). Upon being accepted by a provider, the consumer App will receive a notification, such as a push notification, to confirm the provider's acceptance as discussed herein. (see e.g. FIG. 15A). Upon being confirmed, as discussed herein with respect to FIGS. 5A and 5B the consumer request/provider request pair become a job, and the job workflow, as described herein, would proceed.

For the purposes of processing a consumer request from the consumer App, the service system 102 uses information from the consumer App to schedule provider requests. More specifically, upon receipt of a new consumer request from the consumer App by the backend servers of system 102, the details and information of the consumer request are held in an in-memory work queue of the system 102 and await processing. For example, system 102 might use one or more background programs, such as a worker daemon, for processing the consumer job request. The worker daemons run in parallel across a collection of servers and monitor the work queue for new requests to process. When a new request is discovered by a worker, the request is removed from the queue and processed.

FIG. 5C provides a flowchart of the software flow 900 of the invention with respect to one embodiment in processing a consumer request. In accordance with one feature of the invention, when a consumer request is processed (Block 902), the details of the request from the consumer App are used to identify service providers (Block 904) that match the need of the consumer. Providers are matched based on criteria associated with the provider or a preference of the consumer. For example, the criteria might include, but not be limited to their favorite status, service type, years of experience, trade licensing of the provider and current distance from the job site or location as well as their work status, such as if they are on a job currently or not. The system 102 evaluates provider records and fields therein, and upon identifying all matching service providers, a new provider request is created for each service provider (Block 906). The provider requests are stored in a work queue in system 102 to await processing at the appropriate time. The provider requests, in one embodiment, are schedule for staggered processing based one other criteria. For example, the processing might be based on the service providers distance from the job location and their current working status.

When a provider request is processed, the details of the request are used to send the appropriate notification to various service providers' registered devices to alert them of the request for work. When a particular provider request (resulting from the original consumer request) is answered or accepted, the work flow process proceeds as noted in FIGS. 5A, 5B.

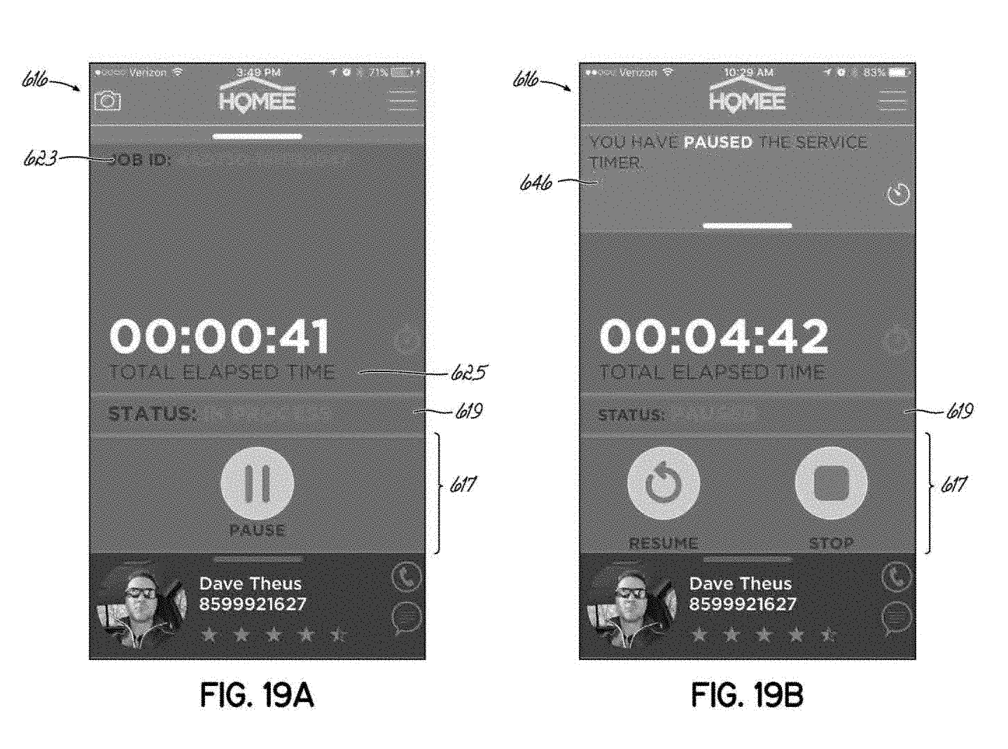

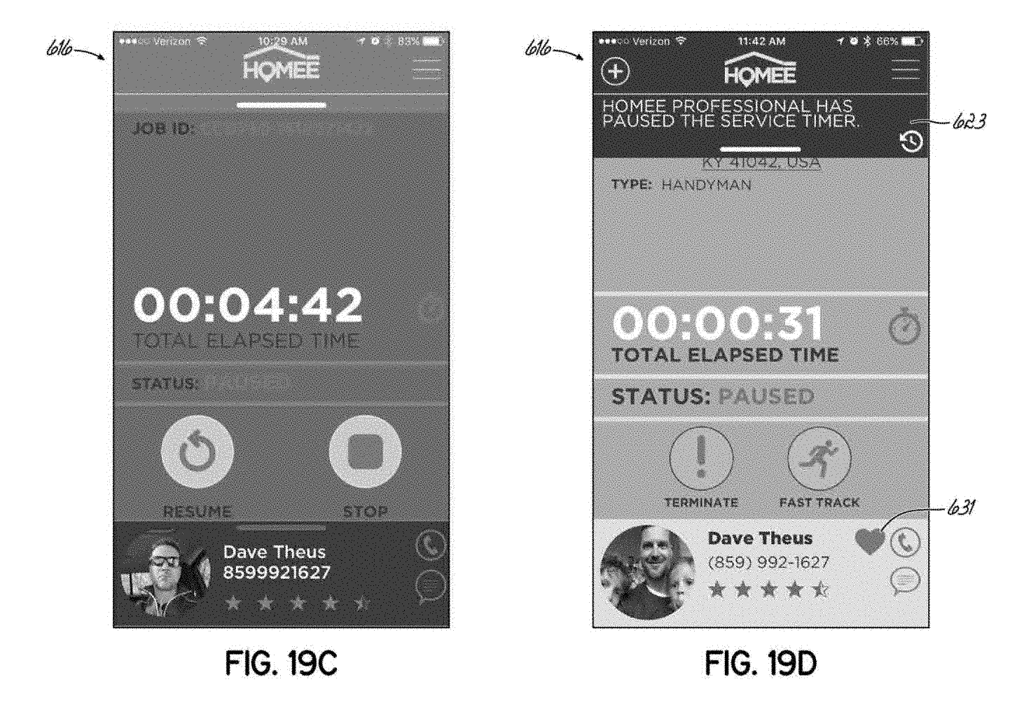

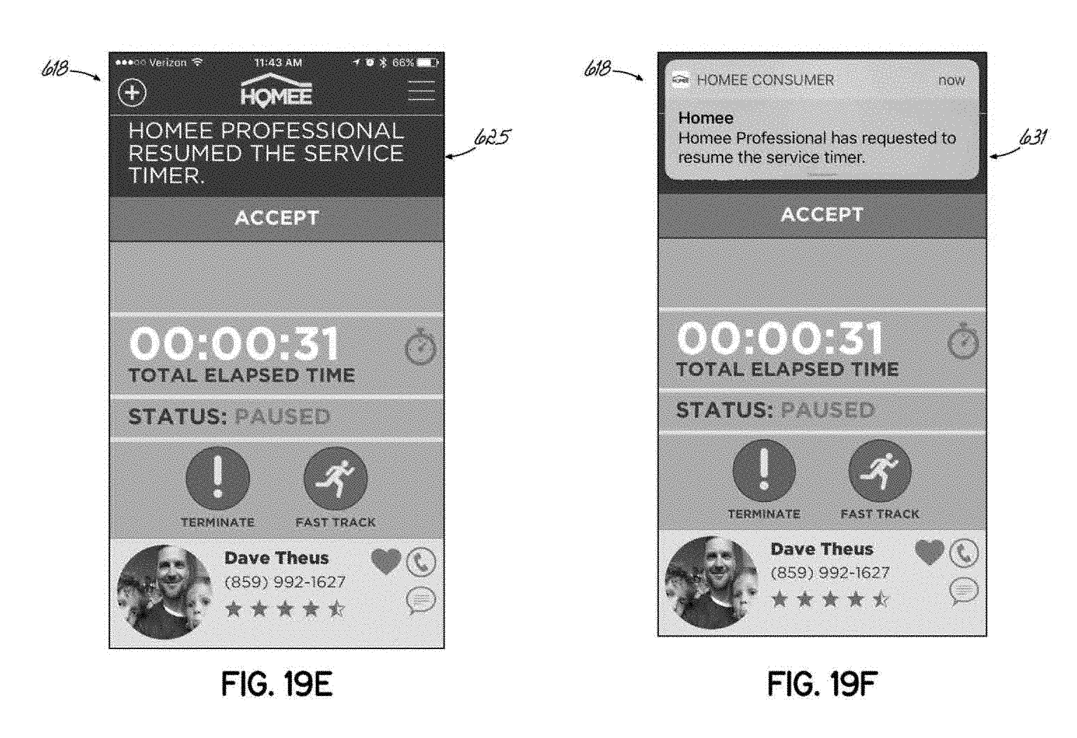

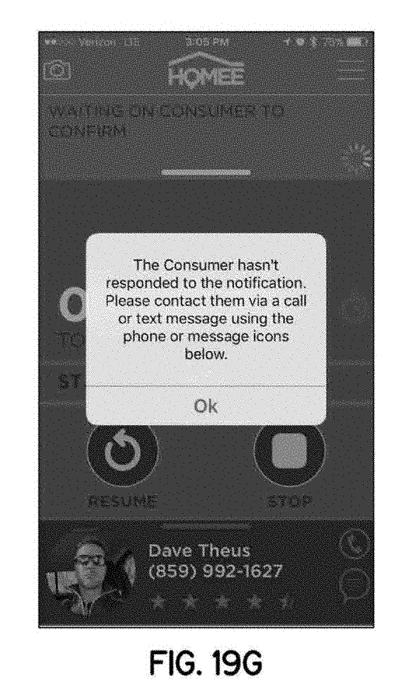

Once a suitable set of providers has been determined, then requests might be sent out in a particular hierarchy as to who gets the provider requests first and then later in the search flow. That is, the requests might be sent out under one set of criteria for a first duration and then under another set of criteria for another duration. This continues under other sets of criteria and other durations until the provider is found and accepts the request. For example, in one embodiment of the invention, the flow might proceed in the following process that might take into account preferred providers (biasing favorites), location of providers (biasing proximity) and availability (biasing those that are not currently on active/in-process jobs). For example, in various screen interfaces where the service provider information is shown, a field can be toggled for designating that provider as a favorite and that status will be noted in the data records for the provider. Referring to FIG. 19D, for example, field 631 might be displayed and engage to toggle on or off for a favorite provider designation. Alternatively, a separate screen (not shown), might be provided in a drop-down menu for designating one or more providers as a favorite. If ultimately a provider cannot be found, the system 102 is also responsible for handling timeouts due to non-acceptance and requesting a local “ghost” account. With the ghost account, a person or employee that is associated with the system 102 and the system of the overall invention can accept the request and work to manually locate a provider to handle the job for a particular consumer.

The current steps and timings of each individual step of one exemplary search protocol might be summarized as follows:

1. Send provider request to all Providers that are not on a job and are within 1 mile radius of a job site (biases pre-arranged jobs). (Block 908). The duration for that request might be for 15 seconds, for example before the next search requests are processed. (from 0-15 seconds). For example, if there is a job that the consumer and provider know is going to happen, the provider might be sent or might show up at the job site. The consumer then submits a request and since the provider request goes to close providers, the provider that is already on site will get the request first and accept so that the arrangement is made before searching beyond that provider. This allows a consumer and provider to address pre-arranged jobs and still work through the system of the present invention. If not accepted under this criteria, per block 909, the flow moves on to the next search processing criteria. If the request is accepted, the flow resumes as a normal job flow as noted in FIGS. 5A and 5B as noted starting at Block 402.

2. Send provider request to all Favorited Providers that are not on a job and are within a 50 mile radius of a job site (biases favorited Pros). (Block 912). The duration for that request might be for another 15 seconds, for example. (from 16-30 seconds). If not accepted under this criteria, per Block 913, the flow moves on to the next search processing criteria.

3. Send provider request to all Providers that are not on a job and are between 1-10 mile radius of a job site (biases closest Pros). (Block 914). The duration for that request might be for another 15 seconds, for example. (from 31-45 seconds). If not accepted under this criteria, per block 915, the flow moves on to the next search processing criteria.

4. Send provider request to all Providers that are not on a job and are between 10-50 mile radius of a job site (open to all network). (Block 916). The duration for that request might be for longer, such as 45 seconds, for example, since the search is expanding. (from 46-90 seconds). If not accepted under this criteria, per block 917, the flow moves on to the next search processing criteria.

5. Send provider request to all Providers that are on a job and are within 50 mile radius of a job site. (Block 918). The duration for that request might be even longer, such as for 3.5 minutes, for example, since the search is getting to an end of the process. (from 1.5-5 minutes). If not accepted under this criteria, per block 919, the flow moves on to the next search processing criteria.

6. If no provider is found, then send a provider request to Ghost Provider in the system. (Block 920). There may be one or more internal providers or provider accounts that a person may set up to address the needs of a particular market and consumers. That may be done over the course of an additional 5 minutes, (internal Homee Provider accounts used to man the market) (from 5-10 minutes).

7. Time-out. If no other options are available, the system would time out and a consumer would have to start over for any new request. The consumer might be notified of the time out and to resubmit a request.

As noted, if the provider request is accepted along the search protocol, the job would proceed as normal as noted herein and in the flow of FIGS. 5A, 5B.

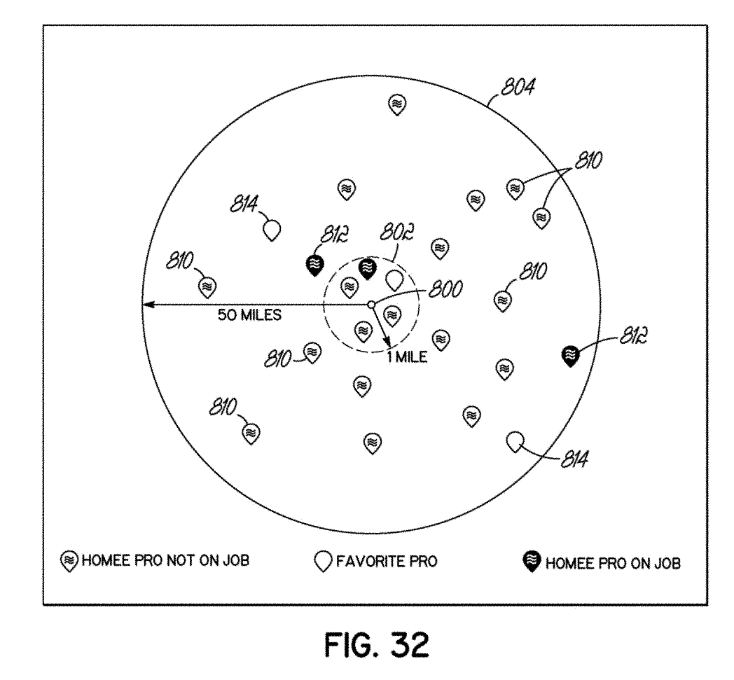

FIG. 32 illustrates logic that might be followed in accordance with the protocol discussed herein. A one mile radius 800, 10 mile radius 802 or 50 mile radius 804 might be used for various steps in broadening out a search. Similarly, various providers, such as those not on a job 810, those providers that are on a job 812, or those providers that the consumer has designated as favorites might be contacted with a request as appropriate in the protocol.

The system 102 will follow a protocol and depending on responses from providers, will handle the process flow. Upon a job request being confirmed, as discussed herein with respect to FIGS. 5A and 5B, the consumer request/provider request pair become a job, and the job workflow, as described herein, would proceed. The system 102 would then cancel any outstanding job requests. Also, the system handles the various timeouts. In that way, the consumer does not have to have their application open and in the foreground of their device. Therefore, there are less chances to stop or orphan a job request that has started but not completed. The system scheduling also allows for consumer/tenant requested jobs that require approval from a property manager and property manager requested jobs that require interaction with the consumer/tenant to determine the best time to schedule the work to be completed, as discussed herein.

In other embodiments, the protocol might select providers using a different process such as the following process:

1. Determine the providers which are in an Online condition and which match the consumer selected criteria described (e.g., trade type, years of experience, license).

2. Send the job request to the closest matching provider.

3. Wait a designated amount of time for a response. For example, in one embodiment, the system will wait 15 seconds, but shorter or longer wait times may be used.

4. If the closest provider does not accept within the designated time (e.g., 15 second) which acts as an exclusivity period, the job request is sent to the next closest matching provider, and another exclusivity period or wait period (e.g., 15 seconds) begins for that new or next provider.

5. If second or next closest does not accept within this next 15 second exclusivity period, the job request is sent to the next closest matching provider with another exclusivity period or wait 15 seconds, and so on.

6. The job request pattern continues, spreading out the requests to all the record providers within a defined location radius, such as a 25 kilometer radius or to the map zoom level displayed on the consumer's device, until the job request is accepted by one of the providers with an open request.

7. Each of the job requests from a consumer that is seeking a match stays open for a period of time (e.g., 5 minutes for each provider) before that particular consumer's request times out.

The invention therefore cycles between all the providers that are available in a defined radius or a map zoom level and then gives an exclusivity period for each before moving on and then gives a set time-out period for each such provider. If all the providers have been addressed and all the time-out periods are expired, the job request is then expired and a consumer would have to begin again.

In accordance with another feature or embodiment of the invention, the consumer may have one or more actual “favorite” providers that they have used or want to use. The consumer App will determine from the consumer account record if one or more certain providers has been designated as a favorite of the consumer. Then the protocol selects the provider using the following process:

1. The consumer App determines the one or more favorite providers and also determines which of those providers are in an Online condition and also which of those match the consumer's selected criteria (e.g., trade type, years of experience, license).

2. If such provider(s) are determined, a job request is sent to the closest matching favorite provider.

3. Wait a designated amount of time for a response. For example, in one embodiment, the system will wait 25 seconds, but shorter or longer wait times may be used. Generally, you will wait longer for a favorite provider to give them additional time to answer the job request.

4. If the closest favorite provider does not accept within the designated time (e.g., 25 second) which acts as an exclusivity period, the job request is sent to the next closest matching favorite provider, and another exclusivity period or wait period (e.g., 25 seconds) begins for that new or next provider.

5. If second or next closest does not accept within this next 25 second exclusivity period, the job request is sent to the next closest matching favorite provider with another exclusivity period or wait 25 seconds, and so on.

6. The job request pattern continues, spreading out the requests to all the record of favorite providers within a defined location radius, such as a 25 kilometer radius or to the map zoom level displayed on the consumer's device, until the job request is accepted by one of the favorite providers with an open request.

7. If no favorite providers are available or do not accept during the exclusivity period, then the system determines the rest of the providers that are in an Online condition and which match the consumer selected criteria. As such, the protocol will continue is the fashion as noted herein for standard providers not given favorite status.

8. Send the job request to the closest matching provider.

9. This job request pattern continues, spreading out the requests to all the record of providers within a defined location radius or to the map zoom level displayed on the consumer's device, until the job request is accepted by one of the favorite or standard providers with an open request.

10. Each of the job requests from a consumer that is seeking a match stays open for a period of time (e.g., 5 minutes for each provider) before that particular consumer's request times out.

Accordingly, the invention is not limited to a particular search protocol and different combinations of factors such as distances and provider parameters might be used.

The screen 370 presented to the consumer updates as shown in FIGS. 13C-13D as the request is sent out to provider 1 through N to indicate to the consumer that the request is processing. The consumer App provides a count 371 for the various providers that are getting the request. There is also an animated text notification “requesting” 373 that showcases the process is proceeding as shown in FIG. 13D. Referring to the process flow as illustrated in FIGS. 5A-5B, the process 400 begins with consumer service requested or job request Block 402. The service request might also be cancelled Block 406. As described above, after the request goes out to the network, the provider receiving the request is presented with the screen 380 of FIG. 14A by the provider App. The notification of field 382 displayed on screen 380 displays to the provider the various details the type of request that has been sent (Service Type: plumbing, electrical, hvac, Handyman, e.g.) by a suitable notification. Also, an icon 383 in the top right-hand side of the field area shows the service type. The notification text also displays the distance to the job location.

The provider can then determine whether they want to accept the particular service request as shown on screen 380. Input fields are presented, such as field 384 for Accept of the job. In accordance with one feature of the invention, the provider can accept the request and immediately begin their travel to the location, or the provider can set a duration or schedule whereby they are able to start traveling to the job site. To accept, the provider engages field 384 and can accept the job immediately (ie., Now) or further engage a drop down menu 386 for selecting some other schedule for the job. The drop down menu provides for various selectable time intervals 388 for the availability scheduling. For example, in the illustrated embodiment, the menu allows for intervals 388 of ½ hour, 1 hour, and 2 hour for availability scheduling as shown in FIG. 14B. The information in field 382 also uses the GPS functionality of the devices 104, 106 and the mapping functionality accessed through system 102 to provide an estimated travel time for the provider to the job. The selected scheduling information 388 will then be added to the estimated travel time from the provider location to the consumer job location. The information is captured by the provider App based on the inputs from the provider and is reported back to the consumer App through service system 102. The consumer is presented a screen 390 with a notification field 319 as illustrated in FIG. 15A. At that stage, the consumer has the opportunity to Confirm or Decline the provider's acceptance of the job through engagement with input field 392 or to view the rates again. The view rate button field gives the consumer the ability to again check rates to determine the exact dispatch and hourly rates for the provider that has accepted. The rates are displayed as illustrated in FIG. 15B.

Referring to FIG. 5A, if the provider does not accept the job or rather declines or rejects the request as shown in Block 404, the job is considered rejected by the provider (Block 408). If the provider accepts the job, a determination is made (Block 410) of whether the provider accepted the job immediately or “Now” or set a schedule for the acceptance. If no schedule was set, flow proceeds to block 418 and the provider has accepted service. However, if the provider accepted service and also set a schedule (Block 412), the flow proceeds to Block 414 and the invention gives the consumer the chance to accept/Confirm the proposed provider and noted schedule as shown in FIG. 15A, or Decline the schedule through the input fields 392. If the provider and noted schedule are accepted, the process flows to Block 420 to indicate acceptance by the consumer. However, if the provider and proposed schedule are not accepted (Decline) the flow proceeds to Block 416 where the provider and proposed schedule are rejected by the consumer. As such, the service job is essentially considered cancelled by the consumer (Block 406). If the service request acceptance by the provider (Block 414) is not accepted (Decline), in one embodiment of the invention, the consumer's screen goes back to the initial map view (See FIG. 9A) where they can reorder service and in another embodiment of the invention the next queued accepted provider request is presented to the consumer for acceptance until zero are left and then the consumer's screen goes back to the initial map view. The provider App provides a notification to the provider that the Consumer declined the request and the provider goes back into an available state to take the next request.

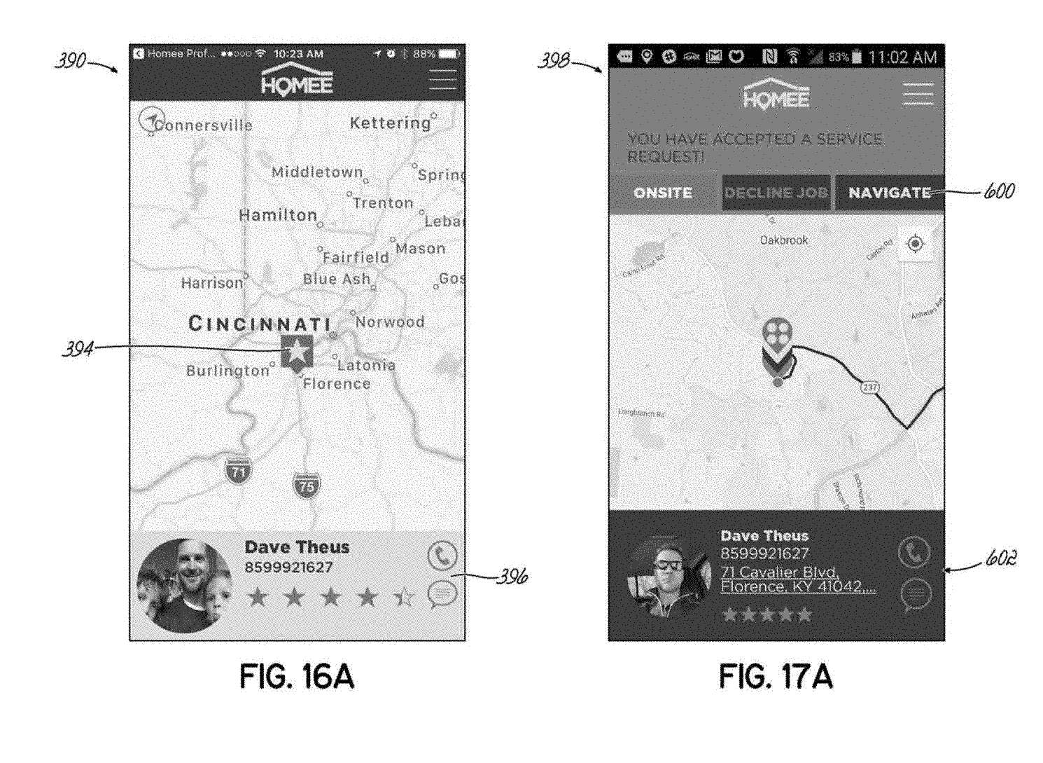

If the process flows to Block 420, indicating acceptance by the consumer, a map view is shown in the consumer App as in screen 390 of FIG. 16A with the provider's pin 394 shown at the provider's location. This provider pin moves as the provider is in transit to the job location. With acceptance by the provider Block 418 and/or acceptance of the provider schedule by the consumer, the process flows to Block 422 and navigation of the provider to the job site begins. The status of the provider will either be on-site (Block 426) or enroute (Block 424). Referring to FIG. 16A, a field 396 provides information for the provider, such as first name, last name, cumulative star rating average, an avatar/image as well as information to contact the provider such as a button to call the provider and one to text/sms them. The record for the provider as accessed through system 102 provides the provider information for display. The field 396 will generally remain on the screen at all times during the job that is in progress. As with various screens for both the consumer and provider Apps, information from the various records might be displayed for the users.

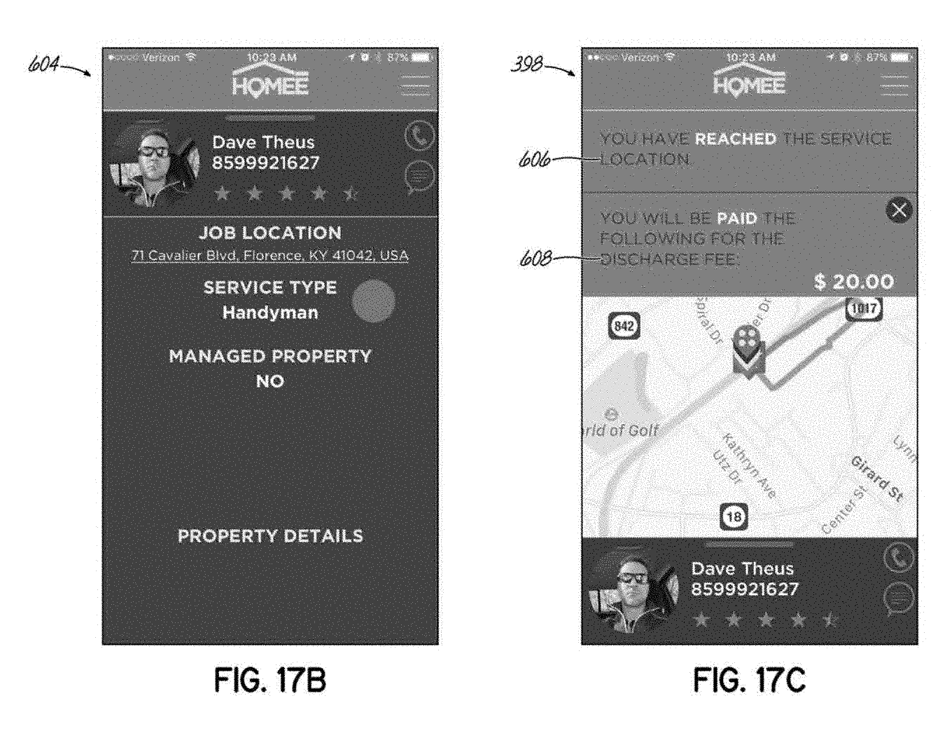

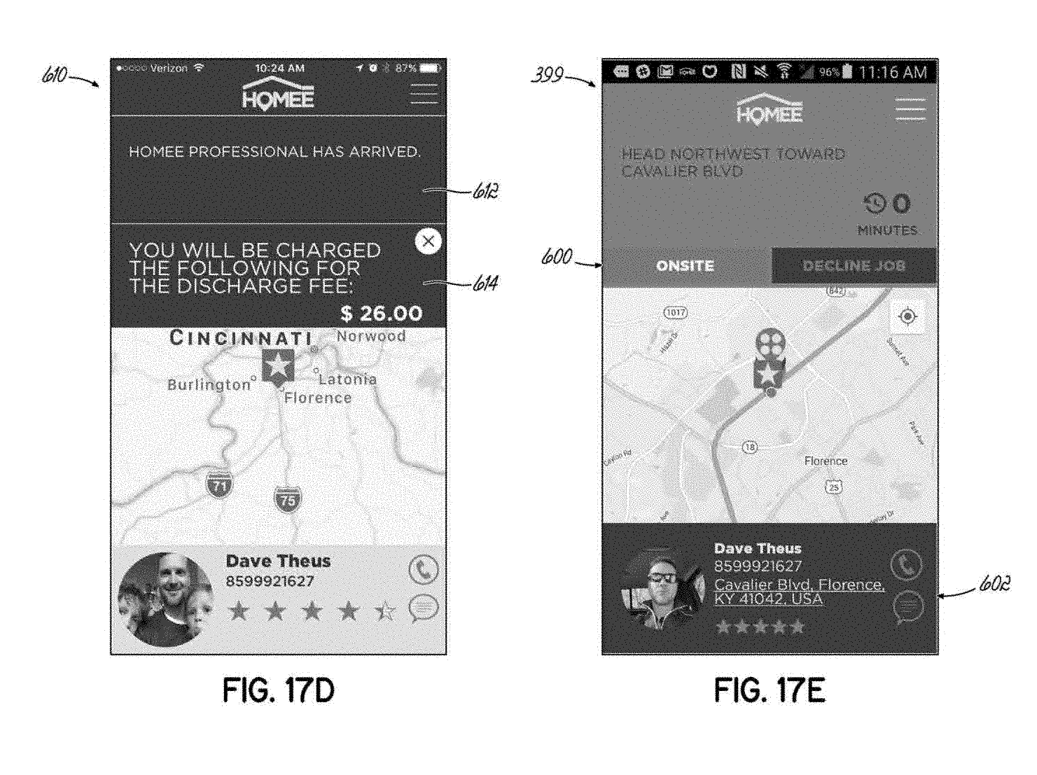

Once the provider has accepted the service and the consumer has confirmed, the provider's screen 398 changes to a map view as seen in FIG. 17A with notification that the provider has accepted a job or service request and presentation of selectable fields 600 whereby the provider has the option to navigate to the job location using the location feature of the invention. They also have the ability through fields 600 to indicate that they are onsite if the navigation and location programs used by the invention do not get them all the way to the site or there is some other barrier to the location services in accordance with the invention. Referring to FIG. 17E, if the provider desires the system 102 to navigate them to the job site, they will see a screen 399 as shown and given turn-by-turn instructions to the job site. The provider can also Decline the job (if there is something that comes up during the time the provider has accepted to the time they arrive onsite: accident, emergency, others). Referring to the flow of FIG. 5A, the provider is either enroute Block 424 or onsite at the job location Block 426. Or, as discussed herein, if the GPS functionality of the provider device 106 does not automatically set them to an onsite status when they have arrived, they can set their status as Onsite per the selection in the input field 600. Referring to FIG. 17A, a bottom screen field 602 provides information for the consumer, such as first name, last name, cumulative star rating average, an avatar/image and a button to call the provider and one to text/sms them. The record for the provider as accessed through system 102 provides the provider information for display. The field 602 will generally remain on the screen at all times during the job that is in progress. Also available on the bottom field are more details on the job location. The provider can slide up the bottom field, such as with the horizontal line icon. With this area expanded, further details are shown to the provider regarding that property as shown in FIG. 17B and screen 604 such as:

Full address of the job location

Label and icon denoting Service Type

Whether this is a Managed Property (yes, no)

If this is a managed property, details about the not to exceed notification limits for labor, materials and totals will also be displayed

Further notes regarding the Property are also displayed following the Property Details heading, such as notes about the type of property, single family, multi family, apartment, etc., age of the building, specifics on various mechanicals, etc. This screen 604 can then be collapsed by swiping down on the horizontal line icon or through some other screen interaction.

Once a provider is Onsite as noted in Block 426 (either because the GPS equates the job location to the provider position or the provider tapped the Onsite button of field 600), the program flow can take several paths. With respect to the provider device, the screen 398 shows a notification 606 notifying the provider that they have reached the job location. The provider's deposit account (account method on record) is credited with a dispatch fee, and a notification 608 is shown in the provider App screen as shown in FIG. 17C.

The consumer App and device screen 610 shows a notification 612 notifying them that the provider has arrived onsite to the job and also a message 614 that the consumer's credit card (payment method on record) will be charged for the dispatch fee as shown in FIG. 17D.

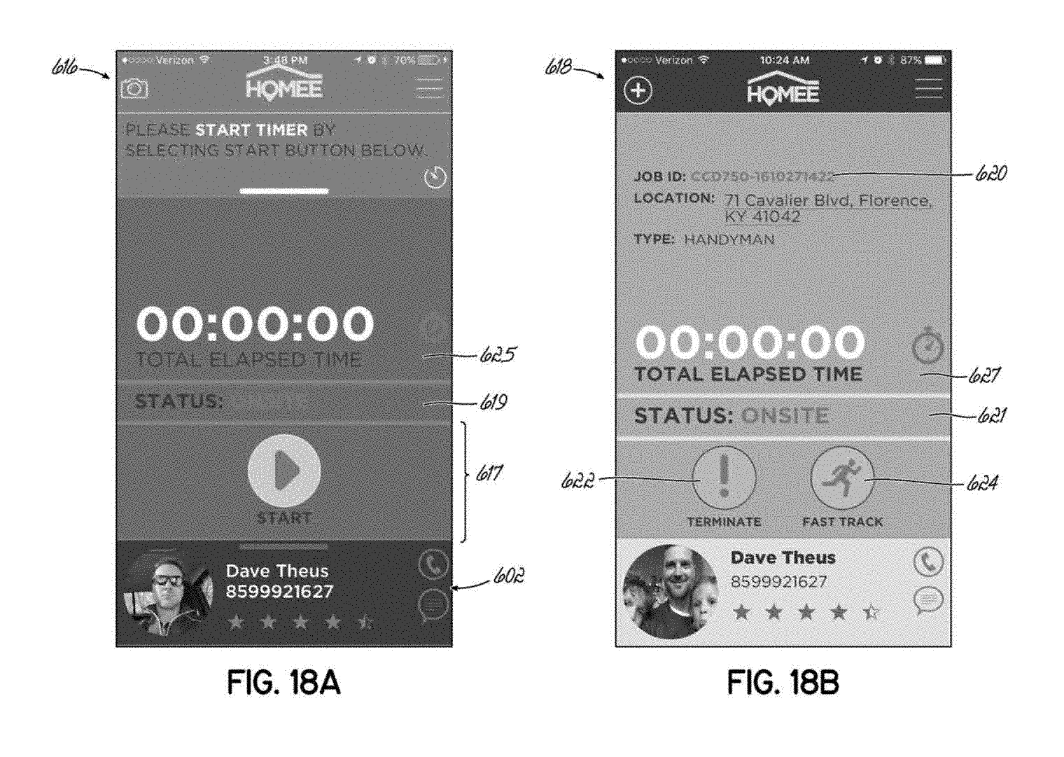

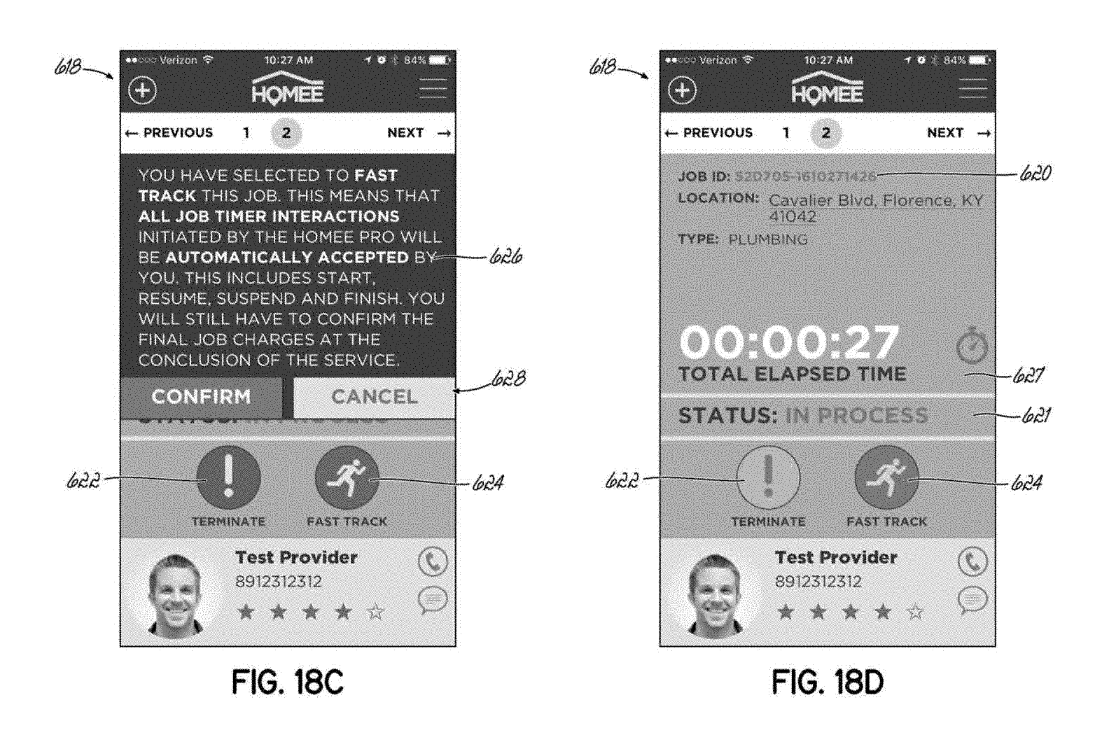

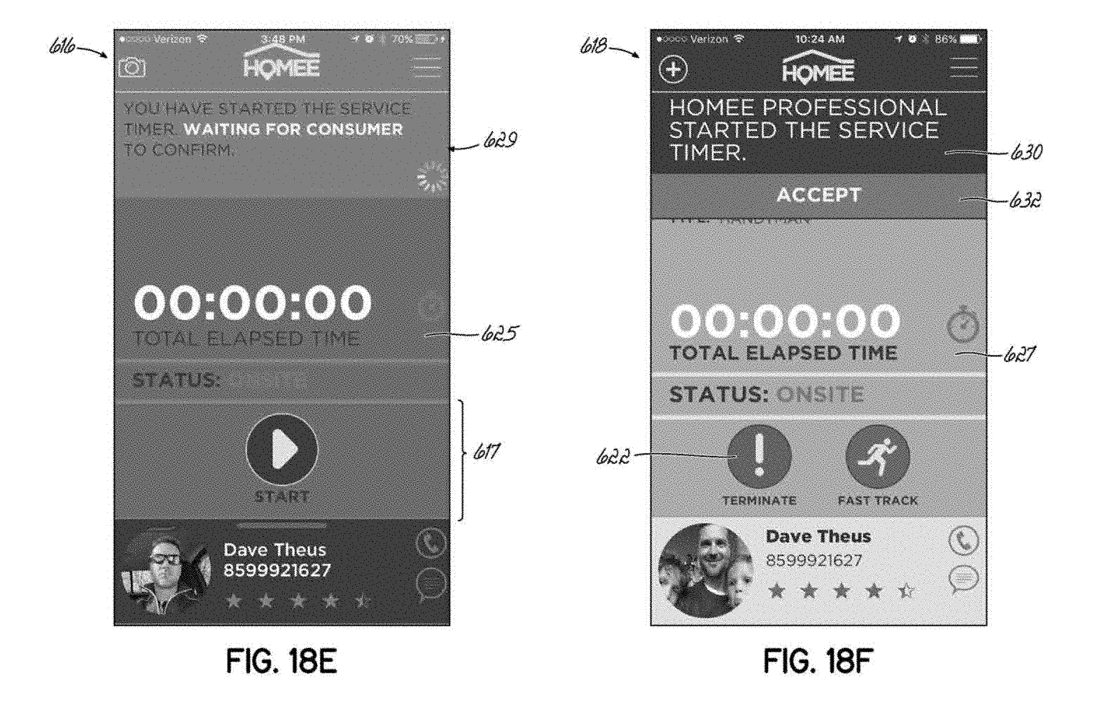

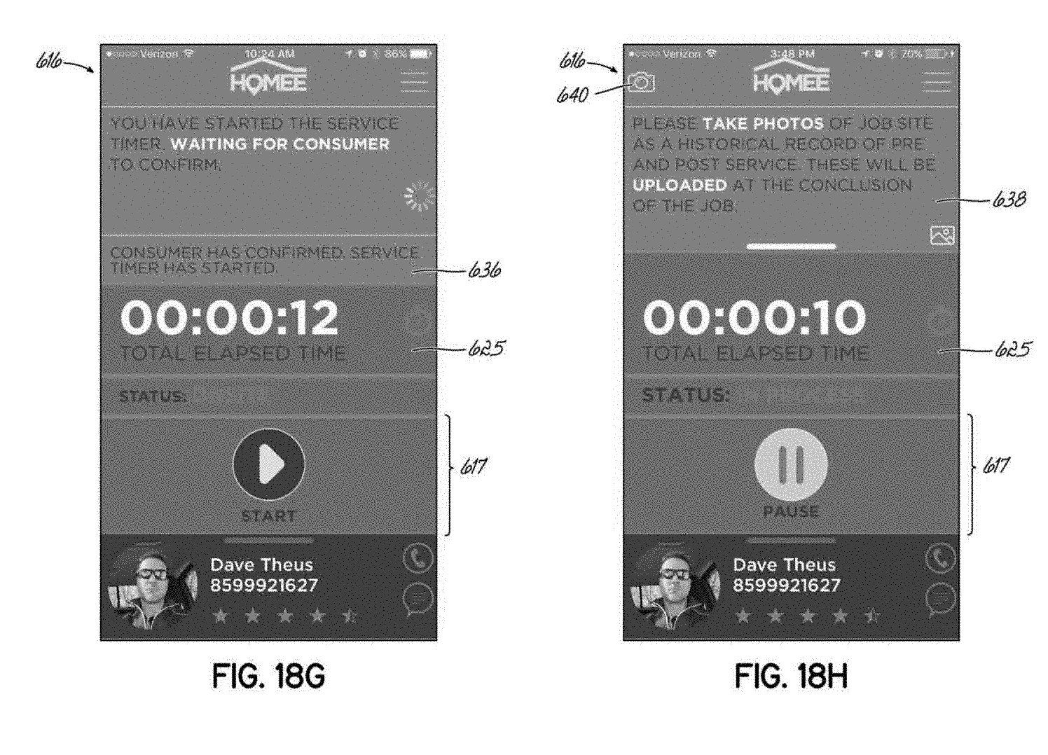

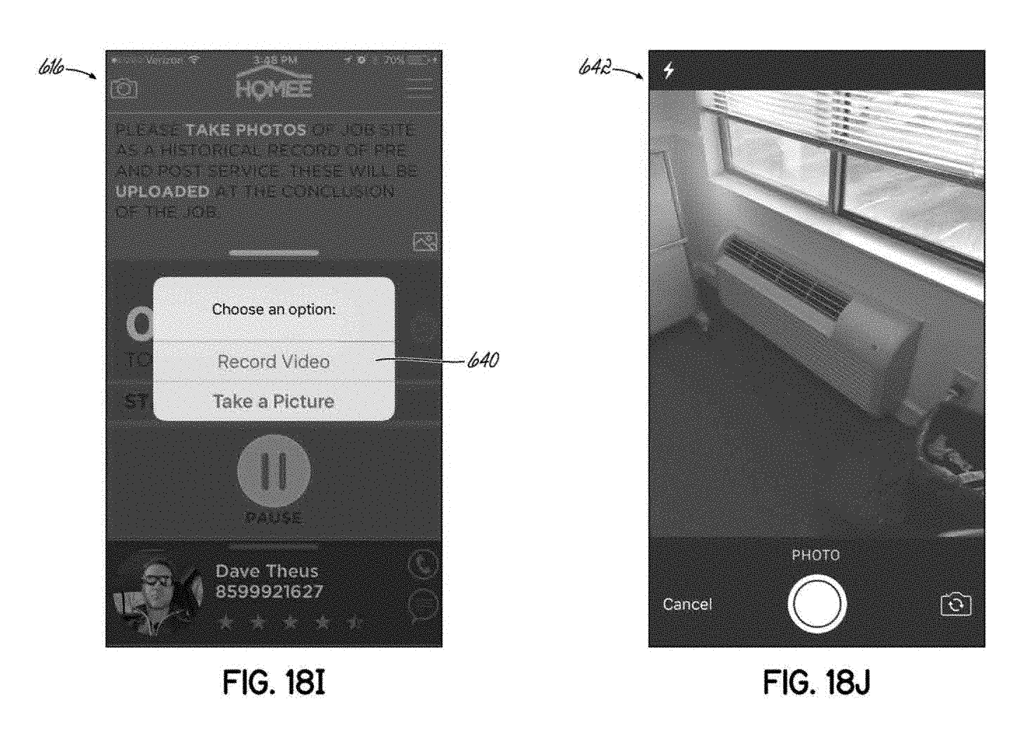

Both of the consumer and provider Apps 170, 180 then will automatically switch their output screens to respective timer screens when the provider is on site and the various accounts have been charged or credited respectively. FIGS. 18A and 18B illustrate respective provider screen 616 and consumer screen 618 showing timers. As part of the job creation and link between the consumer and provider, the service system 102 will create and assign a unique descriptor for the job, referred to herein as Job ID 620, as shown in FIG. 18B which is displayed for the consumer. The Job ID 620 is a combination of letters and numbers (e.g., 16 characters long) that links the job to the consumer that ordered it and to the provider that accepted it and to payment reconcilliation in the system 100 of the invention.

Referring to FIG. 18A, the provider screen 616 provides the following information:

JOB ID:—Unique string which ties together the consumer with the provider, the status changes as the job proceeds through the workflow and ties the final job details to the JOB ID (notes, materials list, pre and post images/videos and various particulars)

Time (hours: minutes: seconds)—Total Elapsed Time (field 625)

STATUS: (pertains to workflow and status as shown in the workflow diagram of FIGS. 5A-5B). For example, the status could be ONSITE, ENROUTE, PAUSED, STOPPED. (Field 619)

Buttons to control timer (start, pause, resume, stop, finish). (Field 617)

Bottom consumer information bar. Field 602

Referring to FIG. 18B, the consumer screen 618 provides the following information:

JOB ID: Unique string which ties together the consumer with the provider, the status changes as the job proceeds through the workflow and ties the final job details to the id (notes, materials list, pre and post images/videos and various cost particulars) (Field 620)

Location: Full address of job location. This is important information if there are jobs at multiple locations for a particular consumer.

Service Type: This is also important for jobs at multiple locations for a particular consumer.

Time (hours: minutes: seconds)—Total Elapsed Time (field 627)

STATUS (pertains to workflow and status shown in the workflow diagram of FIGS. 5A-5B) For example, the status could be ONSITE, ENROUTE, PAUSED, STOPPED. (Field 621)

TERMINATE: used to abort the job immediately—Pauses the timer and notifies provider of consumer's intent to stop the job. This can be used for emergency situations, such as when a consumer might not be satisfied that provider is successfully able to complete job, or for other reasons etc.) (Field 622)

FAST TRACK: this field might be engaged so that the service system 102 backend would automate the acceptance of various timer interactions (pause to resume, pause to stop, stop to suspend, stop to finish) between the consumer and provider. This is to streamline the interaction between provider and consumer as one feature of the invention. (Field 624)

Bottom Provider information bar

Generally, as discussed herein, various timer status changes whereby the timer restarts, or the job completes or is put into a suspended state, etc, will usually require that the consumer accept or confirm the change in timer status and manually indicate the acceptance of this change with interaction with the screen 618. However, if there is a certain trust with the provider, for example, and the consumer does not need or want to have to constantly manually accept and engage with each interaction, they can enter the Fast Track mode. Engaging the Fast Track field 624 sets a flag in the program flow whereby status changes are automatically accepted.

Once the Fast Track field 624 is engaged, as seen in FIG. 18C, a notification 626 is displayed in the consumer device screen 618 and the user is given the chance to Confirm or Cancel in field 628. If confirmed, the Fast Track field 624 may be changed in color for example to illustrate that it is ON. (See FIG. 18D).

Referring again to FIG. 18A, the provider can request that the timer be started for the job by engaging the Start button of field 617 and the consumer will then receive a notification 630 that the provider wants to start the job timer (FIG. 18F). At this juncture, the consumer must respond. Referring to FIG. 18F, the consumer must respond on his device through engagement or input through field 632. That is, the consumer accepts the initial time start of the timer that has been requested per the provider starting the timer. If Fast Track has been selected, as noted herein as an option, the Fast Track process only begins after the timer, 625, 627 has been initially accepted and thereafter started. Referring to FIG. 18E, once the provider starts a timer, the provider App also provides a notification 629 as shown that the timer is started and the provider is waiting for the consumer to confirm or accept the timer start.

Referring again to the flow chart of FIGS. 5A and 5B, when the provider starts a timer, as noted in Block 430 as a provider timer requested, the customer must Accept as reflected in decision Block 434. The consumer is reminded periodically as illustrated in FIG. 18F, for a period of time, for example 60 seconds. If the consumer does not accept, the job may time out with the process flow through Block 432 as shown in FIG. 5A. The provider is then presented with the screen of FIG. 18A again and can try to restart the timer or might call or contact that consumer. If the timer start is accepted, the provider is notified with an appropriate notification 636 (FIG. 18G) of the confirmation of the timer and the timer begins to track the time. Flow proceeds as noted in Block 436 of FIG. 5B.

In accordance with one feature of the invention, photos of the job are used in the interaction of the job. For example, at some time in the process, such as for example, 10 seconds into the job timer, a notification 638 is provided in the provider device screen 616 (FIG. 18H) reminding the provider that they will need to capture job information such as to take pre-job pictures for the job and also submit them at the end of the job with post-job pictures. This is a required step for the e-inspection compliance that service system of the invention requires. For example, a camera icon 640 may be provided in the device interface in the header of the timer screen as seen in FIG. 18G. the icon field can be engaged to access the device's camera functionality, such as still or video camera(s) in the provider device 106. A notification 640 is presented to the provider for them to select, through a suitable engagement with a selection field, whether they want to record a video or still camera. In accordance with one feature, the provider App 180 or service system 102 may limit the video upload to 1 Mb of data and present a notification to the provider if they try to upload a larger file. FIG. 18J illustrates a photo screen display 642 as is typical in mobile devices having camera functionality and provider can take the necessary photos. Once a suitable photo is acquired and the provider confirms their process, such as whether they want to use that picture or retake another picture, the timer screen is displayed. During this picture taking or video taking step, the timer continues to run.

In accordance with another feature of the invention, the provider can pause the timer for the job. As shown in FIG. 19A, the timer progresses for the listed Job ID 623 and the provider can engage the field 617 that displays a Pause icon after the timer is started. If the job is paused by the provider, notification 646 is provided, and the timer is stopped as illustrated in FIG. 19B. As with various notifications, the notification field 646 on the screen can be collapsed to again see information on the screen such as the Job ID 623. (FIG. 19C) The status field 619 will indicate a Paused status and field 617 to be engaged by the provider shows Resume and Stop icons for either resuming the currently paused job or stopping the job as seen in FIG. 19B. The consumer device screen 618 also shows the paused status and may provide a notification 623 regarding the Pause status as shown in FIG. 19D.

If the provider makes a decision to resume the paused job and timer, they cannot just resume, unless the job has Fast Track status granted by the consumer. In accordance with one feature of the invention, the consumer must accept that resumption of the timer. As shown in FIG. 5B, Block 442 indicates a decision to be made by the provider for resuming the job and timer. If the Resume icon is selected in FIG. 19B, a resume request is made to the consumer through a notification 629 as shown in FIG. 19E on the consumer screen and the consumer must accept the resume request as noted in the decision block 452. Alternatively, if a provider wants to resume the job, other notifications, such as notification 631 on screen 618 might be used. If the consumer accepts the resume request, flow returns to block 436 and the timer resumes. Generally, system 102 will keep the master timer setting that can be accessed by the consumer and provider devices and Apps. If the consumer does not accept within a time out period (e.g., 2×60 second periods), process flow proceeds to block 440 and block 444 wherein the job is considered Paused and awaits further disposition. The provider gets a message on the screen to call the consumer as shown in FIG. 19F. The provider screen then appears again as in FIG. 19B.

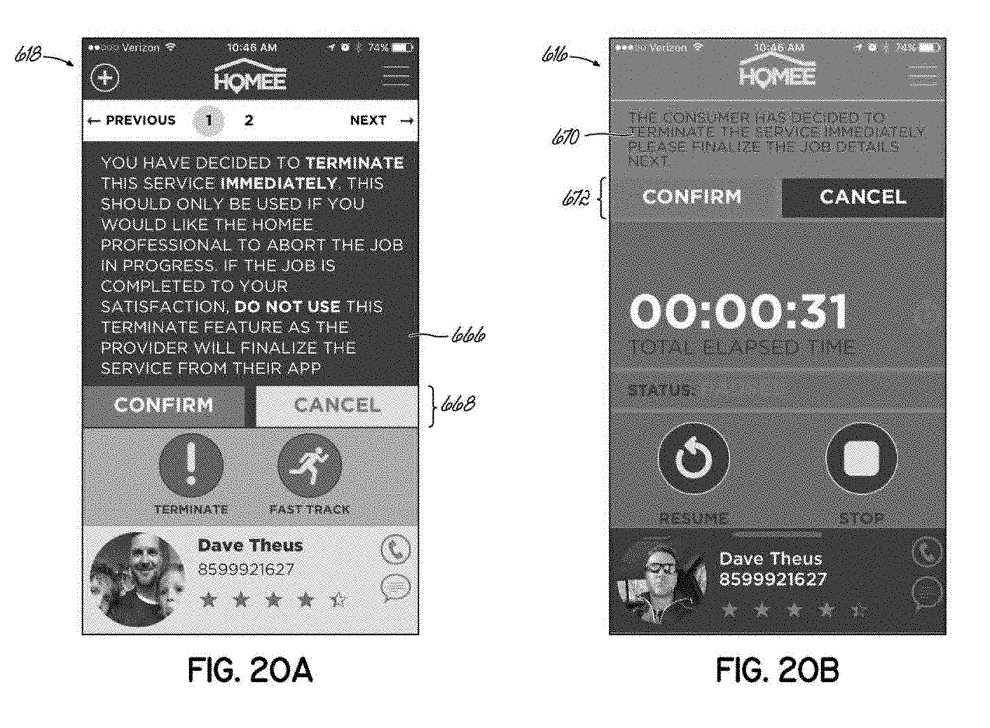

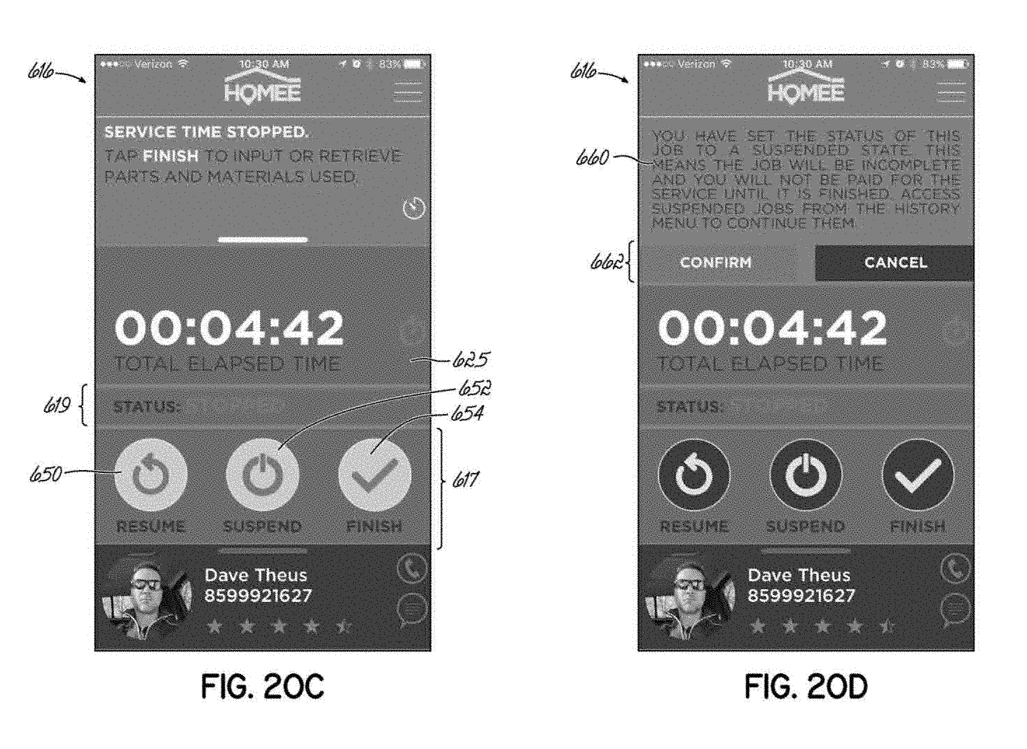

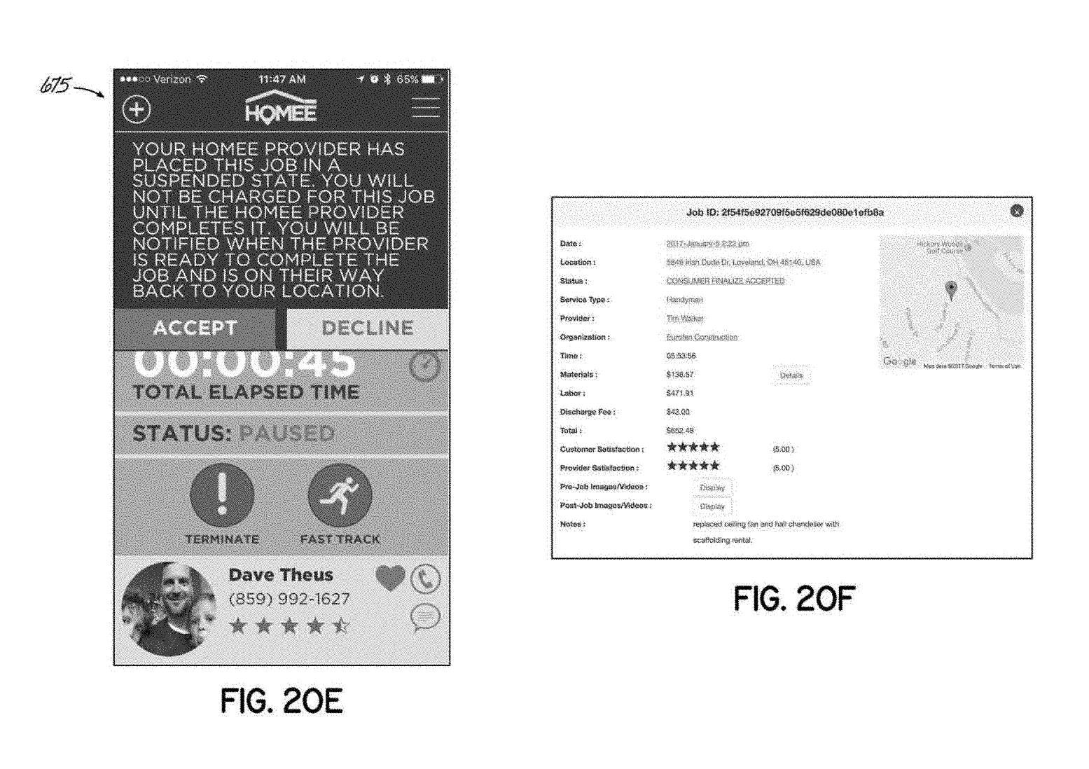

If instead of resuming the job, the provider selects the Stop icon, they are presented with screen 616 as illustrated in FIG. 20C and given a number of different icons to choose in field 617, including a Resume icon 650, a Suspend icon 652, and a Finish icon 654. That is, the stopped job must be disposed of in some suitable way. The provider can thus resume with the job, or more permanently suspend the job, or they can indicate that the job is finished. When the Stop icon is engaged, the field 619 indicates a stopped job. Referring to FIG. 5B, at the stop decision block 446, if the Resume icon is engaged, the flow returns to block 442 for resuming the job and getting the consumer to accept it (unless on Fast Track status).

If the provider selects the Suspend icon, the job will be considered suspended and kept in the paused state. The Screen of FIG. 20D is presented to the provider with a notification 660 noting to the provider one or more consequences of the suspended state and that such jobs that are suspended may be accessed from a History menu and otherwise disposed. Field 662 provides the options of confirming that the job is to be suspended or cancelling the suspension. If the provider selects to cancel the suspended state, the process flow returns the job to a stopped state and to a user interface screen of FIG. 20C wherein the job is still stopped and the provider has the options again of how they might wish to dispose of the job. However, if the provider confirms the suspended state (FIG. 20D), then in accordance with another feature of the present invention, unless the decision making has been fast tracked, the consumer must agree to the suspension of the job.

Referring to FIG. 5B, in the process flow of the decision in Block 446 to stop the job and then to select to suspend the stopped job, the process flow proceeds to another decision Block 458 for suspending a job. Upon the provider confirming the suspended state, the provider's suspension is requested (Block 468) and a consumer gets a notification 675 that the provider has placed the job in a suspended state as shown in FIG. 20E. The consumer has to then accept or decline that suspension as indicated in Block 466. If the consumer does not accept the suspension but rather declines it, flow proceeds to Block 456 and the job is considered paused as noted in Block 444. The provider then is presented with the screen of FIG. 19B and the consumer is presented with the screen of FIG. 19D If the consumer accepts the proposed provider suspension of the job, the flow proceeds to Block 476 and the job is considered suspended and then selectable in a history of jobs as discussed herein, such as for further resumption of the job. At that, both the consumer and provider device screens return to the initial landing screens such as FIGS. 9A and 12A and workflow and job requests can start all over again.

Referring again to FIG. 18B, in addition to the ability for the consumer to fast track the process and reduce various of the checks along the job flow that require the consumer to specifically accept, the consumer also has the ability through a Terminate icon 622 to terminate a job, such as prematurely for what usually will be extenuating circumstances. Usually the job will be completed and finalized or finished by the provider. If the terminate icon 622 is engaged however in screen 18B, the consumer is provided a notification 666 that describes the purpose of the termination process and other information about how termination is outside of the normal job process flow, and the provider is provided a termination notification as illustrated in FIGS. 20A and 20B. The consumer, thus advised, can then engage field 668 and confirm or cancel the termination process.

Referring to FIG. 20B, in the screen 616 of the provider, a notification 670 is provided by the provider App and the provider can confirm or cancel the termination process from their end. Referring to flowchart 5B, the termination might be requested by the consumer as noted in Block 438. The consumer is notified what the termination means (FIG. 20A) and can confirm that they want to terminate or cancel the termination. If the termination is cancelled, the previous screen would appear for the consumer. If termination is confirmed, then the provider is engaged through screen 20B. Then through decision block 450, the provider may accept (confirm) the termination which indicates the job is completed as shown in Block 474. Then the system proceeds through the job completion process as noted herein. Or the provider can reject (cancel) the termination as noted in Block 448. If the provider rejects the termination, the provider and consumer screen return to the previous screen, which may be a timer screen for the job.

The job can be put into a completed state in a number of ways wherein the materials information and other information is gathered for a final billing and completion process so the provider can be paid. Referring again to FIG. 5B and the process flow, if a consumer requests termination and that is accepted as noted in Block 474, process flows to Block 496 for the purposes of determining if the information regarding all the materials used for the job have been input by the provider and the job can flow as discussed herein to confirmation by the consumer.

Alternatively, referring to FIG. 20C, if the job has been stopped as in Block 446 of FIG. 5B, the provider can decide to select the Finish icon 654 on the screen and thus finish the job. Referring to the process flow of FIG. 5B, in response to the decision through Block 446 that the job is to be finished or completed rather than resumed or suspended, program process flows to Block 474 wherein the provider has selected that the job is to be finished. The system engages the provider for job details and the provider will provide additional job details, that are required or are optional, for the purposes of completing the job for final approval and acceptance by the consumer.

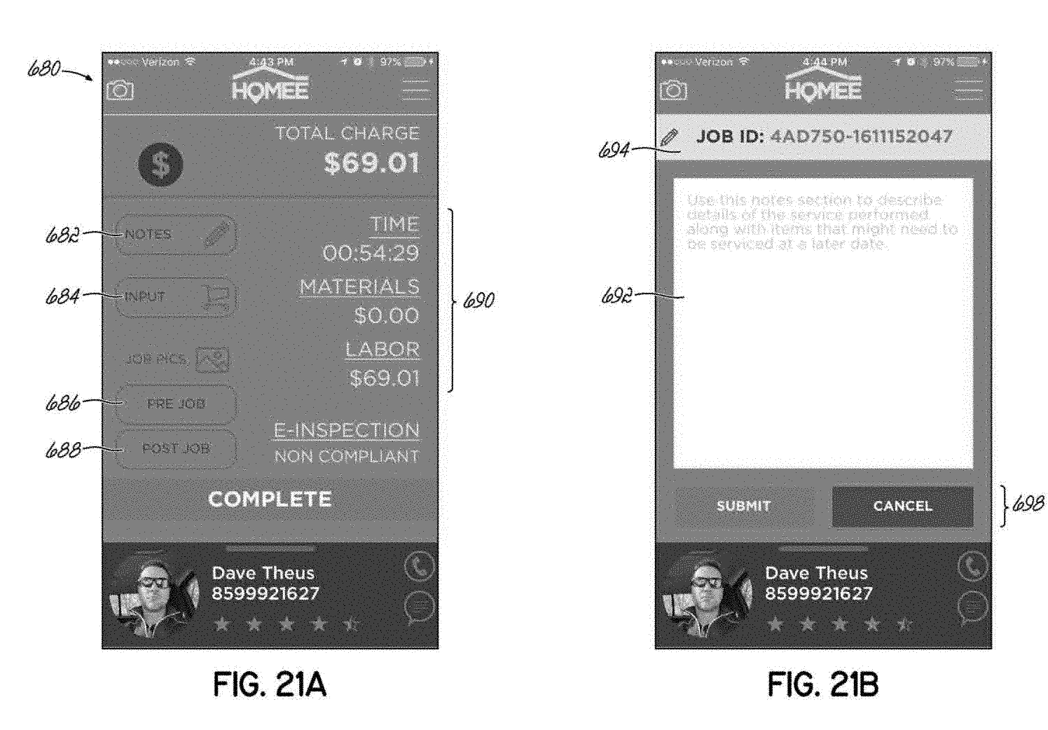

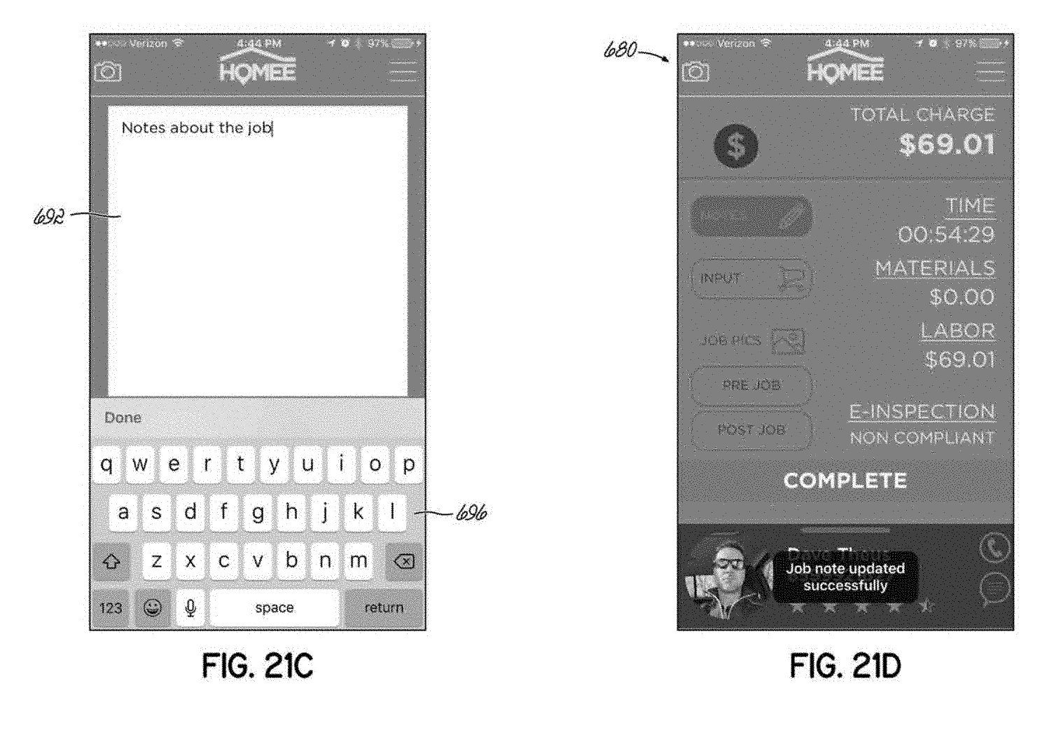

Once the provider selects that a job is complete, a Job Details screen 680 is displayed to the provider on the provider device as illustrated in FIG. 21A in order to finalize input of all the optional and required job inputs and details for finalizing the job. Through the selection of various button fields 682, 684, 686, 688, information can be entered as required or desired in accordance with the invention. Screen 680 also displays job details 690 regarding job time, materials cost, labor rate, etc. One optional information category is the notes input. Notes information is for the provider to summarize the job, to note what was done or what might be left to do at another time. Additionally, notes on the property might be included along with notes on the parts that were put in/replaced or may need to be replaced later. The notes feature provides a record that is kind of a catch all record for whatever that provider needs to add about the job. The notes are then reviewed as part of the system e-inspection process. The details may be provided through system 102, such as through a website interface with the backend server. FIG. 20F shows one possible web interface with details regarding the job. Referring to FIG. 21B, upon engagement with field 682, a notes field 692 matched with Job ID information 694 is provided for text entry, such as with a keyboard 696 as illustrated in FIG. 21C. Field 698 as shown in FIG. 21B provides the ability to submit or cancel such notes. Upon submission of the notes, the various button fields 682, 684, 686, 688 may be selectively colored in or otherwise differentiated from the screen to show before and after entry of information or to otherwise indicate that the provider has performed the function associated with the field as illustrated in FIG. 21D.

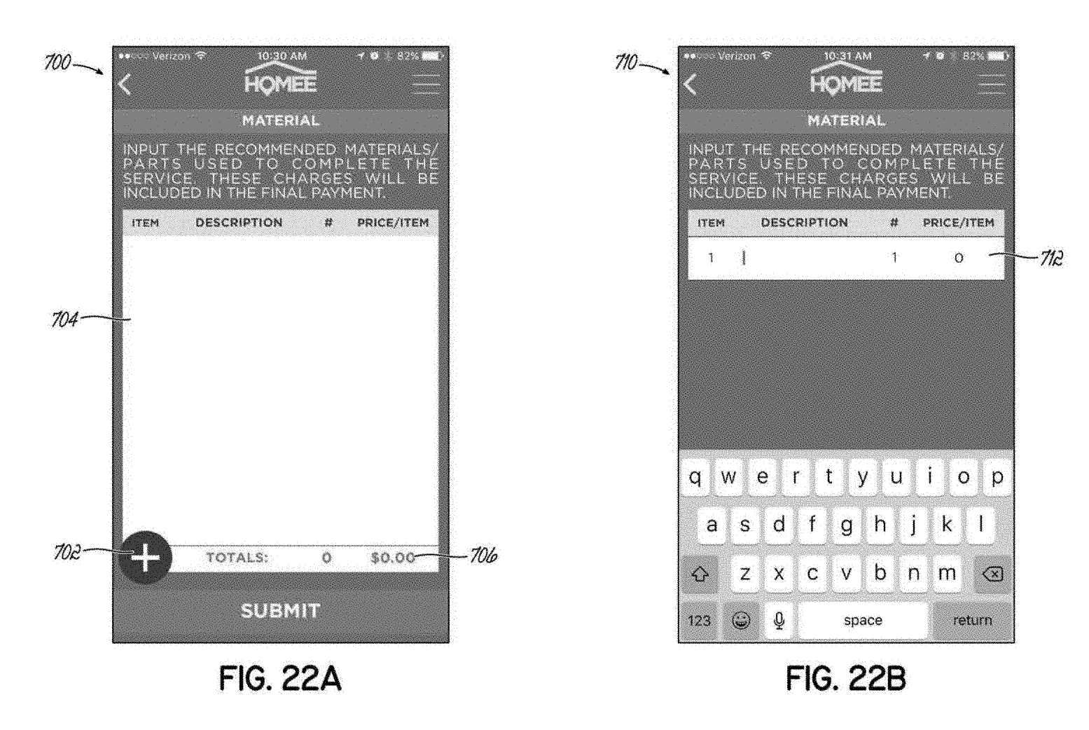

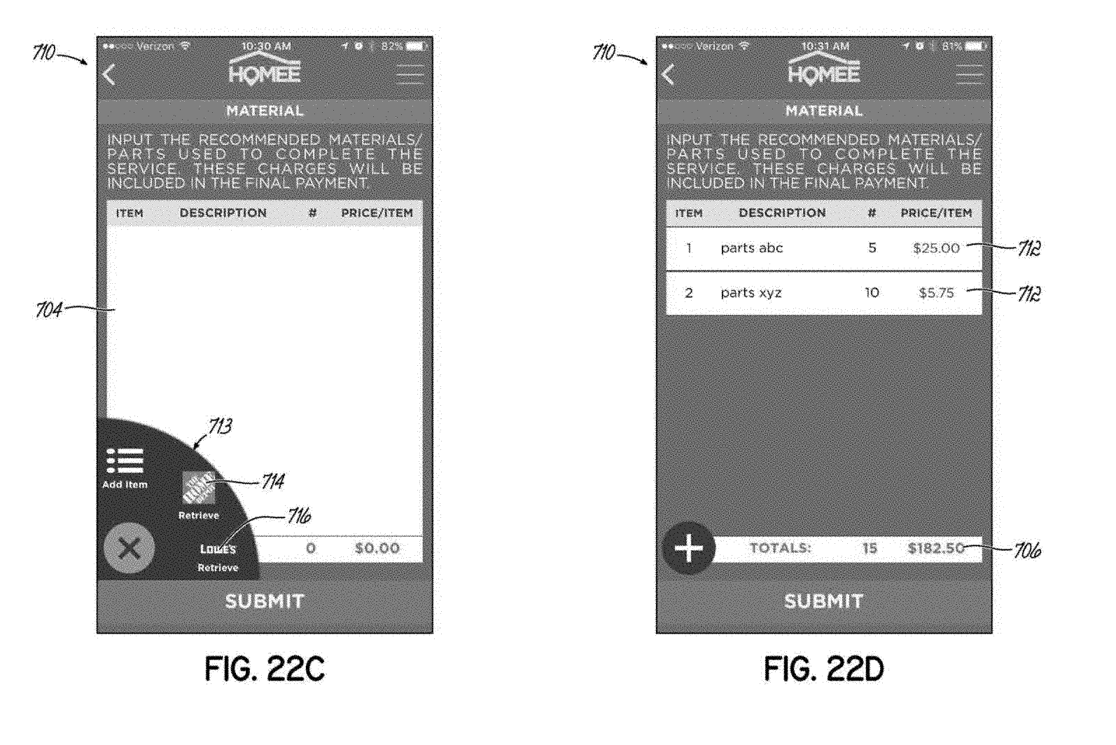

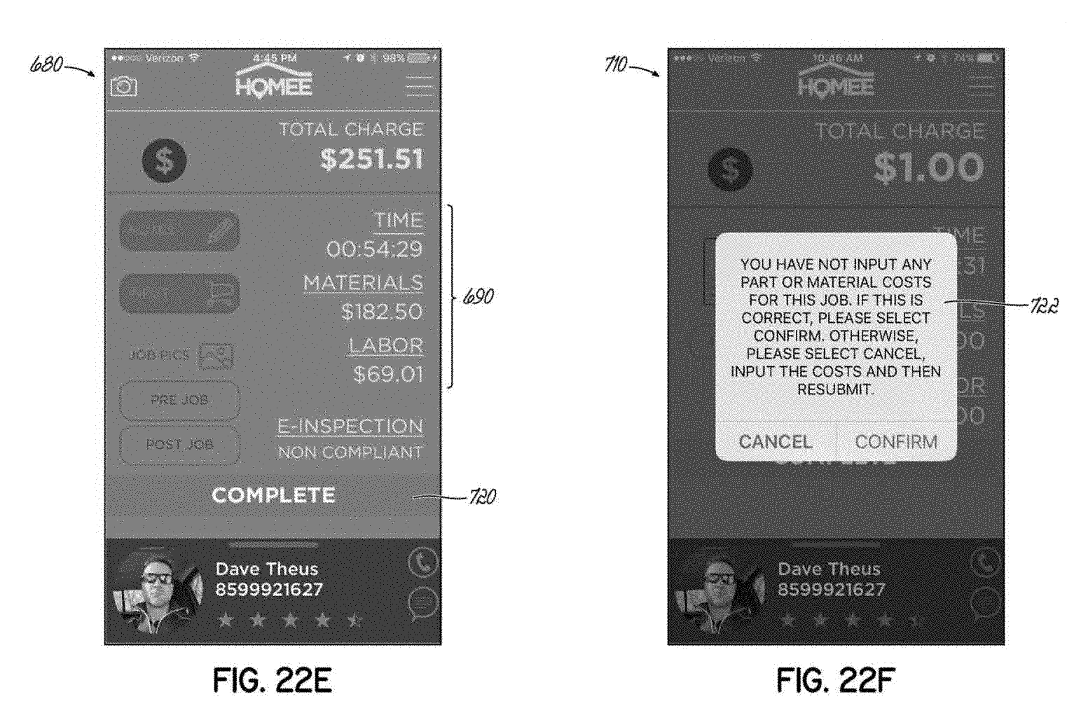

Parts and materials can be entered by the provider to show what was used to complete the service job request. When the provider engages the button field 684, the screen 700 of FIG. 22A is displayed, which is a parts and materials itemized input screen. The screen has a field 704 for entry of items, through engagement of the button field 702 (Plus icon). Also, field 706 displays the noted item total and cost total. There are a number of methods provided by the invention for the provider to create the itemized list. These options are presented to the provider when they engage button field 702 which expands into the input options available as shown in FIGS. 22B and 22C.

One option in accordance with features of the invention is for manual input whereby the provider inputs each of the parts in the itemized list. Such manual input is suitable for cases when a provider had the parts on a truck, for when the provider went outside the automated process to procure parts, or certain parts were from a store that has not been integrated into the system of the invention, such as through third party API integration through the system 102. The required information that the provider must input in one embodiment of the invention is the line item Description, Quantity and Price/Item. Referring to FIG. 22B, the field 712 and keyboard are automatically presented to the user when they tap or engage the cell input field. The Description field can be any string (numbers, characters, symbols, etc.). The Quantity and Price/Item fields are limited to numbers and there are validation checks in place in the provider App to make sure a provider does not enter a ≤zero Quantity or a ≤zero Price/Item. For each item entered, the provider selects the button field 702 and a new Row is created for input. A screen shown in FIG. 22D illustrates two items manually input. The sum of all the Quantity*Price/Item of all the rows is displayed in the last row, last cell as field 706. The Total of field 706 is also displayed on the Job Details screen 680 of FIG. 21A in the field 690 and is included in the final charges to the consumer.

Another option available for the provider in accordance with features of the invention is an integration through system 102 with third party systems 108, such as through an API interface, for implementing features of the invention and obtaining information. Referring to FIG. 22C, the screen 710 will provide additional button fields in a menu format for various vendors/retailers that may have been used by a provider in accordance with the invention to obtain parts and materials. In accordance with one illustrated example, when button field 702 is engaged, an add items menu 713 is presented and that menu includes one or more buttons for retailers, such as HOME DEPOT button 714 or LOWE'S button 716, which are displayed and may be selected to add items from a transaction.

Such an integration of a third party system with the current system in accordance with the invention may involve a specific process as described. A provider passes a background check as noted herein, and the system 102 communicates with third party vendor 108 to add that provider as an approved buyer on a third party vendor commercial account that the system 102 of the invention maintains with the third party vendor, such as for payment and accounting purposes (e.g., Home Depot Commercial Account). Additionally, the system 102 may maintain other accounts, such as professional accounts for use by providers for itemized parts lists as well as volume discounting (e.g., Home Depot Pro Account). The system 102 and API layer passes information of the provider, such as first name, last name, etc. to a third party web based system 108. Once the provider is added to the third party system and specific accounts, they are then able to go to the third party vendor and upon checking out at a register or other location, they tell the cashier they are an approved buyer of the owner of the system. The cashier will review their ID information (license or state ID or other identification information) and determine that they are an approved buyer in their system. Once verified, that provider uses the Job ID of the invention (as displayed on their timer screen or other screen on their mobile device) to the cashier to add to the receipt/invoice and then check out the provider's items, which are then added to the approved accounts. Thus, the invention provides a completely cashless transaction for the provider, and the items and record thereof are integrated through system 102 into the record associated with a particular Job ID. Once the provider finalizes the job (after using the parts), they can tap the third party buttons 714, 716. The provider App then communicates with the service system 102 and uses the Job ID to automatically retrieve the itemized electronic receipt from the third party system 108 and populates the materials table as shown in the screen of FIG. 22D. The input button field 684 changes colors or may be selectively colored in or otherwise differentiated from the screen as noted herein to show before and after entry of information or to otherwise indicate that the provider has performed the function associated with the field as illustrated in FIG. 22E.

In one embodiment of the invention, the parts/material input is optional. This is because there are jobs that require just labor and no parts. But normally, there will be parts that are required for the job. Therefore, in accordance with one feature of the invention, if a provider tries to engage a Complete field 720, in order to complete a job without adding materials/parts (FIG. 22E), a notification 722 is presented to give the provider the ability to confirm that there are no parts parts/materials used on this job. The provider has the ability to confirm and complete the parts/material entry portion of the program or to cancel and go back to the input step for adding parts/material. (FIG. 22F).

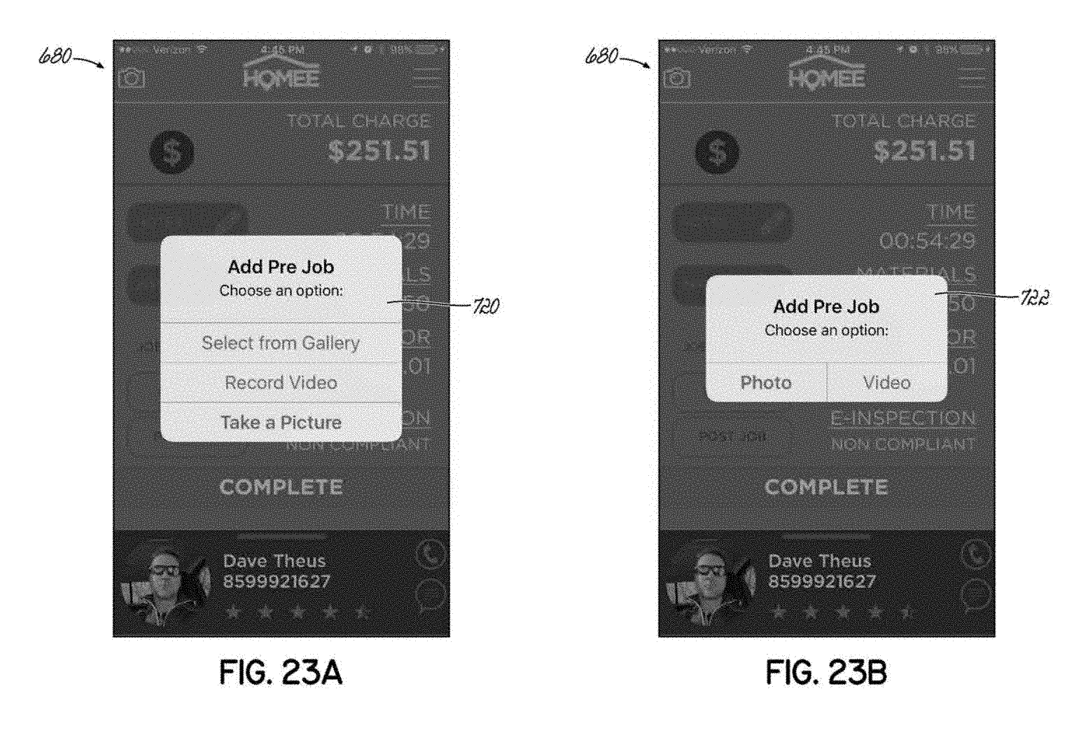

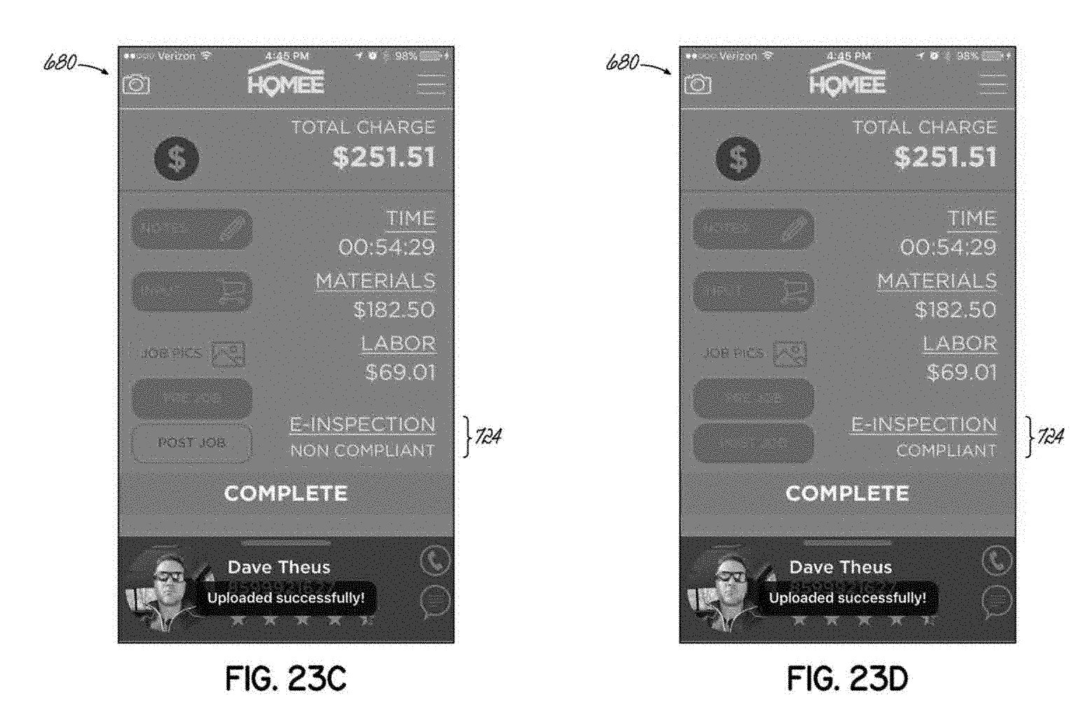

In accordance with another feature of the invention there is certain information that must be provided by the service provider and they are required such that the job cannot be completed without successfully uploading the information. The invention has an E-INSPECTION feature that requires the designated information before the job is “compliant” with the feature. In accordance with one embodiment, pre-job and post-job information, such as images/videos are required in the E-INSPECTION feature. Referring to FIG. 21A, the screen 680 has one or more button fields 686, 688 that may indicate necessary data/information for the E-INSPECTION feature. Upon engaging the buttons, as shown in FIGS. 23A and 23B, the screen 680 will display one or more modal box fields 720, 722 for selecting where the data/information may be acquired to be entered in the record for the job. For example, in the modal box field 720 a picture/video may be taken or obtained from a gallery. In modal box field 722, if a gallery selection is made, a video or photo might be selected. As is show in the screen of FIGS. 23C and 23D, if the provider has not completed the necessary uploads of information (e.g., both pre-job and post-job information), the information/label in the screen field 724 will indicate that the E-INSPECTION feature or process finds that the job submission is non-compliant. The information/label will change to compliant once these required steps for the E-INSPECTION feature are complete. Again, various input fields may change colors or may be selectively colored in or otherwise differentiated from the screen as noted herein to show before and after entry of information or to otherwise indicate that the provider has performed the function associated with the field.

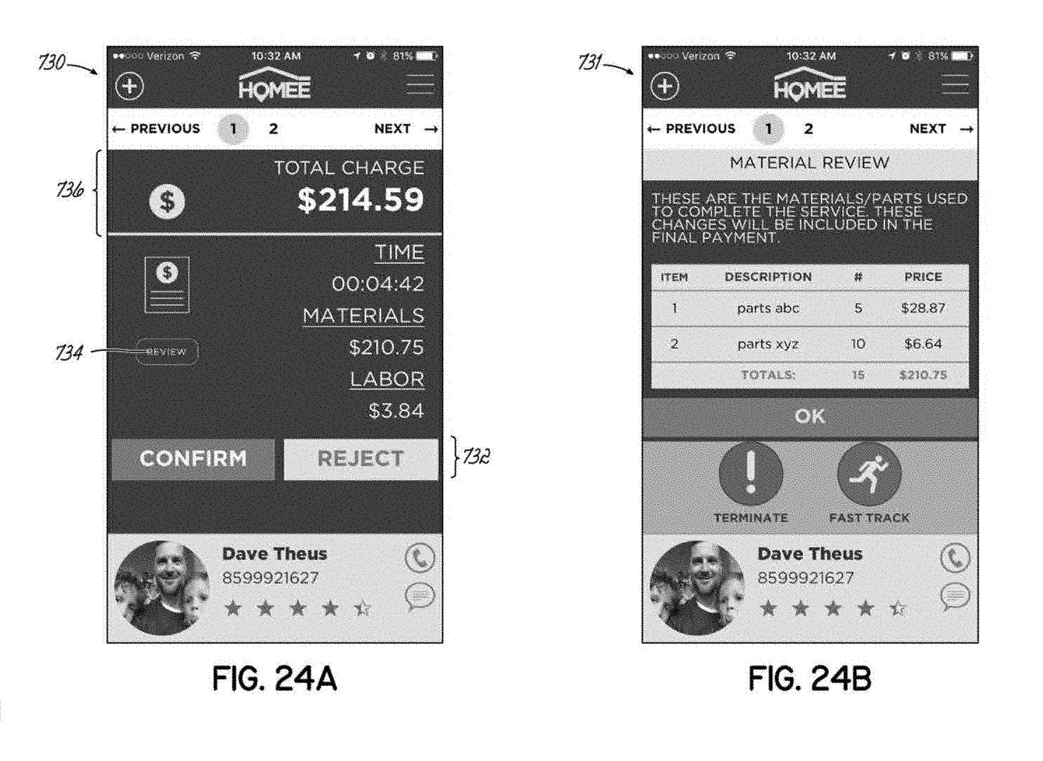

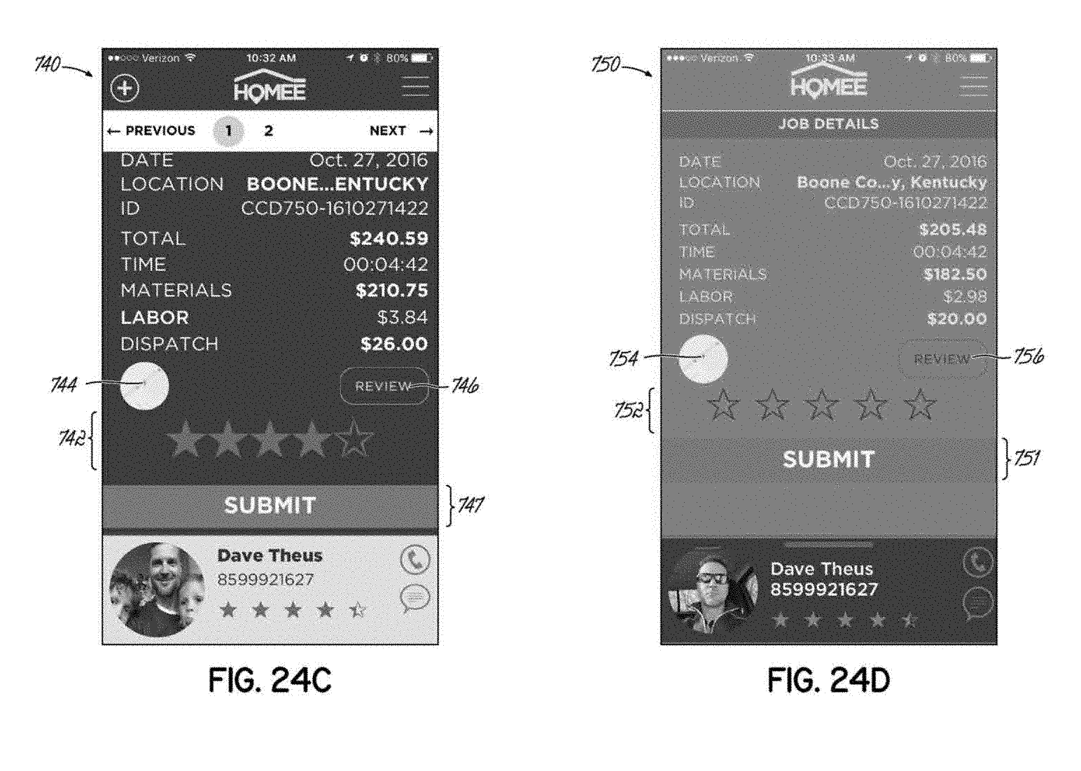

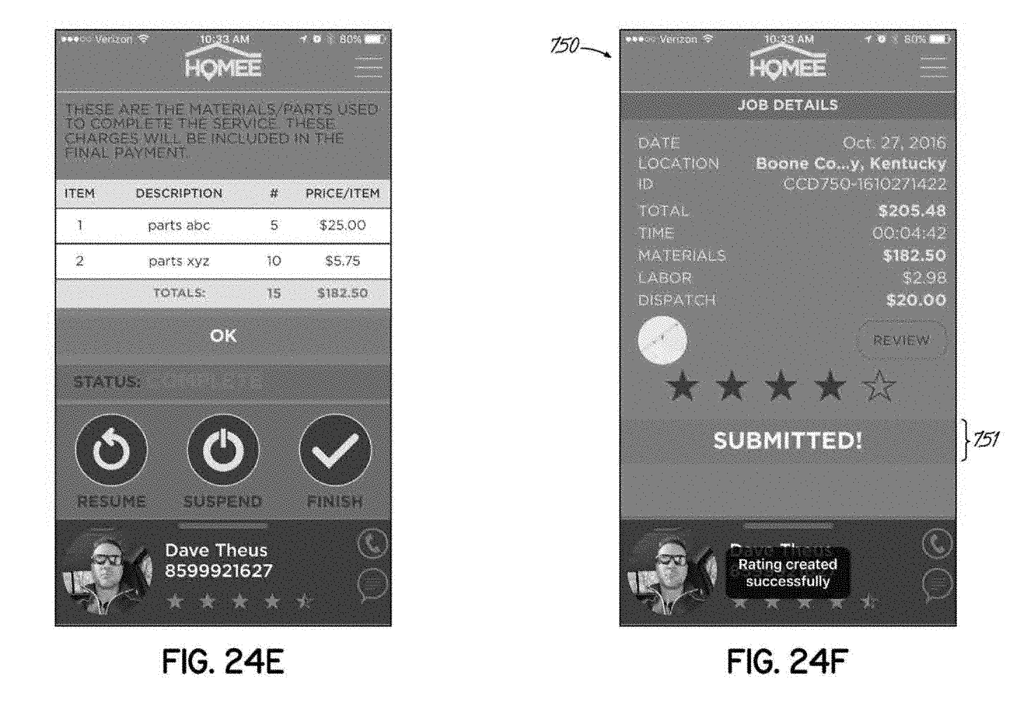

Once the provider has successfully fulfilled the requirements at the end of the job, they can engage the Complete field 720. This sends notification information to the consumer and the screen 730 of FIG. 24A is displayed on the consumer device, requiring the Consumer to engage field 732 and Confirm or Reject the job completion information. If the Consumer selects Reject, it takes both the consumer and provider back to the stopped screen of FIG. 20C allowing the provider to resume the job if it was not yet complete, or to choose to Suspend the job or to revise the materials/parts list that was submitted.

From the screen of FIG. 24A, the consumer can also review the parts/materials list (per review button field 734) that the provider submitted along with the rest of the job information or details (Total Elapsed Time, Total Materials Cost, Total Labor Cost, etc.). Screen 54B illustrates the displayed screen 731 with specific materials/parts information that is part of the final charge. The Total Charge is also displayed on the top field 736 of screen 730 in large bold font for review. The amount illustrated is the charge that will be charged to the consumer based upon their specific payment method, such as a credit card in the provider record data. Once the Consumer Confirms the job is complete and the details are all acceptable per the field 732, the screen 740 of FIG. 24C is displayed whereby the consumer has the full details of this last completed job.

Referring to the process flow of FIG. 5B, decision Block 498 is reflective of the decision of the provider to Complete or finalize the job, such that the provider is requesting approval as indicated in Block 502. Per the flow to Block 504, the consumer has to then accept (i.e., Confirm) the job completion or finalization. If the consumer confirms the job or accepts that is it finished per Block 508, then a rating system is engaged in accordance with the invention as disclosed herein, and payment occurs to the provider and is debited from the consumer. If the consumer rejects that the job is complete, flow proceeds through block 506 and back to the stopped timer screen of FIG. 19D for further disposition of the job as noted herein.

In accordance with another feature of the invention, the system 102 requires that the providers and consumers rate each other. This rating system is presented as a gate to either requesting additional on-demand jobs for the consumer or providing further services on a job for a provider. Each party can rate the other in some fashion. In accordance with one embodiment, the rating system can use a 5 star rating system. That is, a consumer can rate the provider from 1 to 5 stars (1 being the least satisfied to 5 being the most satisfied). As illustrated in FIG. 24C, the screen 740 has field 742 that has stars that may be engaged to be filled in or changed in color to provide the specific ranking. Furthermore, there is a map icon 744 that the consumer can engage and the App will display the location of the job in a full map view, they can also again Review the material/parts list from screen 740 through engagement with field 746. As noted, the screen 740 and rating of the provider is a requirement for the consumer to order another job through the inventive system. Therefore, the screen 740 of FIG. 24C is displayed even if the consumer App is closed and then reopened at a later time. In that way, the system forces the rating of the providers prior to ordering another time but not mandating that they have to provide that rating while the provider might still be with them at the job location, such as to avoid uncomfortable situations. They can then engage the Submit field 747 for submission of the ratings and complete the process from the consumer's end.

Once the consumer Confirms the job is complete and the details are all acceptable, the screen 750 of FIG. 24D is displayed by the provider App whereby the Provider has the full details of this last completed job and in accordance with the ratings feature of the invention, the provider rates the consumer. That is, a provider can rate the consumer from 1 to 5 stars (1 being the least satisfied to 5 being the most satisfied). As illustrated in FIG. 24D, the screen 750 has field 752 that has stars that may be engaged to be filled in or changed in color to provide the specific ranking. Furthermore, there is a map icon 754 that the provider can engage and the App will display the location of the job in a full map view, they can also again Review the material/parts list also from screen 750 through engagement with field 756. FIG. 24E illustrates what the screen may illustrate for reviewing the materials/parts. As noted, the screen 750 and rating of the provider is a requirement for the provider in order to get and service another job through the inventive system. Therefore, the screen 750 of FIG. 24D is displayed even if the provider App is closed and then reopened at a later time. In that way, the system forces the rating of the consumer prior to obtaining another time but not mandating that they have to provide that rating while the consumer might still be with them at the job location, such as to avoid uncomfortable situations. They can then engage the Submit field 747 for submission of the ratings and completion of the job from the providers end as illustrated in FIG. 24F wherein the field 751 displays that the ratings were submitted.

The inventive system as discussed herein is directed to a particular single job. As such the various screens, both provider and consumer, were illustrated showing the single job progression. However, in accordance with another feature of the invention, the present invention has functionality of running and supporting multiple simultaneous jobs at either multiple locations or multiple trades/jobs at a single location. in support of an extended Property Management Functionality. Using the invention, a consumer might order multiple of the same service types or might order different service types. For example, a plumbing job at one location, and then order a handyman job at another location, or a plumbing job at one location and electrical job at that same location, etc. The invention is not limited to particular job mixtures.

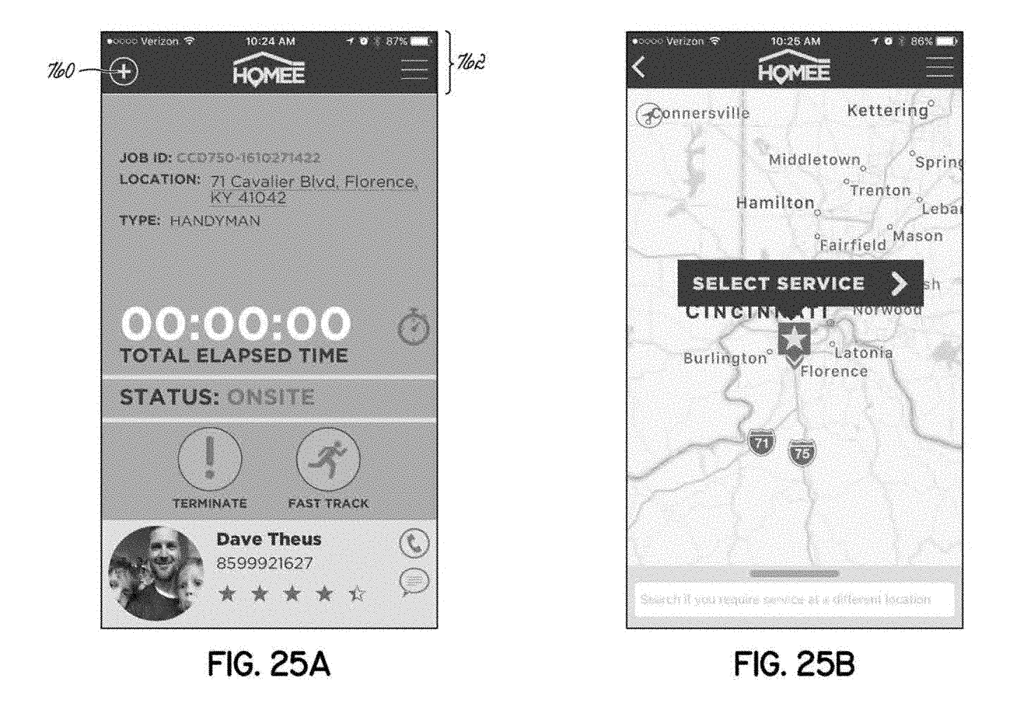

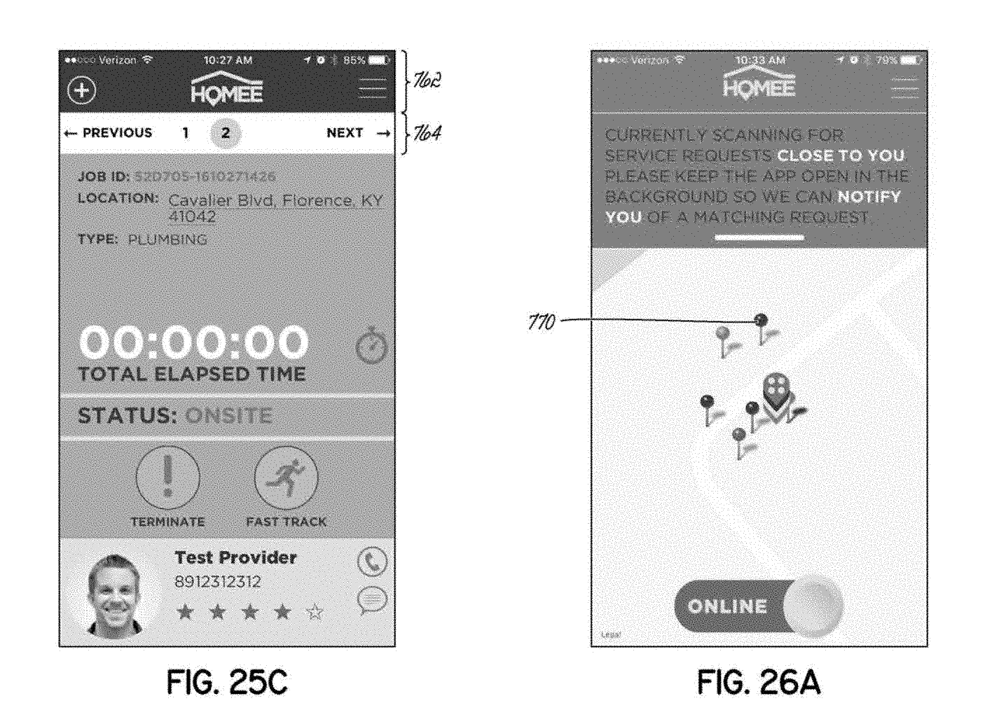

With this feature of the invention, different providers with different rates are supported. Multiple Job IDs are assigned and managed and multiple timers are used and controlled. Accordingly, jobs can be started and paused, and resumed independently with essentially full consumer independent control of those individual jobs through the support of the multiple job functionality of the invention. Referring to FIG. 25A, a consumer screen showing the details of an existing job where the provider is onsite is shown. To utilize multiple job features, the consumer engages a button field (PLUS button) 760 in the top header field 762 of the screen, when they have already begun a single job. Once a consumer taps on the button field 760, the process for requesting service through in-app notifications, through timer controls, through finalizing a job and rating a provider are similar to the program flow and process as disclosed herein. However, these independently controlled jobs can be accessed through a jobs pagination field 764 directly under the header field 762 as illustrated in FIG. 25C.

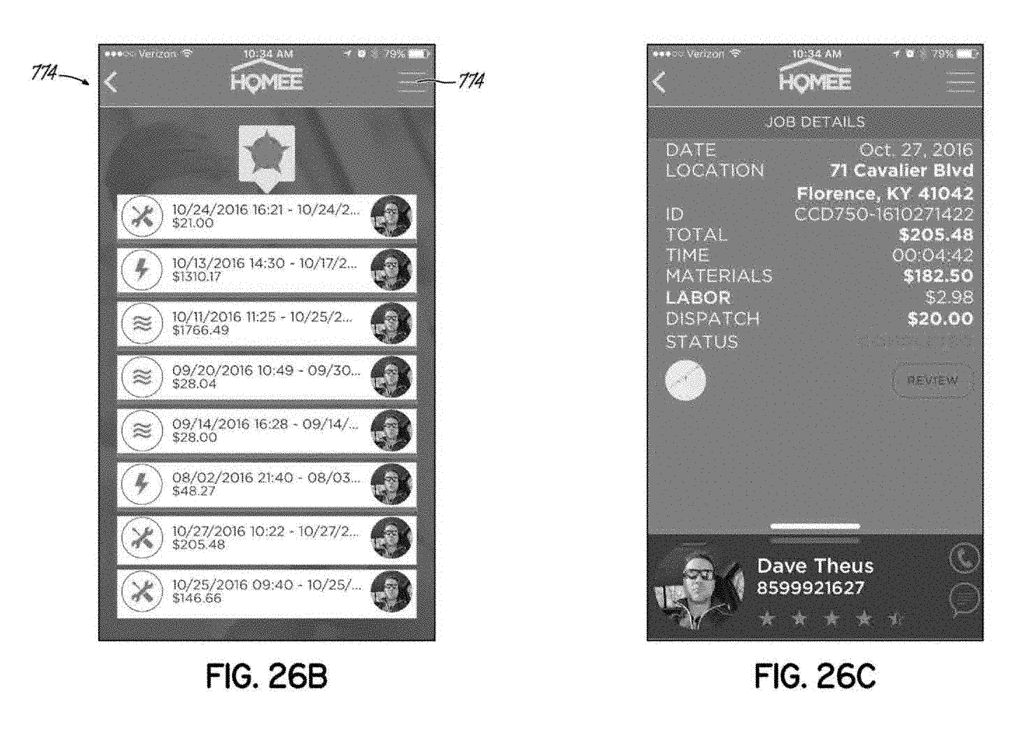

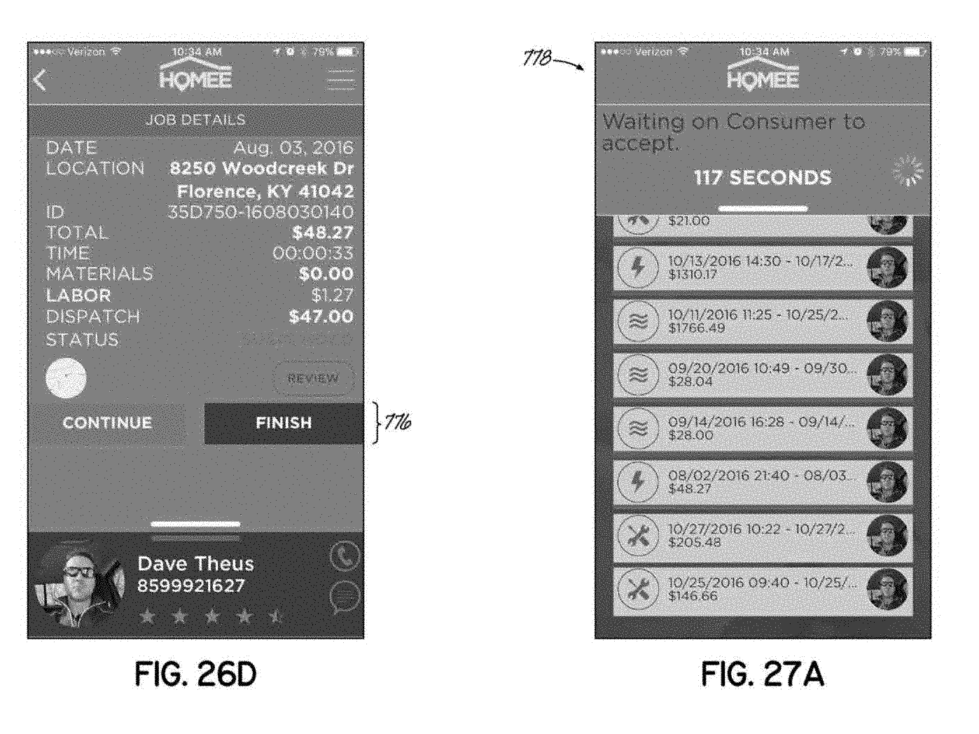

Various other features of the inventive system provide additional information to a consumer or provider for access through a respective mobile device and App. For example, the provider App map function is to provide for indications of past jobs for a provider to review. Such information might be accessed, for example, from the service system of the server that stores the various provider records and such information. In one feature, on the providers Map screen, as shown again in FIG. 26A, the last 10 job locations are displayed with color coded pins 770 indicating the following:

### Dark Blue: Completed Jobs

### Orange: Suspended Jobs

### Green: In Process Jobs

The color coding corresponds to the color coding which is also utilized on a job history screen and feature that is provided as well by the system for the provider to evaluate jobs of various different statuses. Referring to FIG. 26B, screen 772 is illustrated that shows a list of the various past jobs. The same color coding scheme is utilized here as in the map pins of FIG. 26A. The job history screen is accessible through a menu field 774 of screen 772 in FIG. 26B located in the top header field of the screen. The listing in screen 772 has the green underlined item illustrated as an in-process job and it is illustrated at the top of the list as primary importance on the screen 772. If the provider engages or taps a pin or one of the listings in screen 772, another job history screen showing details is provided. Referring to FIG. 26C, a screen with job details for a completed job is illustrated. In FIG. 26D a screen with job details for a suspended job is illustrated. In accordance with one feature of the invention the provider App allows a provider to display an infinitely loading list of the past jobs of that provider and can sort them in various ways. They may be sorted by order of job status, then secondarily in chronological order. For example, the in process jobs might be displayed first, followed by suspended jobs and then completed jobs, all in chronological order. The listings underlined in orange indicate that these jobs are in a suspended state for easy completion or finishing. The last listed items are those jobs that have been successfully completed. As illustrated in the list of FIG. 26B, each of the entries in the list show the type of service that was performed (indicated by the service icon), the date the job was initiated, the total price of the service thus far, and the information (e.g. an avatar) of the consumer that had requested the job. As noted, when a provider engages a listing in the job history list, a full screen of details, such as in FIGS. 26C, D are displayed by the provider App.

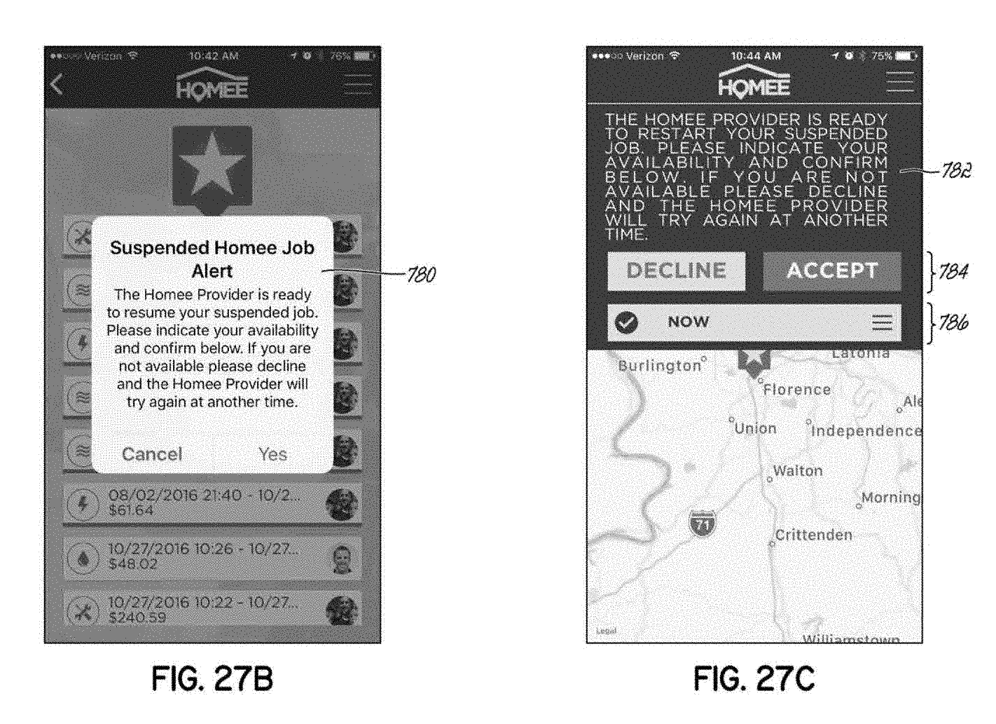

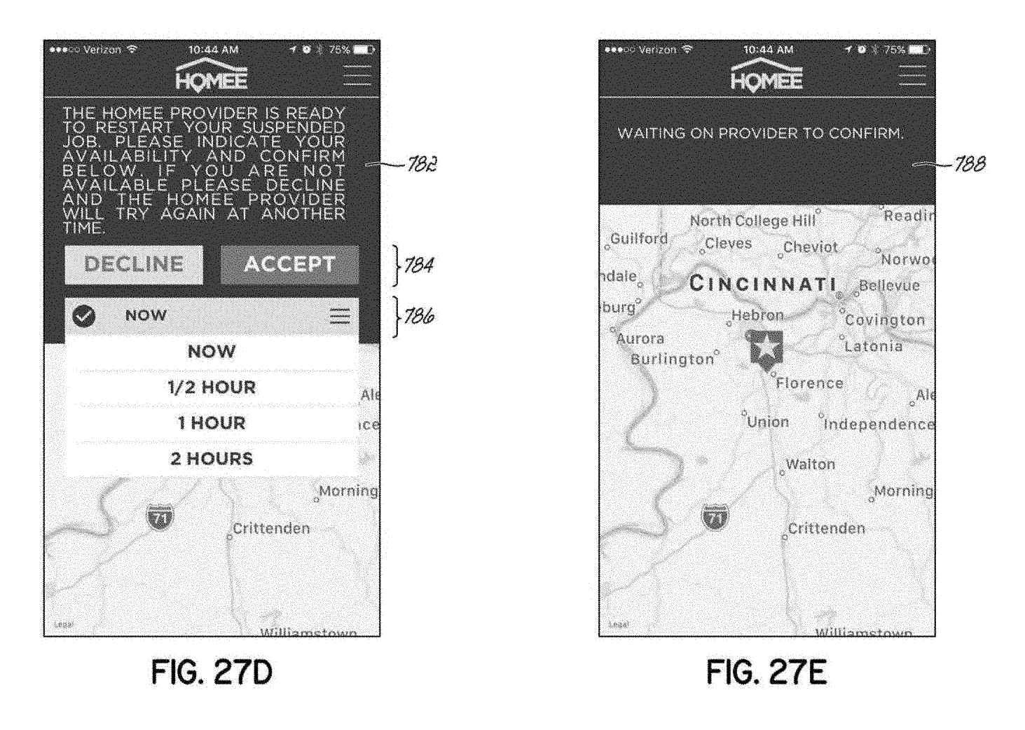

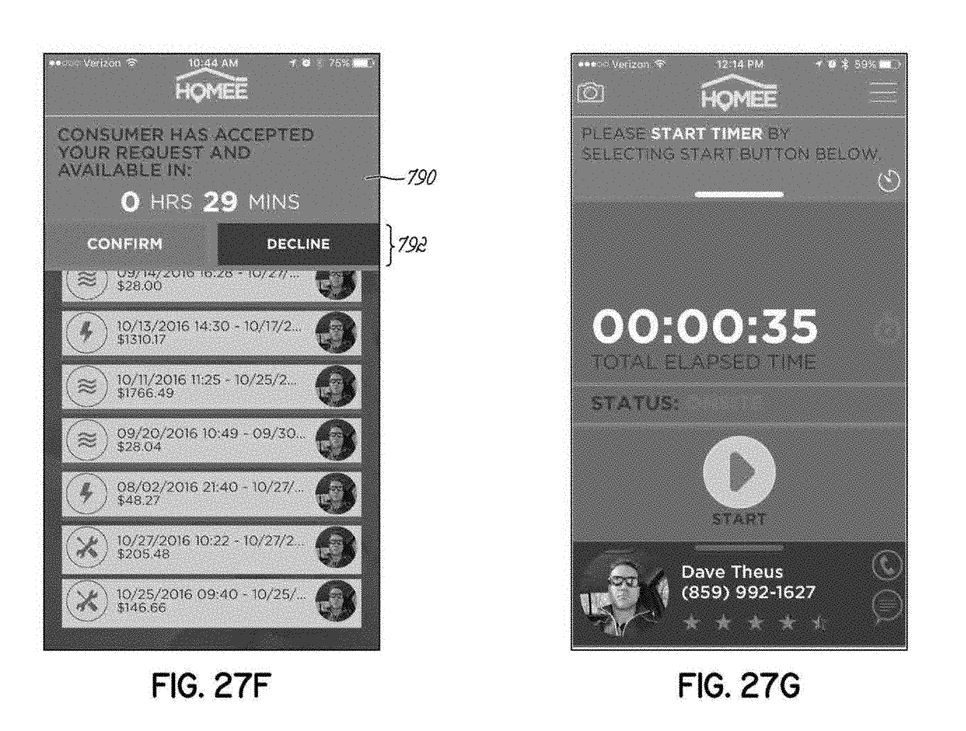

Depending on the job status, a provider might resume a job that was previously suspended. Referring again to FIG. 26D, a suspended job and details is illustrated on the screen. The provider can choose to continue the job or to finish the job through appropriate buttons of field 776. If a Provider engages the Continue button, a notification 778 is provided on the provider device screen as shown in FIG. 27A that the consumer needs to accept and a wait timer run by the provider App is shown. While the screen in FIG. 27A illustrates a short wait, the wait may progress for days after the job was suspended. Simultaneously in the consumer App, the consumer receives an alert notification 780 on their device as illustrated in the screen of FIG. 27B. In accordance with one feature of the invention, the notification regarding the resumption or “unsuspension” of an open job will appear on the consumer device screen whether the provider is in or out of the consumer App so they are made aware. The notification 780 allows them to indicate (Yes or Cancel) that they are available and then provides further options to the consumer if they are available to have a provider resume the job. In accordance with another feature of the invention, the consumer has the ability to provide a schedule to the provider on a resumed or restarted job, that will then have to be approved by the provider. This is different than the initial engagement on the job wherein the consumer approves or disapproves of a schedule presented by the provider. Specifically, if the consumer taps Yes in the notification 780, the consumer App provides the screen of FIG. 27C with a notification 782 that the provider is ready to resume and with a field 784 that the consumer can engage to accept or decline and also schedule their availability to continue the suspended job. For example, the consumer can accept and indicate they are available immediately or schedule up to 2 hours later through a drop down menu 786 or they can decline the continuation of the suspended job. If the job is to resume (e.g. Accept) through the screen of FIG. 27D, and the consumer is available immediately, the job resumes and the navigation process begins as indicated in FIG. 17 E for example. However, if the job is to resume, but the consumer is not yet ready or available for it to resume immediately, and they have therefore selected a scheduled or delayed start time as illustrated in FIG. 27D, the provider must accept the proposed consumer schedule. The provider is notified of the proposed schedule of the consumer by a notification 790 in the screen on the provider device as illustrated in FIG. 27F. The provider also is presented an input field 792 that the provider can engage and accept the proposed consumer schedule (i.e., Confirm), or reject the schedule (i.e., Decline). In that process, the consumer is presented with the screen of FIG. 27E and notification 788 on the consumer device. If the provider accepts and engages the Confirm button, the job resumes with a timer screen as shown in FIG. 27G. If the provider engages the Decline button and rejects the job, the job is placed back in a suspended state.

Referring to the flowchart in FIG. 5B, as illustrated in Block 478, if the provider seeks to unsuspend or resume a job, the consumer has to take the action of accepting or rejecting that request, per Block 480. If the consumer declines or rejects that job resume or restart, the job returns to the suspended state (Block 476). If however the consumer accepts the job restart, they can do so for an immediate start or they can propose a schedule for the restart as reflected in decision Block 486. If the consumer can resume the job immediately then the flow proceeds through Block 492 as illustrated and the provider proceeds through the navigation process as illustrated with Block 422 of FIG. 5A. If however, a delayed restart and schedule is requested by the consumer as illustrated in the flow of Block 488, then the provider is presented with the decision to accept or reject the proposed schedule as noted. If the schedule is accepted, the job resumes and the provider again proceeds to the job per Block 422 as described herein. If the schedule is rejected by the provider, the job is again suspended (Block 476).

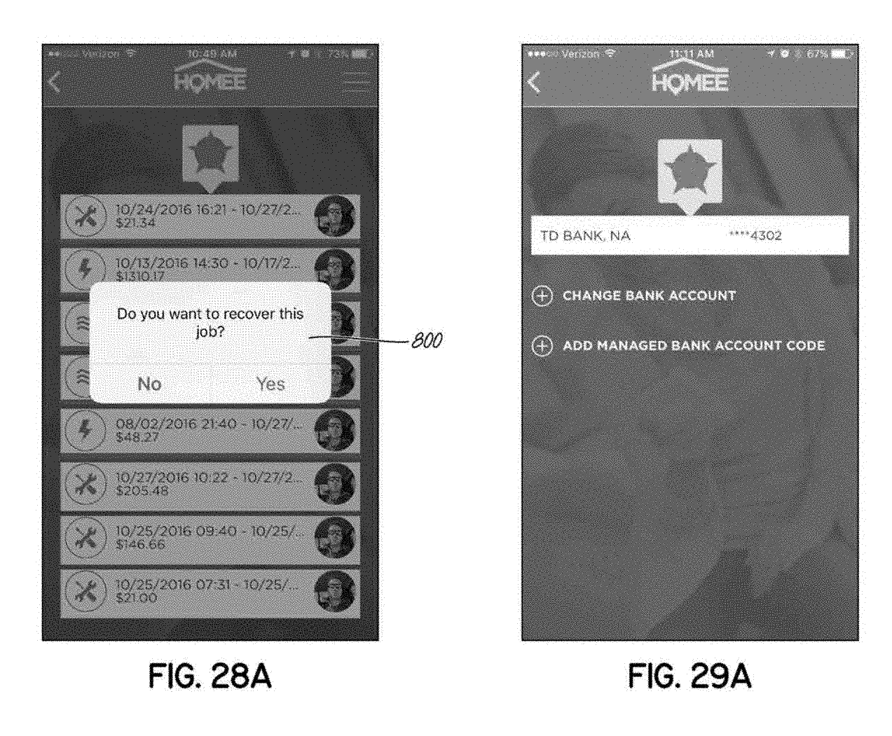

In accordance with another feature of the invention, if either of the consumer or provider Apps gets into an unrecoverable state (screen freezes, App crashes, etc.), the Apps each have a Clear and Recover job functionality that is available. A notification and input field 800 are presented as illustrated in the screen of FIG. 28A. This functionality clears whatever job is currently displayed in the app and recovers the job that the user then selects from the job history. This Recover job functionality works only on jobs that are currently in process. When used, the particular user is taken back to the timer for their App and the time is synced with the service system server which maintains a master elapsed time for each of the running jobs.

The consumer and provider Apps each maintain profiles for the particular consumer or provider. Such records are maintained in the service system 102 on the backend server 107. Through menus provided through the user interfaces as disclosed herein, such as in the header field of each of the consumer and provider Apps, the consumer and provider can input information associated with respective profiles as well as financial information.

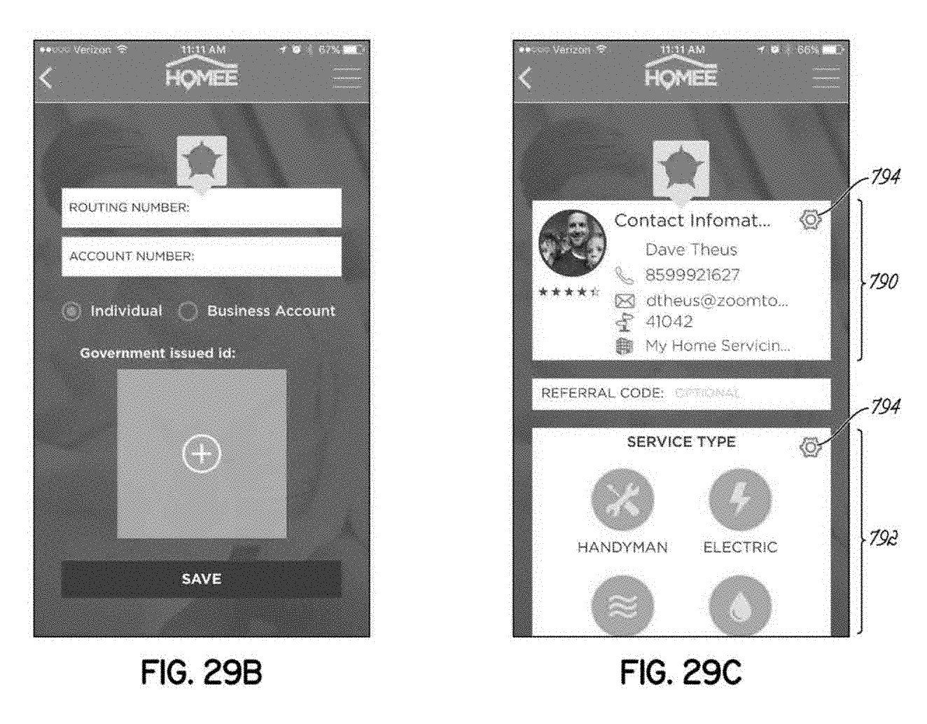

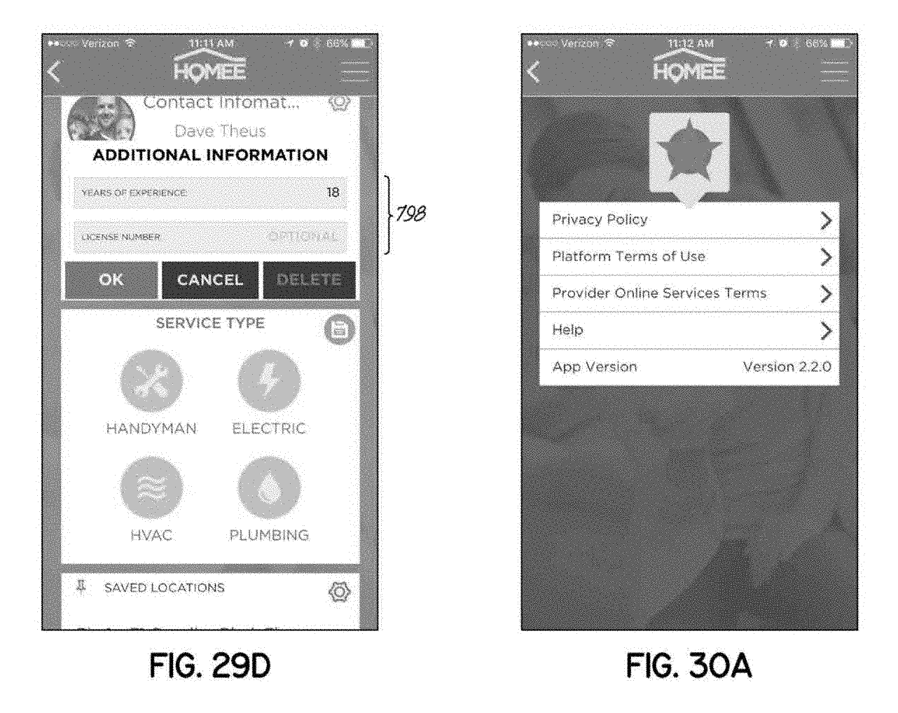

Referring to FIGS. 29A and 29B, the provider can provide banking information for their particular account or can link to a Master Service Owner account as discussed herein. As shown, the user interfaces present various fields and selectable input fields that allow the data to be entered and saved as appropriate. Furthermore, the provider can provide information for building or editing their profile. FIGS. 29C and 29D illustrate interface screens for the provider profile. There may be sections for contact information, referral codes, service types, saved locations, etc. Such referral codes may be used to attribute a consumer or customer to a customer acquisition program or to certain people, wherein rewards within the program of the invention might be utilized. The various information in fields 790, 792 might be entered or edited as appropriate, such as through suitable icons 794, 796. Referring to FIG. 29D, if the provider edits the service type information and selects a service type, input fields 798 are presented for providing additional information, such as years of experience and license information.

Other information might also be accessed by a provider through the menus, such as privacy policies, terms of use, provider service terms, help, etc as illustrated in the interface screen of FIG. 30A.

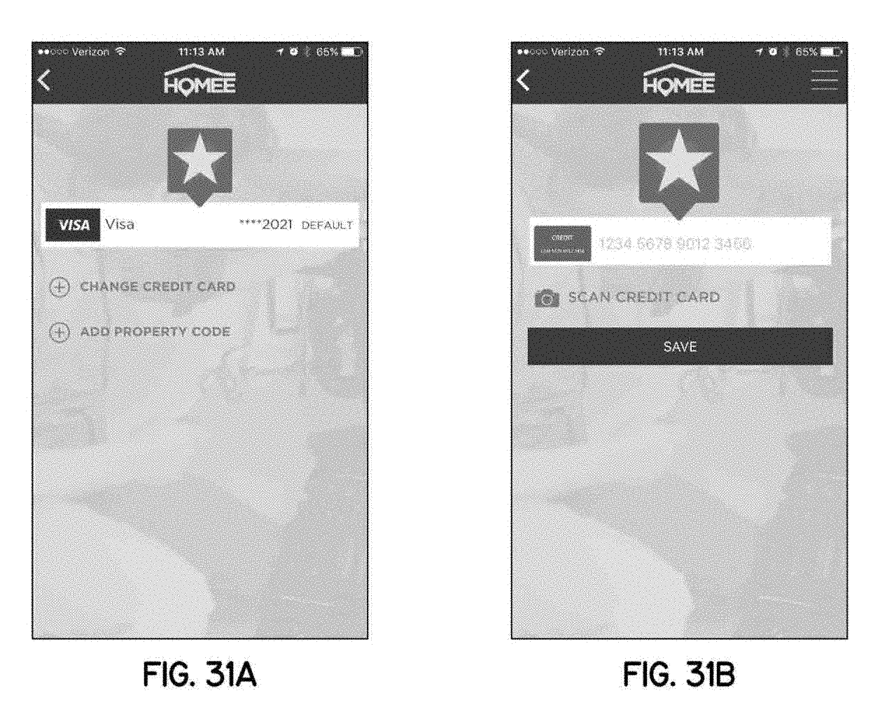

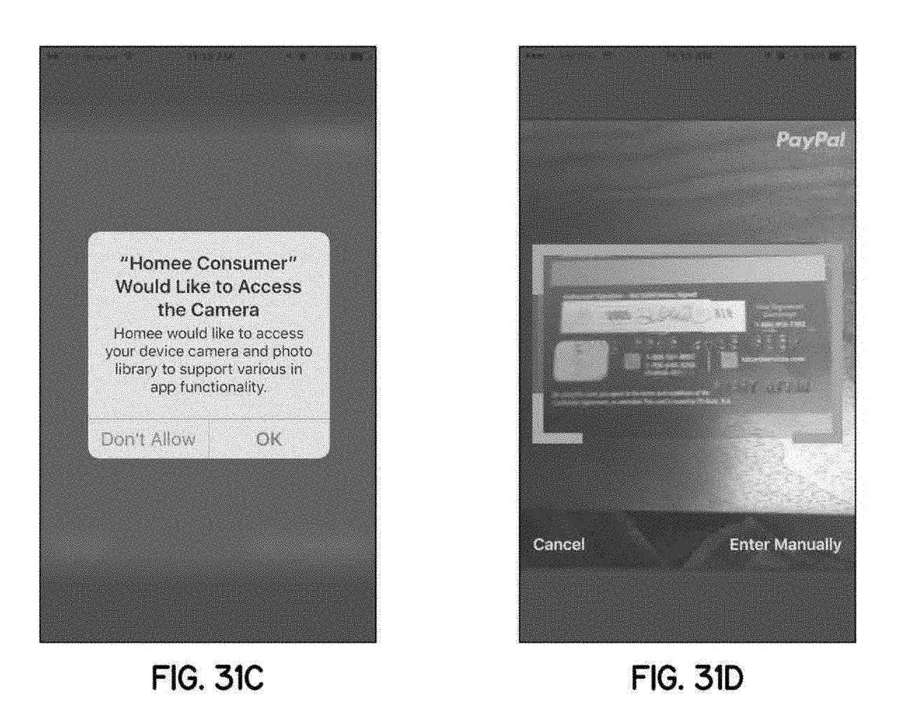

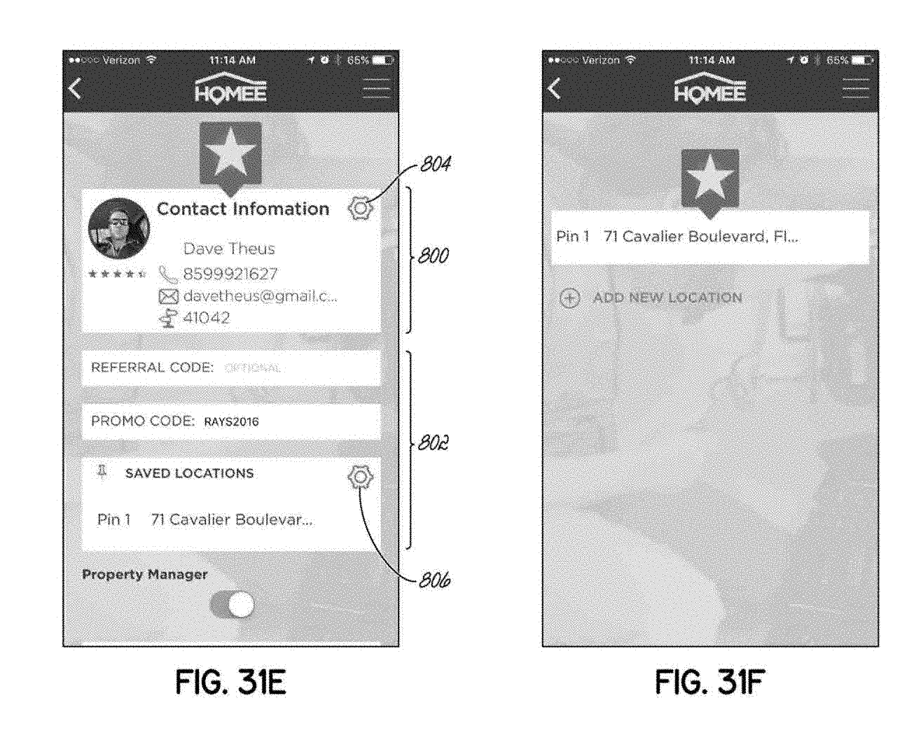

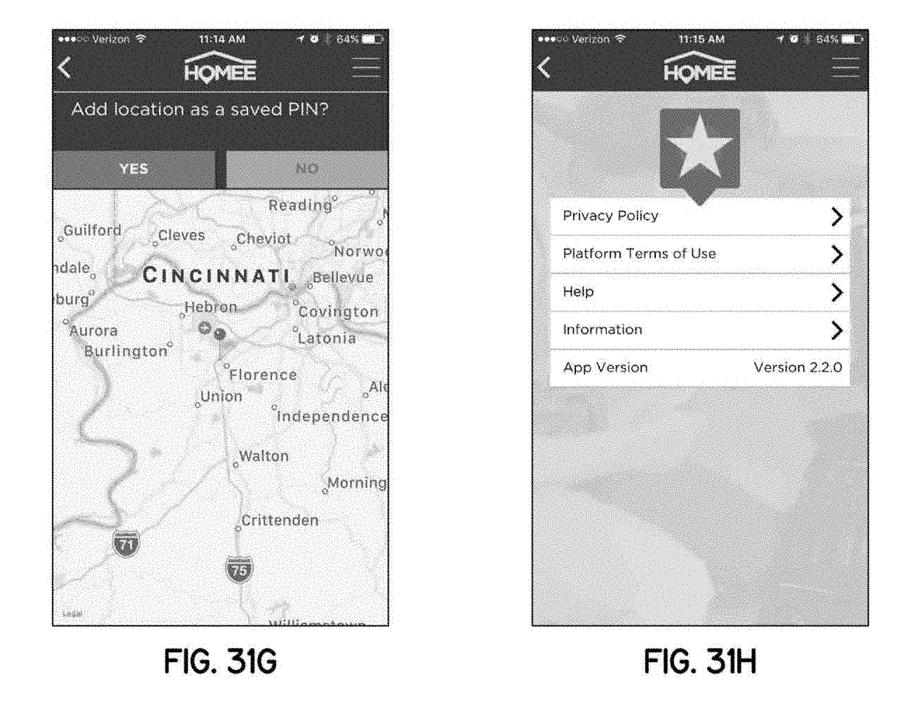

Referring to FIGS. 31A-H, the consumer can also build and edit a profile and provide banking/financial information for their particular account or can link to a Property Management Owner account as discussed herein. As shown, the user interfaces present various fields and selectable input fields that allow the data to be entered and saved as appropriate. Referring to FIGS. 31A and 31B information for a credit card may be entered for paying a provider upon completion of a job. As discussed further herein, property codes for properties that are owned and/or managed by another party, can be entered for other accounts as described herein. The screen 820, might include fields 821, 823 for adding or changing credit card information and/or adding a managed property token. In accordance with one feature, a credit card might be scanned as provided by the consumer App functionality and illustrated in the screens of FIGS. 31C and 31D. FIGS. 31E-G illustrate interface screens for the consumer profile. There may be sections for contact information, referral codes, promotional codes, saved locations, etc. For example, promotional codes may link to coupons or other programs for monetary savings on certain jobs. The various information in fields 800, 802 might be entered or edited as appropriate, such as through suitable icons 804, 806. Referring to FIG. 31F, various saved locations might be illustrated in a saved location screen and might be used for ordering service at different locations, such as a home, an office, a vacation property, etc. the various locations on the screen may be edited and deleted as a record through appropriate interfaces as would be understood by a person of ordinary skill in the art. The function of saving such locations can be enhanced by the location features of the invention and a map screen might be used as illustrated in FIG. 31G for confirming the address that is to be a saved location, if the provider edits the service type information and selects a service type, input fields 798 are presented for providing additional information, such as years of experience and license information.

Other information might also be accessed by a consumer through the menus, such as privacy policies, terms of use, help, etc. as illustrated in the interface screen of FIG. 31H.

### Property Management

In various uses of the invention, the consumer is the ultimate owner of the property for which service is requested. As such, and as discussed in the examples herein, the consumer deals directly with the provider for service and approval and payment for a job. Therefore, in a normal or typical job request workflow, a consumer can submit a consumer request and the system of the invention automatically generates a set of provider requests and associated records that are based on consumer request data and based on current provider availability and location. Providers can then accept the provider request received in their provider App. Then the consumer can approve/decline the accepted provider requests in their consumer app until an acceptable provider is confirmed and the consumer request becomes a job and service is completed.

However, there are scenarios wherein the consumer requesting the service does not own the property and may not be paying directly for any service or job. For example, a consumer might be a tenant of the property where they live. As such, the ultimate payor and ultimate approver for a service in accordance with the invention may be the true owner or others serving in a capacity for the true owner, such as a landlord or a property manager. There are other scenarios wherein a landlord or property manager wants to empower a tenant/consumer to order a service for the property as needed. In accordance with another feature of the present invention, the system supports the situation of managed properties where a property manager or owner can create one or more properties in the inventive system wherein the consumer/tenant can order the service and pay for it through an account of the property manager. In accordance with one embodiment of the invention, a consumer (user that downloads the consumer App on their device) may designate themselves as a property manager. In the current examples, the consumer that is a property owner or manager will be referred to herein as the “property manager” and the consumer that is requesting service will be referred to as the “tenant”. However, such terms are not limiting and the various parties might have other relationships wherein one party has to give approval to another party that is ordering service before a consumer request is made in accordance with the invention.

Specifically, a property manager invites one or more tenants to add a managed payment method to their account and the tenant can add the managed payment method through a payment information screen (e.g. FIG. 31A, 37A) by using a property code provided by the property manager. Using the code, the tenant then joins a managed property group that is associated with data records for a particular property manager. By joining a managed property group, the tenant can request services at the property that will be paid for by the property manager.

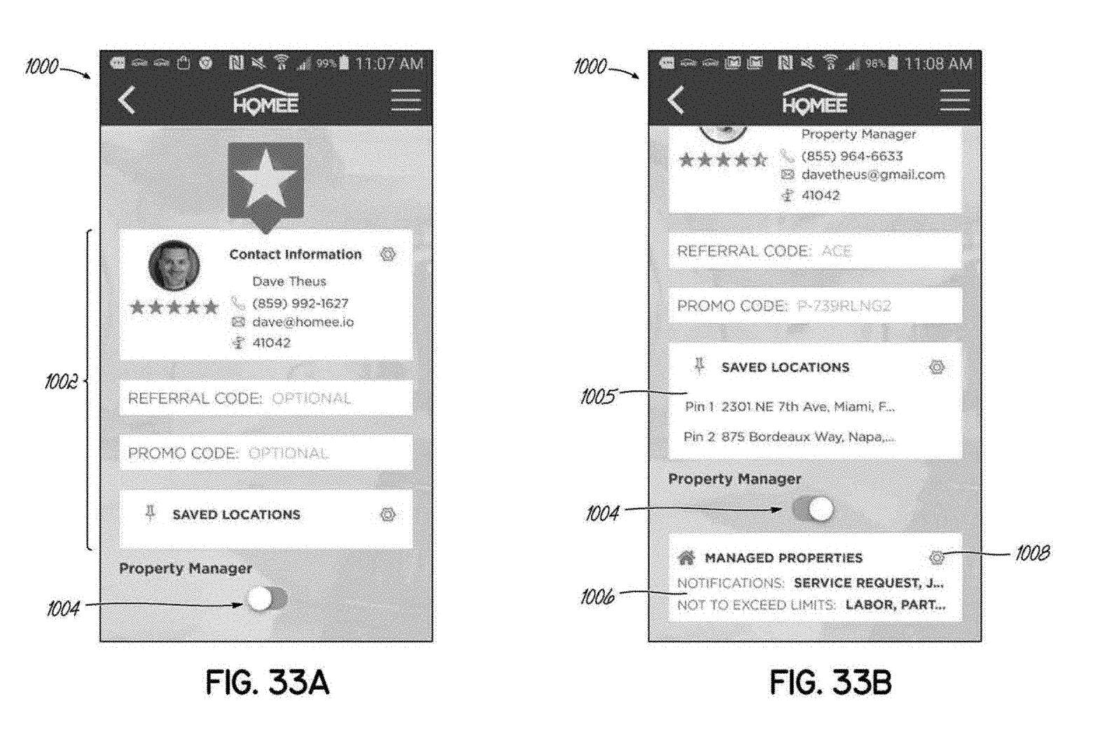

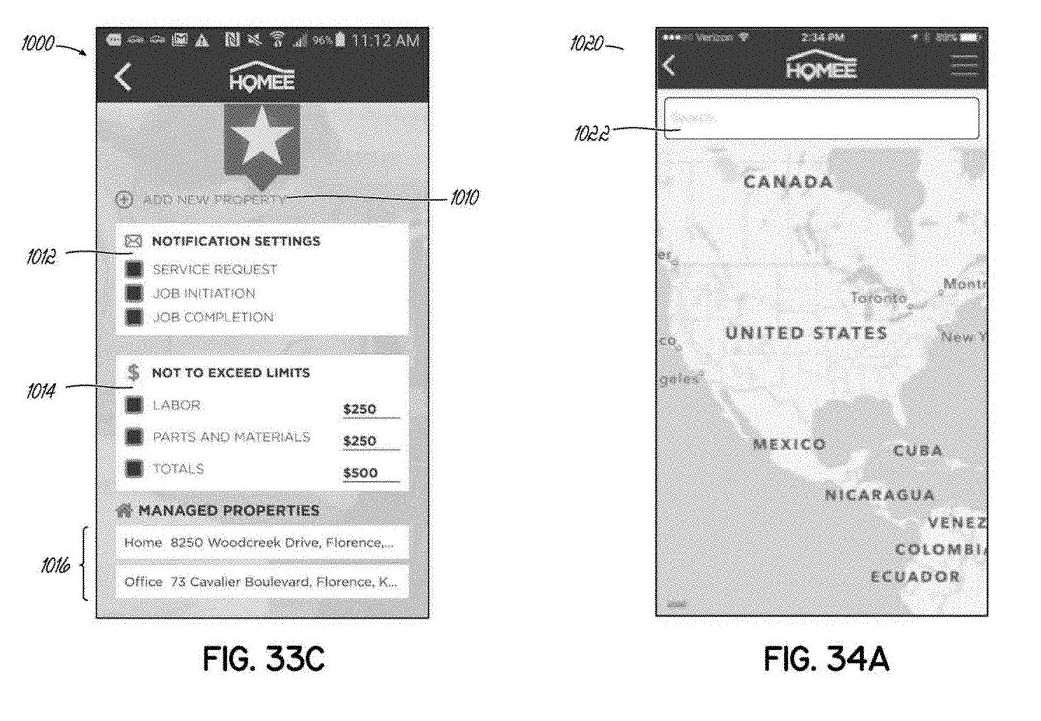

Referring to FIG. 5D, in the program flow 1100, the property manager will download the consumer App and will have a chance, during the initial setup workflow as discussed herein for a consumer App, to add managed properties and thus act as a property manager (Block 1120). Referring to FIG. 33A and screen 1000, in addition to one or more fields 1002 for entering information on the consumer, there is a toggle/slider field 1004 which may be engaged to enable the advanced functionality within the consumers profile screen. Once the user toggles on the property manager field 1004 the system presents the property manager with a field 1006 for adding and configuring managed properties, as illustrated in FIG. 33B. A selectable field, such as an icon 1008, might be selected within the managed properties field 1006. The property manager is then presented with fields for adding managed properties and configuring Notification settings and Not to Exceed limits to be applied to the property to be managed. Referring to FIG. 33C, a field 1010 is provided to add information regarding a property to be managed. Field 1012 may be used to enter preferences for when the property manager is to be notified, such as upon a request of service, upon a job initiation and/or upon a job completion. Field 1014 then allows the property manager to add certain Not to Exceed limits for job parameters such as labor and parts/materials. These preference settings from the fields 1012, 1014 are then applied to all job requests that are tied to the managed properties, that are also displayed in field 1016

For example, the property manager can add notification parameter through selected settings (Block 1122). Based on the notification settings the inventive system sends notification messages (e.g. emails) to the property manager when services are requested at a property location, when a job is initiated e.g. when a timer started), and/or when a job is completed (e.g. when the final details are approved). Other notification parameters might be set in accordance with features of the invention. Also, Not to Exceed limits may be added (Block 1124). The Not to Exceed limits are used for the Property Manager to control the job once it is started. If any of these limits are exceeded (e.g. a trigger might be 80% of labor/total, 100% of material) the job is automatically paused by this system and locked (not able to be resumed by the provider). For the purposes of resuming the job, the inventive system sends a message (e.g. an SMS message) to the property manager with a code (e.g. a 6 digit code) that can then be sent back in a message (e.g. another SMS message) with approval to resume. The system then uses the returned code to resume the service job.

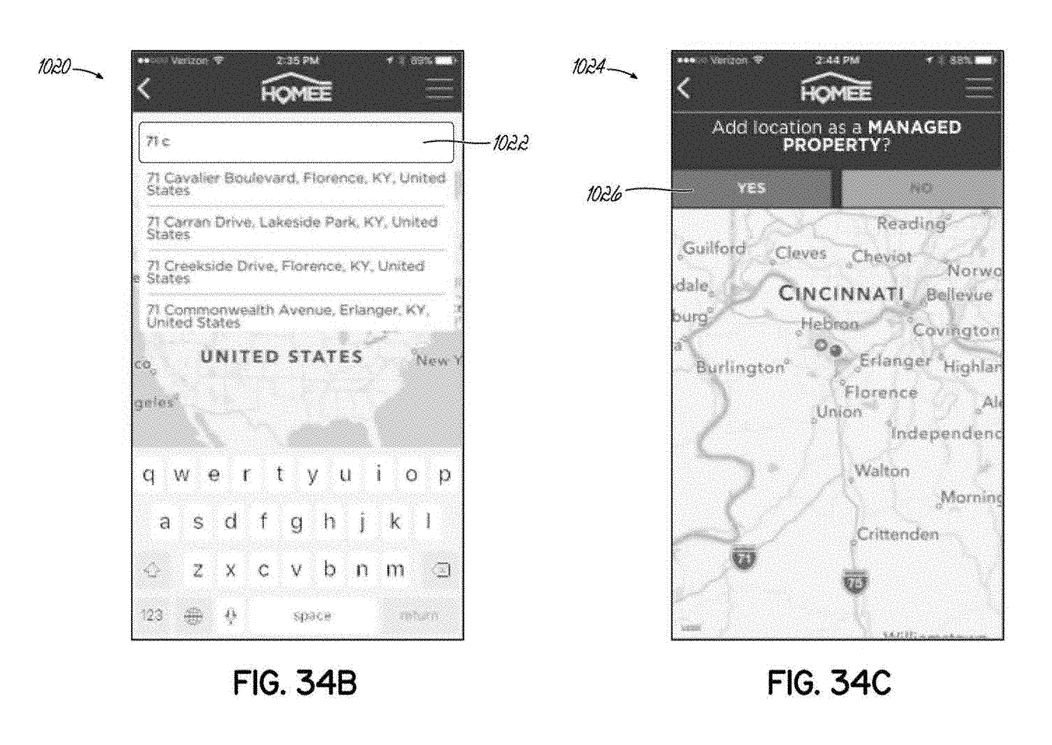

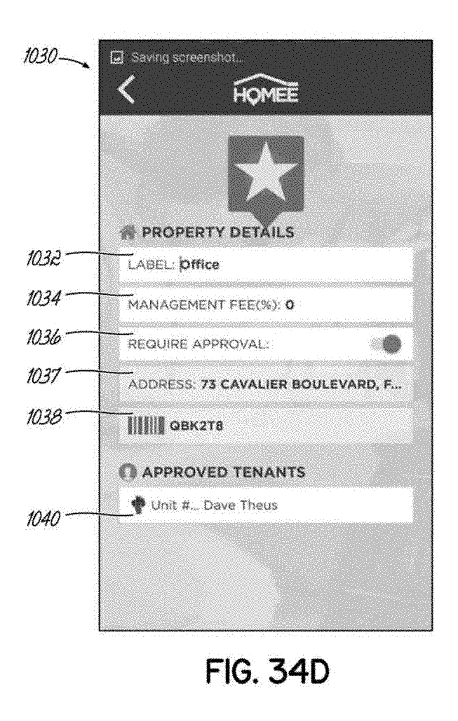

Various properties may be set up with the property addresses to include as the managed properties. Referring to FIG. 34A, in screen 1020, a search field 1022 is presented on a map screen and may have type ahead functionality to locate the property address to manage for selecting that property. FIG. 34B illustrates a property search in progress. Once a property is located, as in FIG. 34C, the system, through screen 1024 provides the ability to confirm, through field 1026, that the property is to be a managed property. FIG. 34D shows a screen 1030 that is presented to the user with fields for further input as well as information from the server system 102 to then be used by a tenant in ordering service at the managed property.

For example, referring to FIG. 34D, each managed property may have a label field 1032 to name the property, an optional management fee field 1034 to set a management fee (a percentage added to the final job cost), and a toggle field 1036 for setting the current property for the step of requiring approval from the property manager as discussed herein. Also, an address field 1037 with the property address (number, street, city, state, zip) might be presented. The screen 1030 also presents the managed payment token in a field 1038. The unique token (such as a 6 digit/letter token) is determined or generated by the system 102 when the property is added and is then presented to the property manager on screen 1030 (Block 1126). The field 1040 is for managing the tenants that have applied the managed payment token to their consumer accounts as a payment option as discussed herein.

Once these additional properties and data have been entered in the property details screen 1030, and the toggle field 1036 to require approval is set in the OFF position, the property manager can then share this token with each tenant of that property that they want to enable to self order jobs and services (Block 1127). Such sharing of the token can be made with the tenant through a number of ways such as an email, a text message or a letter to the tenant, for example. As discussed further herein, if the property does require an approval (such as field 1036 in an ON position) then additional steps will need to be taken as discussed herein. The process for tenants to add the managed payment token to their consumer is discussed herein. Once the token is added to a consumer profile, the use of the account still has to be approved by the property manager before it becomes active.

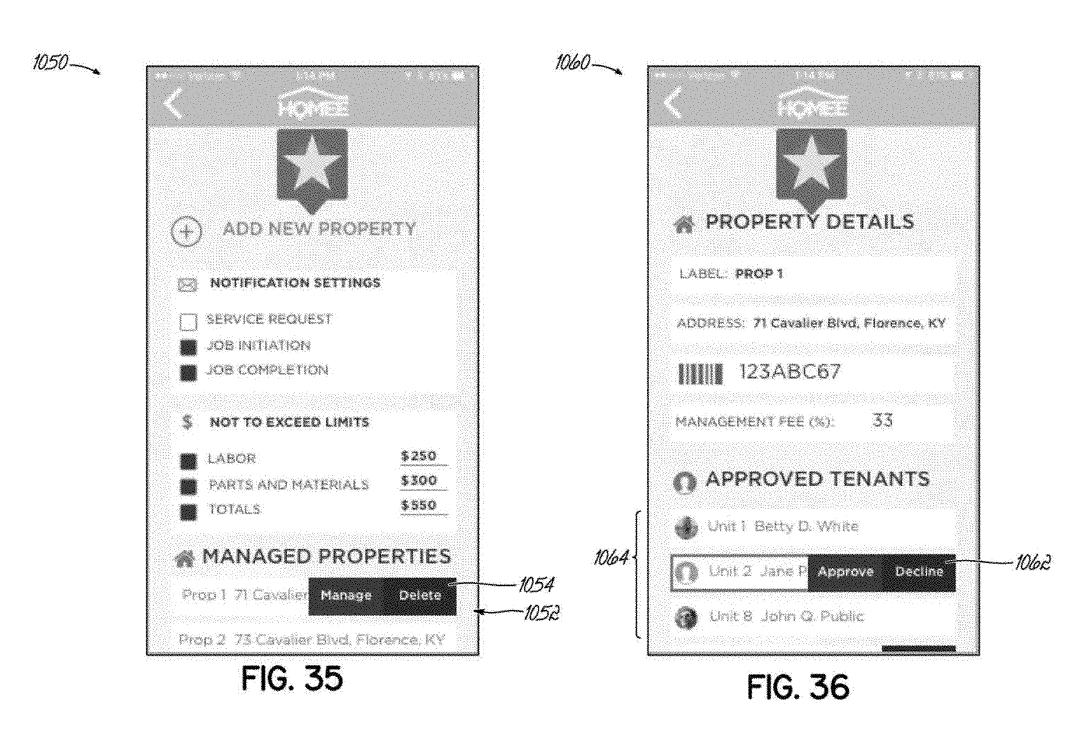

After the property details and data are added through screen 1030 of FIG. 34D, and the managed payment token is recorded in the property manager App and shared with tenants, a property manager is presented with screen 1050 in FIG. 35 and can get back to a property details screen as illustrated in FIG. 36 by engaging a managed property in field 1052 and exposing and selecting manage or delete button fields 1054 that are exposed by sliding right to left on the property field.

Referring to FIG. 36 and screen 1060, after a tenant has added the manage payment token to their payment screen, they will sit in a “waiting approval” state (Block 1128) until the property manager takes the steps to approve or decline the use of the token though engagement with button fields 1062 in approved tenant field 1064. Within the property details screen 1060, each tenant that has added the token is shown under the approved tenant field 1064 and sliding right to left exposes the button fields 1062 that illustrate the actions that can be taken on this tenant. In one engagement of button fields 1062, the property manager can approve or decline the tenants request to add the managed payment (Block 1128). Once approved, the property manager can also delete that tenant at any future time, such as through engagement of the field 1064 and that tenant listed. The approval of the use of the managed payment taken and account allows the system to enable the tenant to order service through that property manager account.

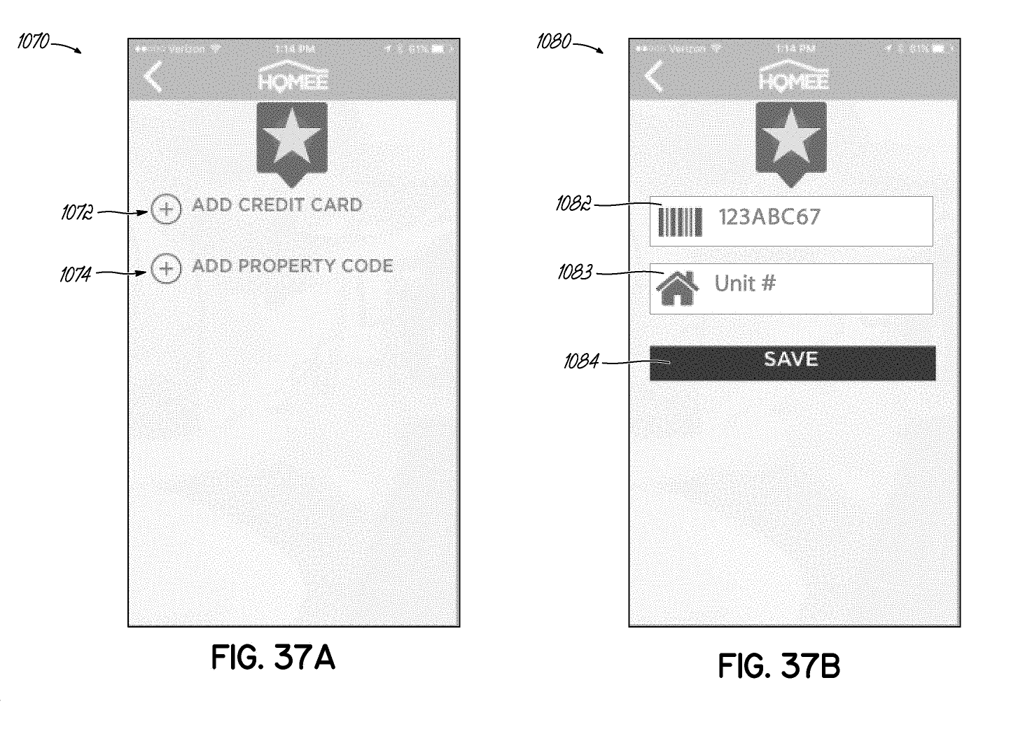

FIGS. 37A and 37B indicate screen used by a tenant when registering a personal user or customer account through the consumer App. The screen 1070 is similar to screen 820 illustrated in FIG. 31A wherein the consumer/tenant must add a method of payment prior to being able to order a service to their property. One method of payment is a personal credit card as described in the general workflow and that information might be added via field 1072. The second method that is used with tenants is the managed payment token, which is the code from the property manager as discussed herein. This token is then used to associate the payment for work at the associated location as matched in the property manager consumer App. (See FIG. 34D) The managed payment token serves two purposes. The managed payment token uses the payment method and information within the property manager's account to pay for the services ordered through the token. Also, the managed payment token prevents fraudulent ordering. The managed payment token only allows the token to be used at the address associated with it (See FIG. 34D) and effectively geo-fences the property and work done and prevents someone from using this same token at another address. As illustrated in FIG. 34B and screen 1080, the token information from the property manager might be entered in field 1082 for a property as noted in field 1083 and then saved as noted in field 1084. As noted, the tenant will sit in a “waiting approval” state until the property manager takes the steps to approve or decline the use of the token.

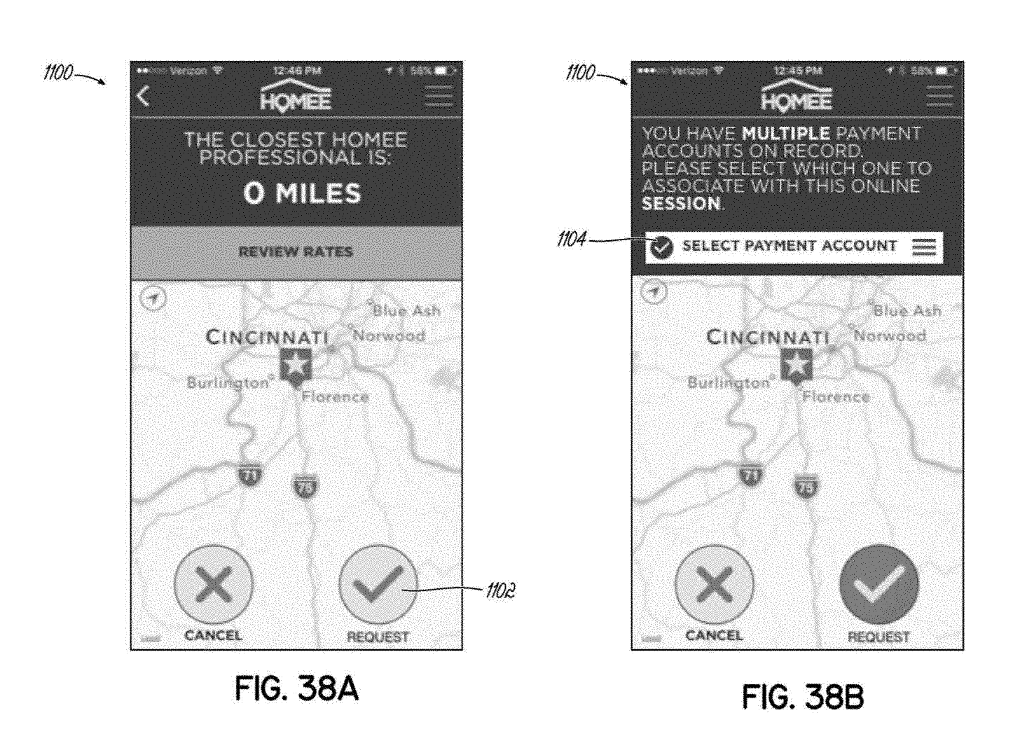

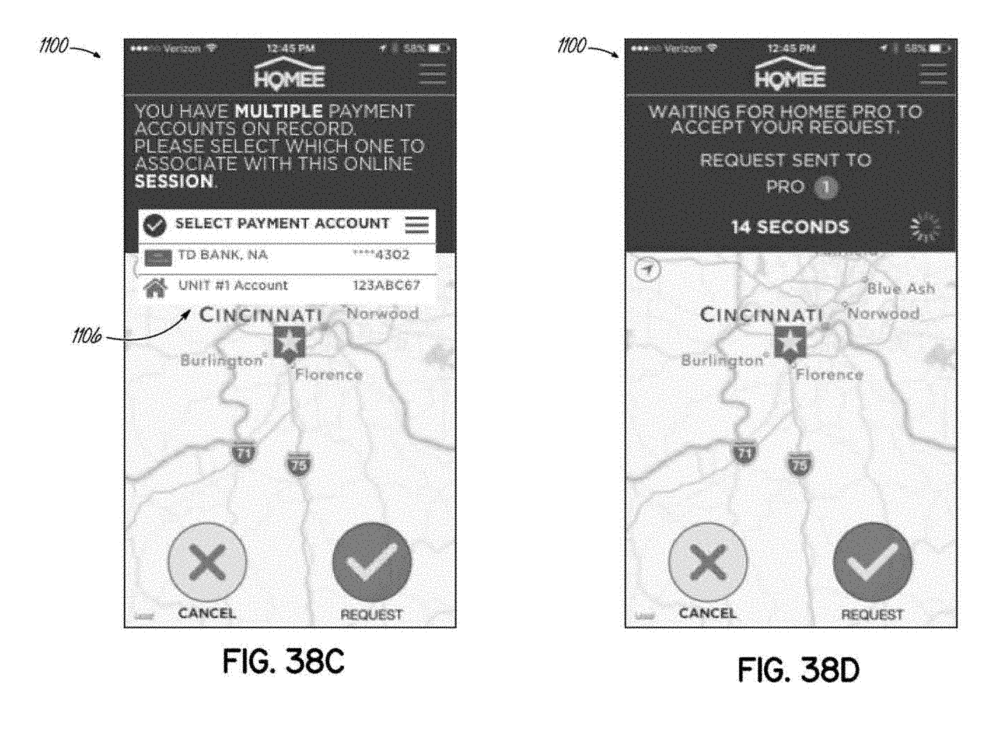

Referring to FIG. 38A-38D, the tenant job ordering process is illustrated. Upon requesting service in screen 1100 of FIG. 38A and through field 1102, the screen of FIG. 38B is presented for selecting a payment account through field 110. The screens 38B, 38C are illustrated and shown to the tenant if they have more than one payment method on their account. If they have a personal credit card and a Managed Payment method, at job ordering time, the user can select through field 1106 whether they would like to use a personal credit card to pay for the service (for example if the service is not approved by the property manager, e.g. painting the living room) or the managed payment method if they are ordering service at the managed property associated with this managed payment. The consumer App also has a feature in the software for when the tenant is trying to use the managed payment token/method at an address/location not within the geo-fence (i.e. 50 m of the location, a notification is shown to the tenant and they are unable to request the service (the field 1102 is inactive)). Once the payment issue is resolved and selected and the job requested, various provider requests might proceed as disclosed herein and reflected in screen 1100 of FIG. 38D.

Once a tenant is set up under a managed property and has been linked to property manager account, the tenant can then order a job that is paid for by the property manager or other party that is responsible for the property. In the typical job request workflow, a consumer can submit a consumer request and the system 102 then automatically generates a set of provider requests and records based on current provider availability and location and other search/match criteria as discussed herein. A provider that receives a request can then accept the provider request received in their provider App. Then the consumer would approve or decline the provider requests in their consumer App until an acceptable provider is confirmed and the consumer request becomes a job and service is completed.

As disclosed, the consumer App, in one embodiment, supports managed properties where a property manager can create one or more properties and invite their tenants to add a managed payment method to their payment option and screen by using a Property Code. By joining a Managed Property Group, the Tenant can request services at the property that will be paid for by the property manager. One feature of that process, in accordance with the invention, is a requirement of an approval from the property manager before the request becomes a job.

As noted with respect to FIG. 34D, in a managed property job request workflow, the concept of approval provides a property manager with the ability to set one or more of their properties with an approval condition that requires their approval when a tenant or tenants request service for the property to be paid for by the property manager. The process for approval is a multistep process that requires a tenant to upload pictures and to add a text note that describes the work that is being requested. The request is then sent to the property manager, who then reviews the pictures and text notes and then makes a decision to approve or decline the consumer/tenant job request. Then upon receiving the property manager approval, the tenant can choose to order the service and the job workflow will continue in normal fashion, or the tenant can cancel the service request.

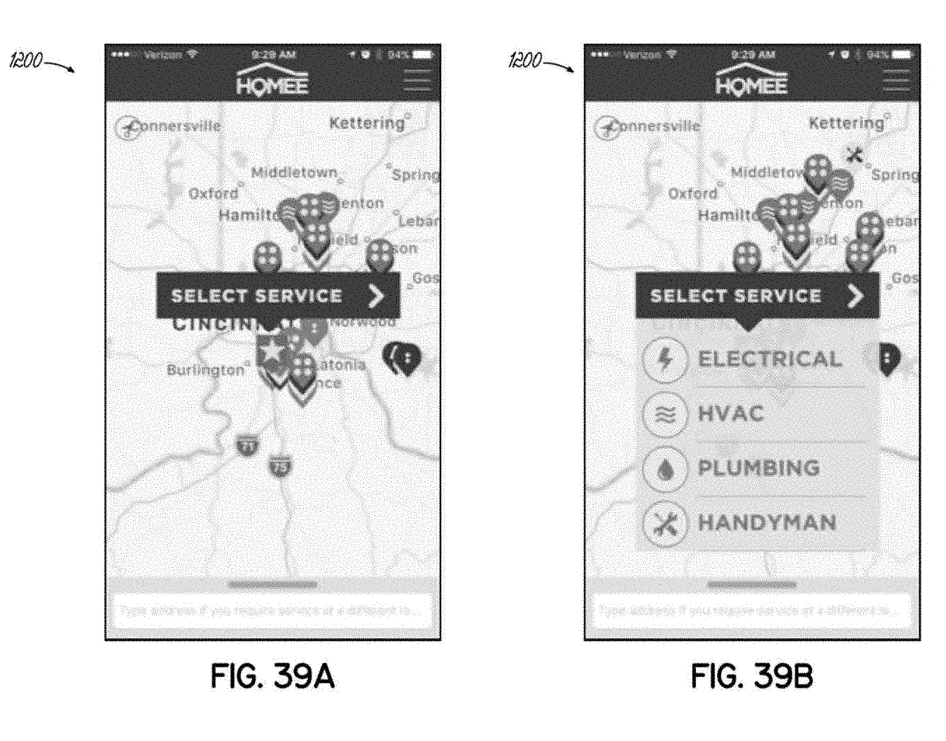

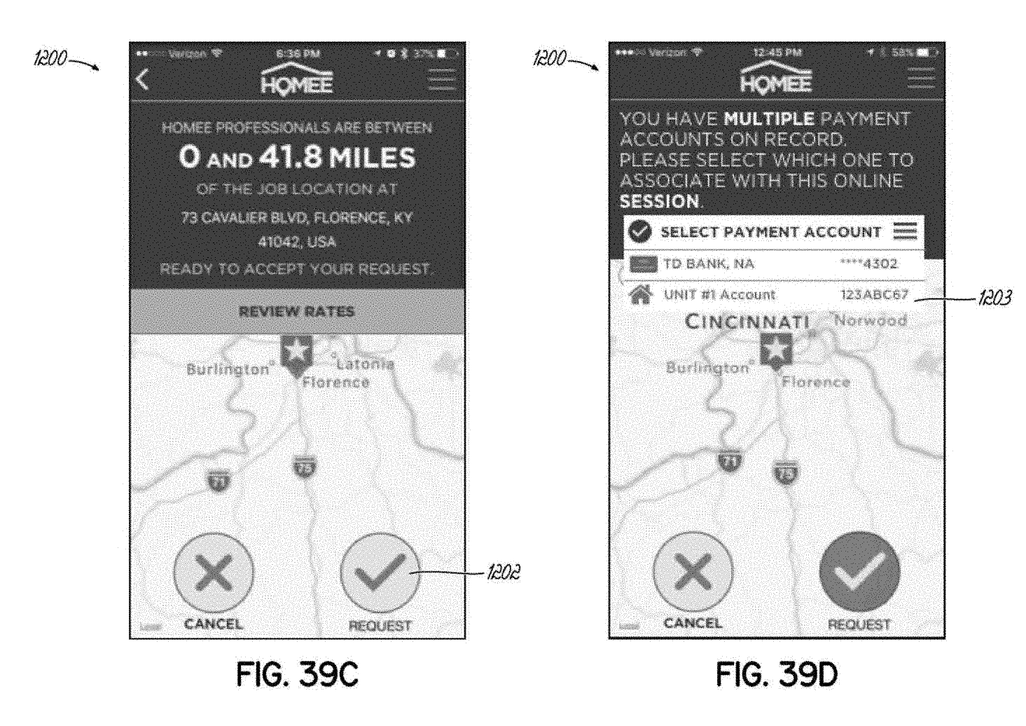

During the initial request workflow, as would proceed through screen 1200 of FIGS. 39A, 39B, the service might be selected and then the tenant is given the opportunity to request service, such as through field 1202 of FIG. 39C. Referring to FIG. 5E, the tenant selects a service (Block 1400) and will have to select a payment option. If a credit card payment option is selected, the request can be processed in the normal flow (Block 1410, 1424). If the tenant and associated tenant record indicate a managed payment option that is set up or there are one or more credit card payment options that are set up in addition to a managed payment, the tenant might select a managed payment option (Block 1410). If the tenant chooses to order with the managed payment 1203, a check is made by the system to determine if records/data for the property manager profile shows that the property is one that requires approval for work to be done (Block 1412). If so, the tenant has to take additional steps for the approval process. In one feature, the tenant must choose one or more picture images or other images to send to the property manager (Block 1414) and must type a text note or message (Block 1416) associated with the request of service.

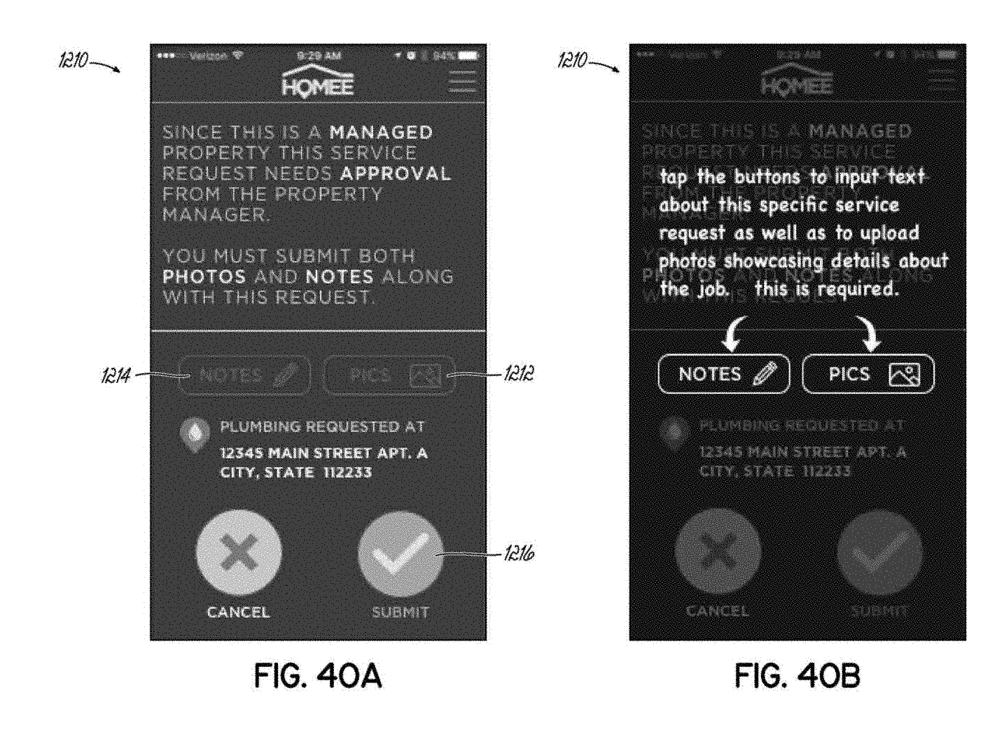

More specifically, and referring to FIGS. 40A and 40B, once the tenant has made a request and before actually creating the consumer request record, the screen 1210 of FIG. 40A with a message is presented to the tenant to inform them that their property is a managed property that requires approval and starts them on an approval process in accordance with the invention. As seen in screen 1210, the message notes that certain steps must be taken and/or certain criteria must be met. In the disclosed embodiment, the approval process requires photos/pictures or other images and notes or some text. In other embodiments, further information or steps might be required and so the invention is not limited to the illustrated embodiment. Fields 1212 and 1214 are presented to allow the tenant to enter pictures/photos and notes. For example, one or more pictures might be chosen from the device running the consumer App and might be sent with the request. The Notes field 1214 and Pics Field 1212 as shown might operate like those similar fields in the job timer and job invoice screens as discussed herein. After those steps are taken and the requested information captured, a submit field 1216 can be engaged. The submit field can be disabled until the information, such as notes and pictures, are added. The invention might provide screen 1210 with a coaching overlay screen with information to explain the screen to the tenant and the steps that must be completed. The overlay screen might then be suppressed so it only to appear once then not show again until some time has elapsed.

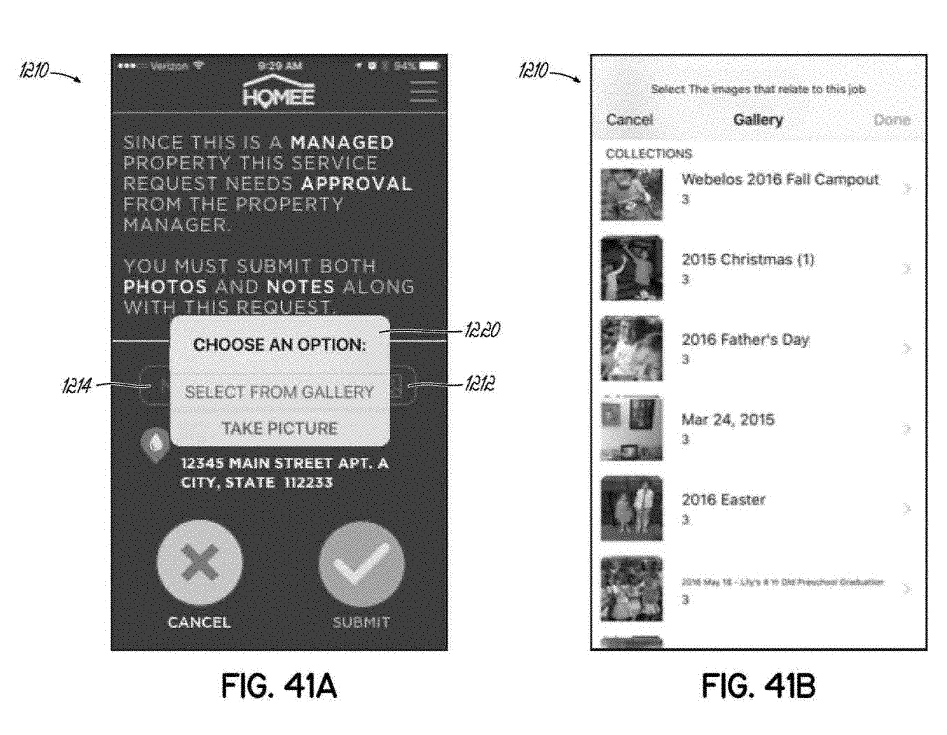

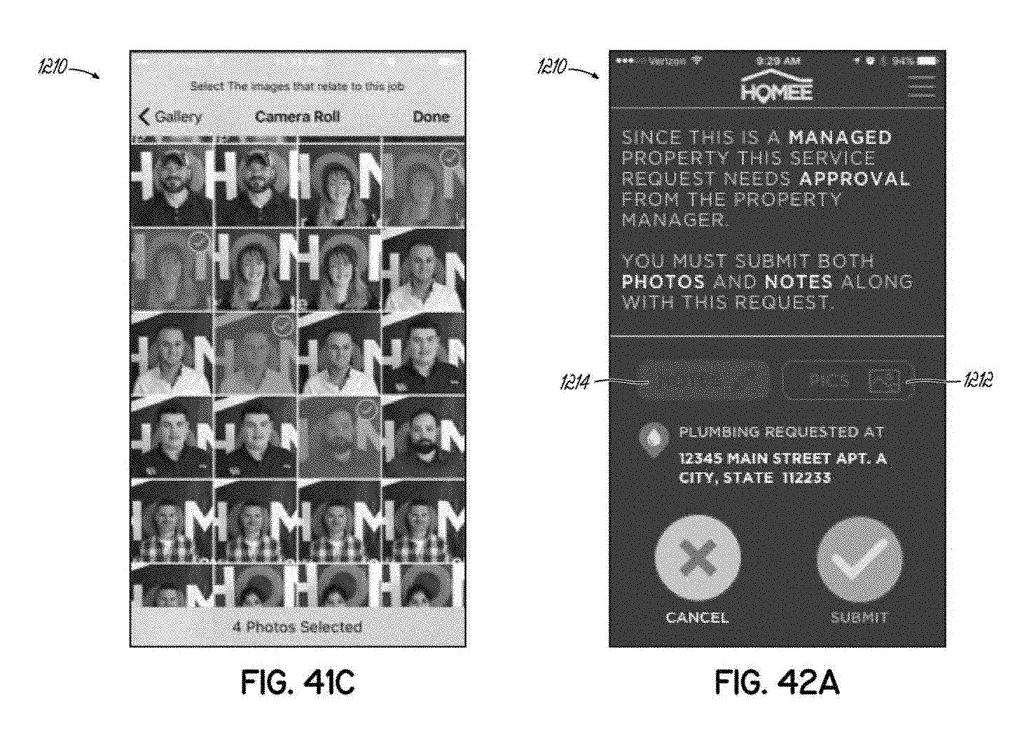

Upon engaging the Pics field 1212, the tenant can choose one or more pictures to be included with their request when it is sent to their property manager. As illustrated in FIG. 41D, screen 1210 may include a notification and selectable fields 1220 regarding where to obtain the picture(s). The fields may be selected and FIGS. 41B and 41C illustrate screens displaying a gallery or other location for obtaining a picture. The pictures are resized by the system the same way job images are resized and are stored to be attached to the consumer request after it has been created.

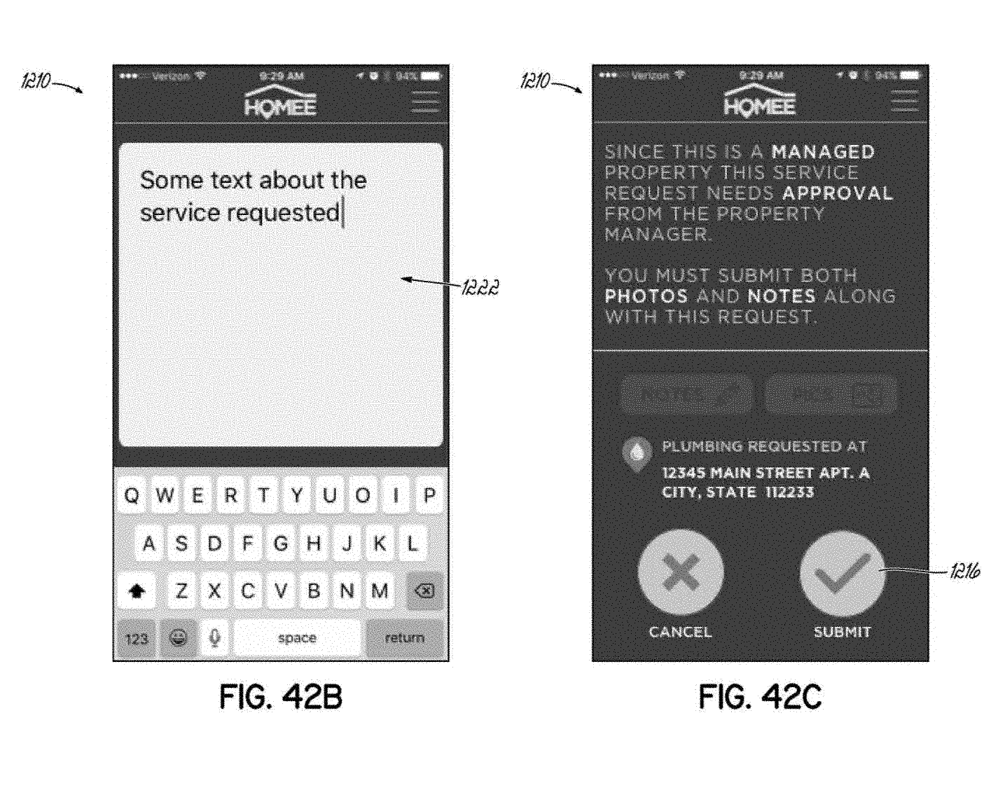

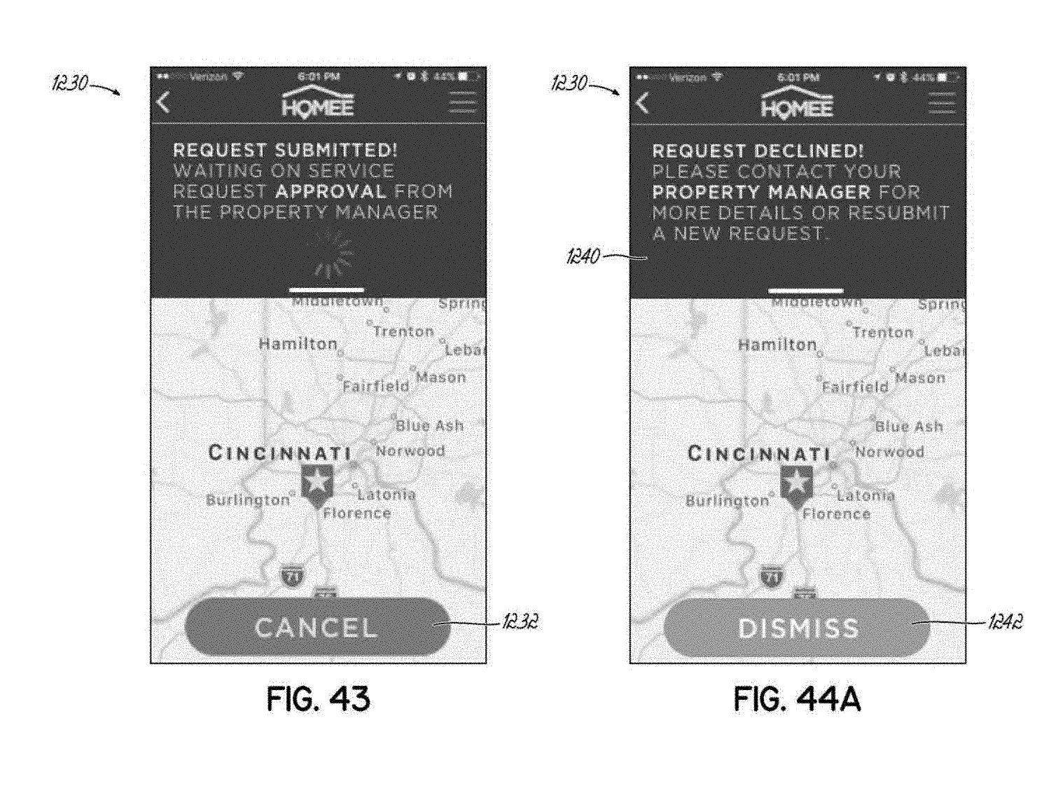

Upon clicking the Notes field 1214 as illustrated in FIG. 42A, a text entry screen with a field 1222 or another similar screen is presented for entering text for a note or message, as illustrated in FIG. 42B. The tenant enters text to be included with their request when it is sent to their property manager. The text in the notes can be stored by the system to be attached to the consumer request after it has been created. After the note text and pictures have been collected/captured, the tenant can engage the Submit field 1216 as shown in FIG. 42C. The property manager must approve the submission and request and the system makes that determination (Block 1418). Upon that submission and when the property manager approves, the consumer request then proceeds through some additional processing steps and then eventually in a typical workflow fashion as illustrated in FIGS. 5A-5B. The tenant is presented with a screen 1230 as illustrated in FIG. 43 informing them that their request is waiting on approval. At this point, the tenant must wait for approval from their property manager before they can proceed, but they can cancel the request through engagement of field 1232. If the tenant cancels the request, they are returned to the map screen as illustrated and discussed herein, where they can initiate a new service request.

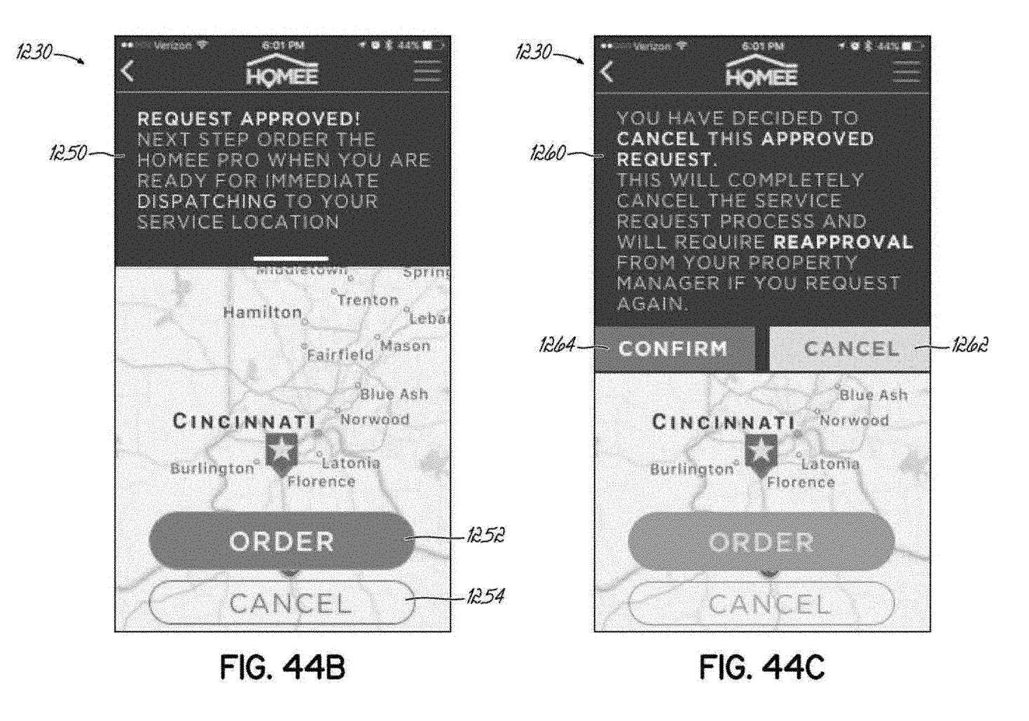

When the property manager chooses to Approve or Decline the request, the tenant will receive a notification informing them of the status update on their request. The system can poll the consumer request to watch for status updates in the event the push notification is not delivered. If the property manager declines the request, the tenant is presented with a screen 1230 as shown in FIG. 44A with a message 1240 informing them that the tenant request was declined. Screen 1230 also presents a field 1242 with an option to Dismiss the request, which will take them again back to a beginning new request or map screen as disclosed herein. If the property manager approves the request, the tenant is presented with a screen 1230 as shown in FIG. 44B with a message 1250 informing them that the tenant request was approved. Screen 1230 also presents fields 1252, 1254 with options to Order or Cancel the request (Block 1420). The system will determine if the request should proceed per the tenant's actions (Block 1422). If they choose to Cancel, the tenant is presented with a screen 1230 as shown in FIG. 44C with a message 1260 forcing them to Confirm the cancellation through field 1264 or Cancel that proposed cancellation through field 1262. If they Confirm the cancellation the system will then cancel the consumer request, returning them to the beginning new request or map screen (Block 1423). If they choose to Cancel the cancellation and then Order the service (See FIG. 44B) the status of the consumer request is updated to pending and the request will proceed to be processed (Block 1424) and follow the same workflow as creating a normal consumer request as discussed herein with respect to FIGS. 5A-5B.

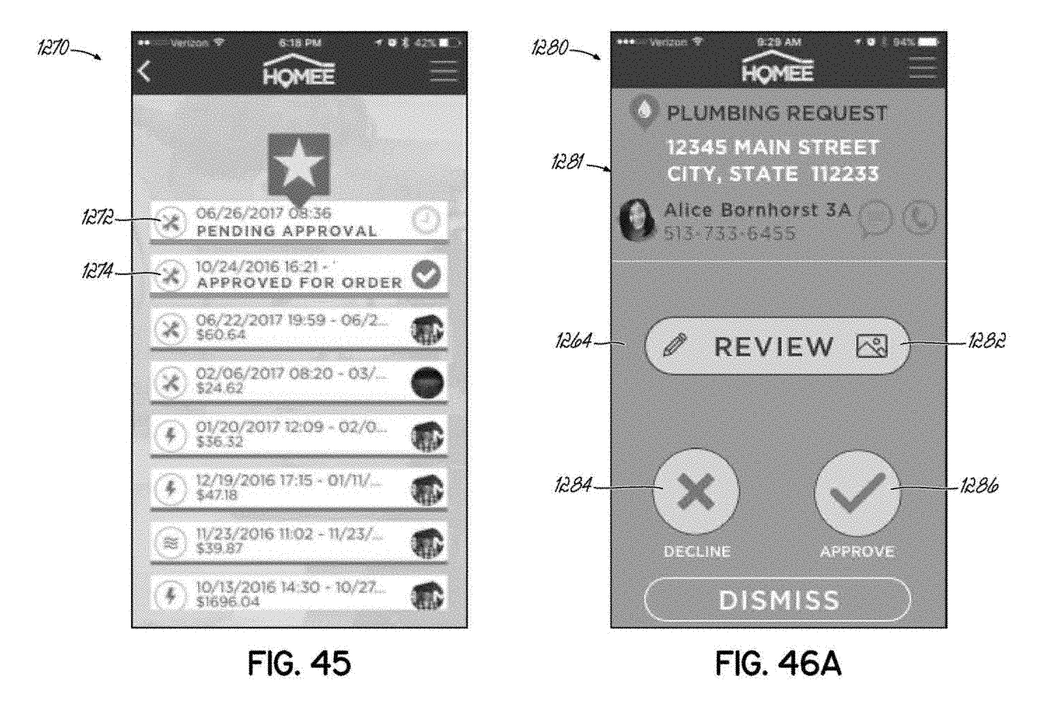

In accordance with another feature of the invention, if a tenant clears their request, or launches the consumer App on a new device or in any way loses the fact that they have a request in process, they will be able to see open consumer requests in the system on a History screen. FIG. 45 illustrates a screen 1270 with history entries from the consumer App records with entries 1272, 1274 indicating open consumer requests. The history screen 1270 might be accessed by a drop down menu. Engaging one of the open requests should make the request active in the consumer App and take the tenant to the appropriate screen depending on the status of the request so they can proceed.

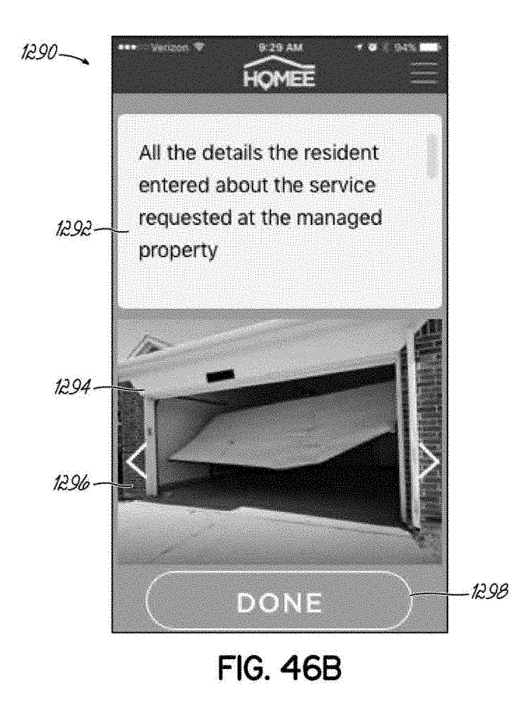

On the other side of the approval process, when the property manager receives a notification for a consumer request, the property manager is presented with a screen 1280 as illustrated in FIG. 46A informing the property manager they have a new request to review. Information 1281 regarding the managed property and tenant is listed and the property manager can review the details of the request by engaging field 1282. If the user clicks the Review filed 1282, they are presented with a screen 1290 as shown in FIG. 46B showing the notes 1292 and pictures 1294. The display may have carousel controls 1296. Engaging the Done field 1298 returns the property manager then to the approval screen 1280 in FIG. 46A. If the user engages the Decline field 1284 the consumer request is declined and the property manager might be returned to their History screen, similar to the history screen of FIG. 45. If the property manager engages the Approve field 1286, the consumer request is approved and its status is updated by the system and the tenant will be notified as disclosed herein. (see FIG. 44B) and the property manager might be returned to their History screen.

If the property manager dismisses their approval request, launches the App on a new device or in any way loses the fact that they have an outstanding request in process, they will be able to see open consumer requests records on their History screen, similar to screen 45. Selecting one of the status requests should make the approval request active in the App and take the user to the approval screen 1280 in FIG. 46A. Clicking on any other approval request should show the review screen of FIG. 46B so the property manager can see the note and pictures for the request, but not allow them to get back to the approval screen to change their approval state. This is because once a consumer request is released by the tenant to the system, the provider requests and/or a job proceeds and the property manager cannot go back and withdraw approval.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

### Master Service Owner

In various uses of the invention, the provider is the ultimate owner of the company for which service is provided or is a sole proprietor. As such, and as discussed in the examples herein, the provider deals directly with the consumer for service and approval and payment for a job. Therefore, in a normal or typical job request workflow, a consumer can submit a consumer request and the system of the invention automatically generates a set of provider requests and associated records that are based on consumer request data and based on current provider availability and location. Providers can then accept the provider request received in their provider App. Then the consumer can approve/decline the accepted provider requests in their consumer app until an acceptable provider is confirmed and the consumer request becomes a job and service is completed.

However, there are scenarios wherein the provider providing the service does not own the company nor is a sole proprietor but works for or on behalf of an organization and may not be collecting directly for any service or job. For example, a provider might work for a company that provides plumbing services. As such, the ultimate collector for a service in accordance with the invention may be the true company owner. In accordance with one embodiment of the invention, a provider (user that downloads the provider App on their device) may designate themselves as a service owner. In the current examples, the provider that is a service owner or manager will be referred to herein as the “service owner” and the provider that is providing the service will be referred to as the “pro”. However, such terms are not limiting and the various parties might have other relationships wherein one party has to give approval to another party that is providing service before a consumer request is accepted in accordance with the invention.

Specifically, a service owner invites one or more pros to add a managed deposit method to their account and the pros can add the managed deposit method through a payment information screen (e.g. FIGS. 52-54) by using a bank account code provided by the service owner. Using the code, the pro then joins a managed service group that is associated with data records for a particular service owner. By joining a managed service group, the pro can accept and provide services that will be paid to the service owner.

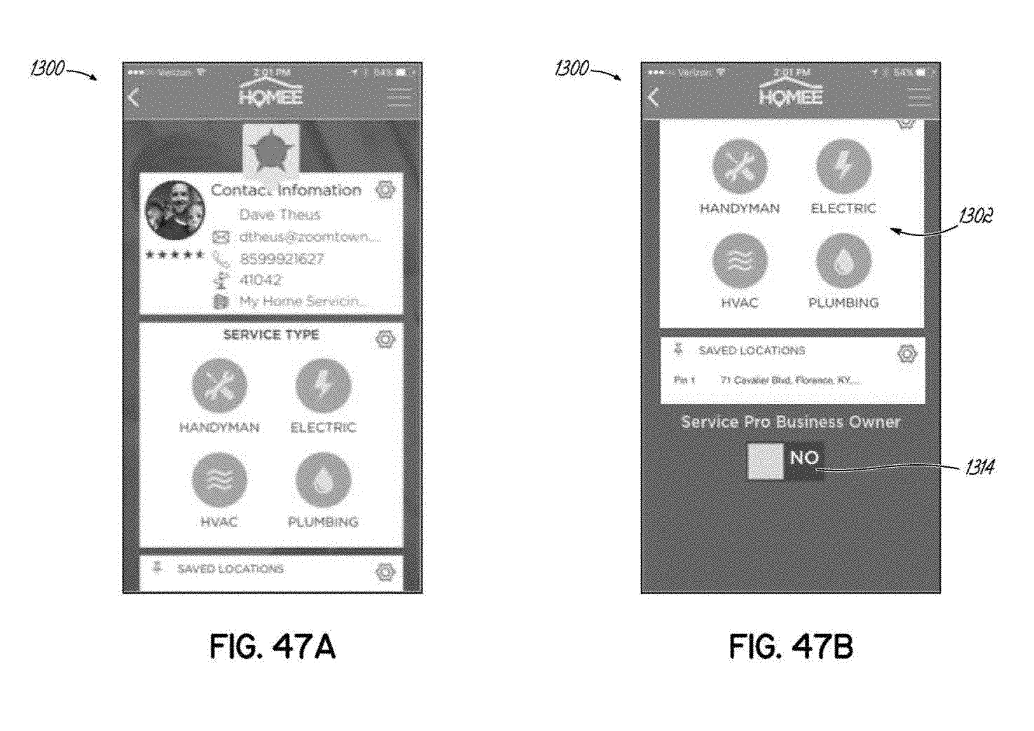

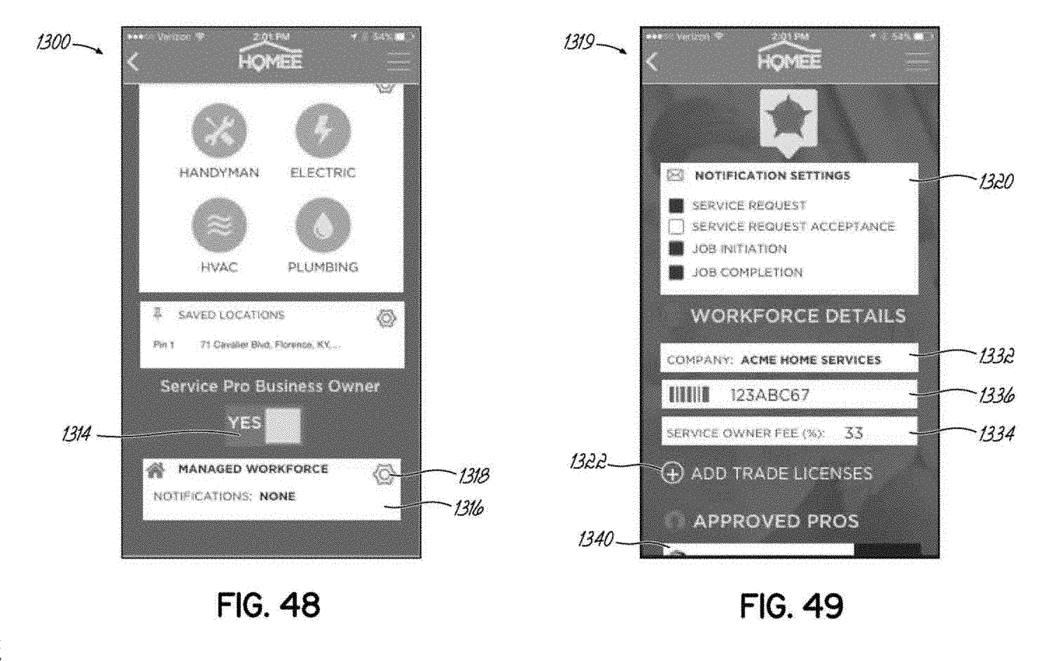

The service owner will download the provider App and will have a chance, during the initial setup workflow, to add managed workforce and thus act as a service owner. Referring to FIG. 47A, 47B and screen 1300, in addition to one or more fields 1312 for entering information on the provider, there is a toggle/slider field 1314 which may be engaged to enable the advanced functionality within the provider's profile screen. Once the user toggles on the service owner field 1314 they are presented with a field 1316 for adding and configuring managed workforce, as illustrated in FIG. 48. A selectable field, such as an icon 1318, might be selected within the managed workforce field 1316. The service owner is then presented with fields for adding managed licenses and configuring Notification settings to be applied to the workforce to be managed. Referring to FIG. 49, a field 1320 may be used to enter preferences for when the service owner is to be notified, such as upon a request of service, upon an acceptance of a service request, upon a job initiation and/or upon a job completion. These preference settings from the fields 1320 are then applied to all job requests that are sent to the managed workforce, that are also displayed in field 1316.

For example, the service owner can add notification parameters through selected settings. Based on the notification settings the inventive system sends notification messages (e.g. emails) to the service owner when services are requested from the pros in the managed workforce, when a job is initiated (e.g. when a timer started), and/or when a job is completed (e.g. when the final details are approved). Other notification parameters might be set in accordance with features of the invention.

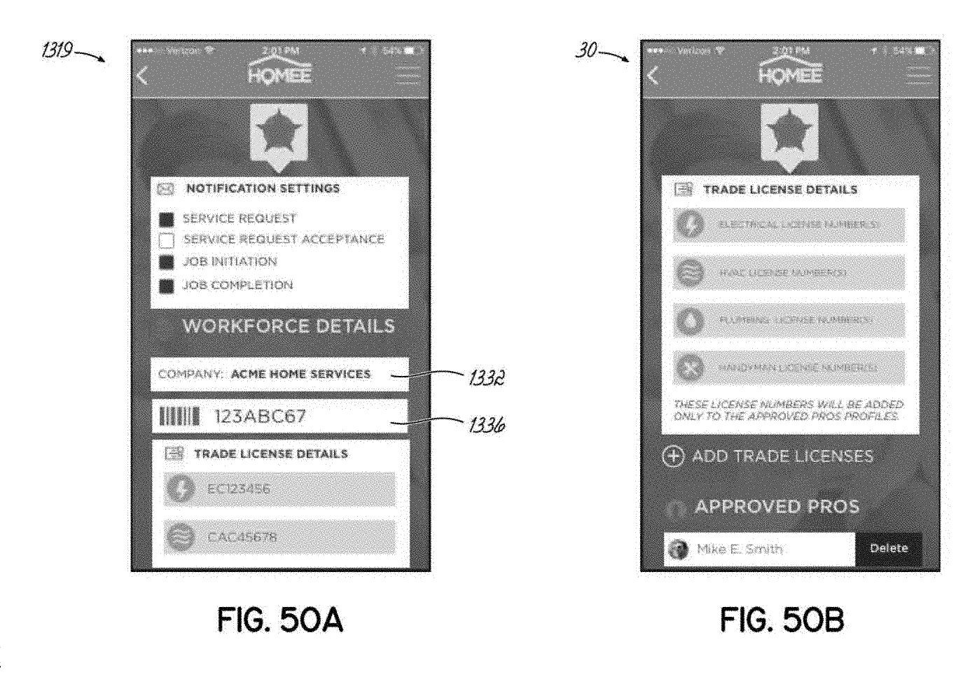

Various trade licenses may be set up to include with the managed workforce. Referring to FIG. 49, in screen 1319, a selectable field, such as an icon 1322, might be selected within the managed workforce field 1316. FIG. 50A shows a screen 1400 that is presented to the user with fields for further input as well as information from the server system 102 to then be used by a pro in receiving consumer requests for service at a property.

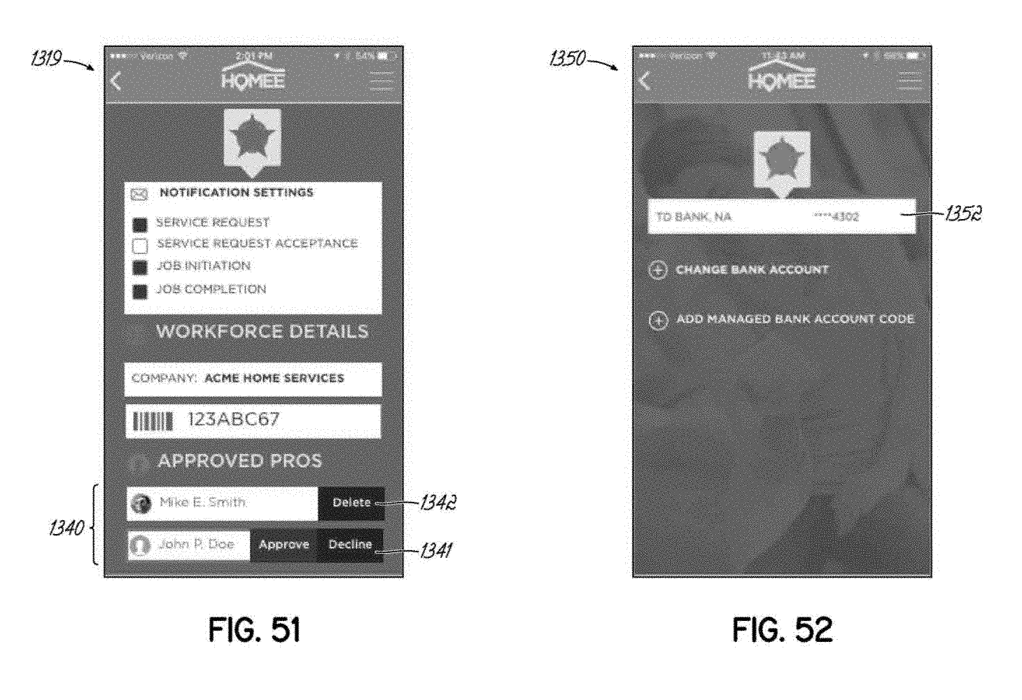

For example, referring to FIG. 49, the managed workforce may have a label field 1332 to name the organization/company, an optional management fee field 1334 to set a service owner fee (a percentage subtracted from rates which are displayed on any of the pros screens. The screen 1319 in FIG. 50A also presents the managed bank account token in a field 1336. The unique token (such as a 6 digit/letter token) is determined or generated by the system 102 when the managed workforce is added and is then presented to the service owner on screen 1319. The field 1340 of FIG. 51 is for managing the pros that have applied the managed account token to their provider accounts as a deposit option as discussed herein.

Once these additional properties and data have been entered in the managed workforce screen 49, the service owner can then share this token with each pro of that workforce that they want to enable to receive requests as part of that organization. Such sharing of the token can be made with the pro through a number of ways such as an email, a text message or a letter to the pro, for example. The process for pros to add the managed payment token to their provider is discussed herein. Once the token is added to a provider profile, the use of the account still has to be approved by the service owner before it becomes active.

Similar to the managed property workflow, after a pro has added the manage account token to their bank account deposit screen, they will sit in a “waiting approval” state until the service owner takes the steps to approve or decline the use of the token through engagement with button fields 1341 in approved pros field 1340. Within the managed workforce screen 51, each pro that has added the token is shown under the approved pros field 1340 and sliding right to left exposes the button fields 1341 that illustrate the actions that can be taken on this pro. In one engagement of button fields 1341, the service owner can approve or decline the pros request to add the managed deposit account. Once approved, the service owner can also delete that pro at any future time, such as through engagement of the field 1342 and that pro listed. The approval of the use of the managed deposit account token and account allows the system to enable the pro to accept and provide service through that service owner account.

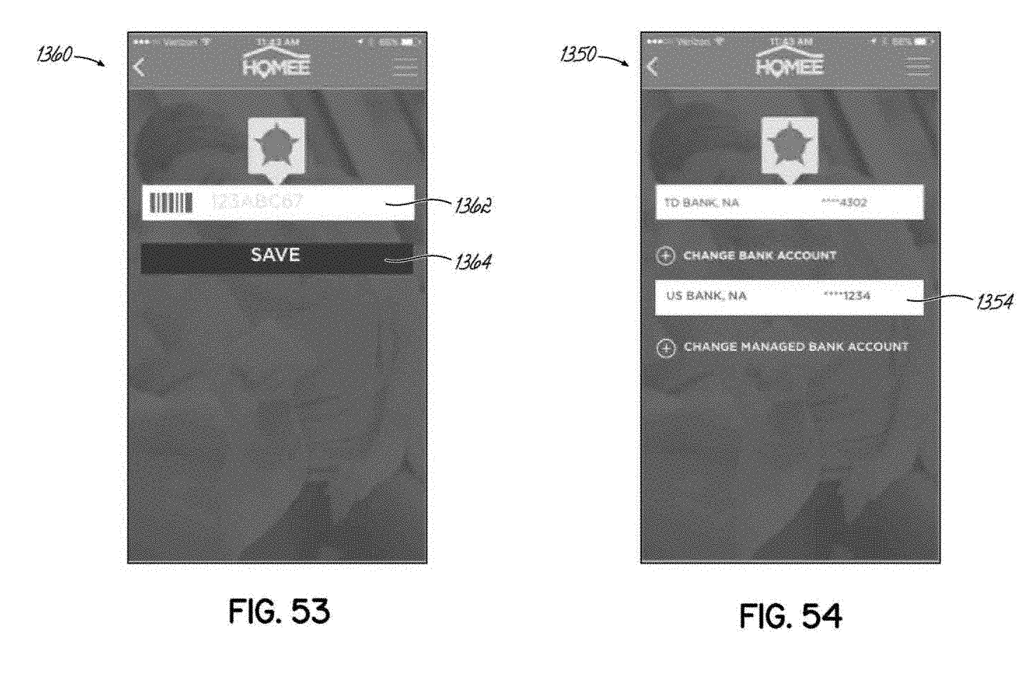

The screen 1350 illustrated in FIG. 52 shows where the provider/pro must add a method of deposit prior to being able to go online and accept and provide a service at a property. One method of deposit is a bank account as described in the general workflow and that information might be added via field 1352 of FIG. 52. The second method that is used with pros is the managed deposit account token, which is the code from the service owner as discussed herein. This token is then used to associate the payment and subsequent deposit for work as matched in the service owner provider App. (See FIG. 49) The managed bank account token serves a single purpose. The managed payment token uses the deposit method and information within the service owner's account to deposit for the services provided through the token. See FIG. 54, field 1354. As illustrated in FIG. 53 and screen 1360, the token information from the service owner might be entered in field 1362 for a pro and then saved as noted in field 1364. As noted, the pro will sit in a “waiting approval” state until the service owner takes the steps to approve or decline the use of the token.

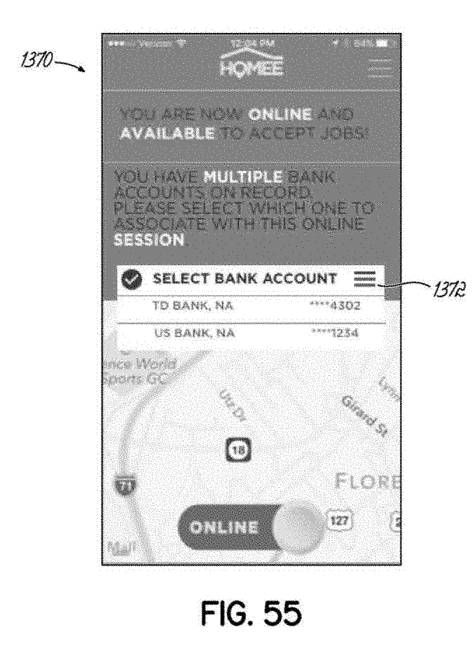

Referring to FIG. 55, the provider going online process is illustrated. Upon going online (or opening the app in a previous online state), the screen 1370 of FIG. 55 is presented for selecting a bank account through field 1372. The screen 55 is illustrated and shown to the pro if they have more than one deposit method on their account. If they have a bank account and a Managed Account method, at online time, the user can select through field 1372 whether they would like to use the personal bank account to be paid for the service (for example if the provider is going online after work hours as an individual or sole proprietor) or the managed account method if they are accepting and providing service as part of the managed workforce associated with this managed account.

What is claimed is:

1. A method for the on-demand provision of a property service job through a computing system with at least one processor and interfacing with a plurality of devices, the method comprising:
maintaining a plurality of profiles for service providers that provide property services;
capturing, through the computing system, a consumer job request from a device of a consumer for a job at a jobsite;
generating a plurality of provider job requests for the service providers, a job request being associated with the job and job site associated with the consumer;
directing job requests to devices of a plurality of service providers in a sequential fashion controlled by provider criteria;
receiving, an acceptance of the job request from a device of at least one service provider;
upon acceptance of the job request by the at least one provider device, evaluating a location of the at least one service provider device with respect to the job site;
generating a timer that is associated with the job, the timer configured for being started and stopped with the device of the service provider;
obtaining approval from the consumer for the start of a timer through the consumer device;
monitoring a subsequent progression of the timer associated with the job.

2. The method of claim 1 further comprising evaluating a stop of the timer by a provider and upon a requested restart of the timer by a provider, communicating information of the restart of the timer to the consumer for obtaining approval from the consumer before a restart of the timer.

3. The method of claim 1 further comprising determining, at a stop of the timer, the status of the job, the status of the job including at least one of paused, suspended or finished.

4. The method of claim 1 further comprising directing job requests in a sequential fashion using provider criteria including at least one of the location of the provider with respect to the job site, the favorite status of the provider, service type of the job, the years of experience of a provider, the trade licensing of a provider, the work status of a provider.

5. The method of claim further comprising directing job requests to devices of a plurality of service providers in a sequential fashion including directing job requests based on one set of provider criteria for a first duration and based on another set of provider criteria for another duration.

6. The method of claim 1 further comprising upon determination, at a stop of the timer, that the job has a finished status, obtaining additional job information from the provider through the provider device.

7. The method of claim 6 wherein additional job information from the provider include pre-job information and post-job information.

8. The method of claim 6 further comprising determining a charge to the consumer for the job based upon the timer associated with the job and the additional job information.

9. The method of claim 1 further comprising, upon receipt of a consumer job request, engaging a property manager through a property manager device and obtaining approval of the consumer job request as a condition for generating a plurality of provider job requests for the service providers.

10. The method of claim 9 further comprising, obtaining additional job information from the provider through the provider device and directing the additional information to the property manager device for obtaining approval of the consumer job request.

11. A system for the on-demand provision of a property service job comprising:
a computing system with at least one processor, the system configured for interfacing with a plurality of remote devices and maintaining a plurality of profiles for service providers that provide property services;
at least one consumer device including at least one processor, the consumer device configured for capturing a consumer job request from a consumer for a job at a jobsite and interfacing with the computing system;
at least one provider device including at least one processor and configured for receiving provider job requests from the computing system;
the computing system configured for generating a plurality of provider job requests for one or more service providers in response to receiving a consumer job request, a provider job request being associated with the job and job site associated with the consumer;
the computing system further configured for directing job requests to devices of a plurality of service providers in a sequential fashion controlled by provider criteria;
the at least one provider device configured for generating an acceptance of the provider of a service provider;
the computing system further configured, upon receiving an acceptance of the job request from the provider device, for generating a timer that is associated with the job, the timer configured for being started and stopped with the device of the service provider based on approval from the consumer for the start of a timer through the consumer device;
the computing system monitoring a subsequent progression of the timer associated with the job.

12. The system of claim 11 wherein the computing system is further configured for evaluating a stop of the timer through a provider device, and upon a requested restart of the timer through a provider device, communicating information of the restart of the timer to the consumer device for obtaining approval through the consumer device before a restart of the timer.

13. The system of claim 11 wherein the computing system is further configured for determining, at a stop of the timer, the status of the job, the status of the job including at least one of paused, suspended or finished.

14. The system of claim 11 wherein the computing system is further configured for directing job requests in a sequential fashion using provider criteria including at least one of the location of the provider with respect to the job site, the favorite status of the provider, service type of the job, the years of experience of a provider, the trade licensing of a provider, the work status of a provider.

15. The system of claim 11 wherein the computing system is further configured for directing job requests to provider devices of a plurality of service providers in a sequential fashion including directing job requests based on one set of provider criteria for a first duration and based on another set of provider criteria for another duration.

16. The system of claim 11 wherein the computing system is further configured for determining, at a stop of the timer, that the job has a finished status, and obtaining additional job information through the provider device.

17. The system of claim 16 wherein additional job information from the provider include pre-job information and post-job information.

18. The system of claim 11 wherein the computing system is further configured for determining a charge to the consumer for the job based upon the timer associated with the job and the additional job information.

19. The system of claim 11 further comprising at least one property manager device, wherein the computing system is further configured for, upon receipt of a consumer job request, engaging a property manager through the property manager device and obtaining approval of the consumer job request as a condition for generating a plurality of provider job requests for the service providers.

20. The system of claim 11 wherein the computing system is further configured for obtaining additional job information from the provider through the provider device and directing the additional information to the property manager device for obtaining approval of the consumer job request.
